(19) United States
(12) Patent Application Publication
(10) Pub. No.: US 2004/0015408 A1
(43) Pub. Date: Jan. 22, 2004

(54) Corporate content management and delivery system

(76) Inventors: Philip Joseph Rauen IV, Kansas City, MO (US); Christopher W. Bjornson, Bolingbrook, IL (US); David Miles Houck, Aurora, IL (US); Paul L. Keane, Leawood, KS (US); Frank B. Modruson, Glen Ellyn, IL (US); Lance Patrick Hartshorn, Hudson, OH (US); Kip Leonard Meyer, Berwyn, IL (US)

Correspondence Address: ACCENTURE C/O MORRISON & FOERSTER, 755 PAGE MILL ROAD, PALO ALTO, CA, 94304, US

(21) Appl. No.: 10/269,683

(22) Filed: Oct. 11, 2002

Related U.S. Application Data
(60) Provisional application No. 60/397,340, filed on Jul. 18, 2002.

(51) Int. Cl. G06F 17/60

(52) U.S. Cl. 705/26

(57) ABSTRACT

The present invention provides a computer-based corporate content management and delivery (CCMD) system. The CCMD system provides efficient storage, management, and delivery of corporate content in response to orders for such content. The CCMD system includes a first module configured to create digital and/or acquire digital content for repurposing in a digital and/or a physical format. A second module, which is electronically coupled to the first module, manages data necessary to process and execute orders for such corporate content in one of digital format and physical format. A third CCMD system module integrates operations of the first module and the second module. The third module also coordinates these operations with internal and/or external third party content/product providers and customers.

### RELATED APPLICATIONS

This application claims priority from U.S. Provsional Application titled “Corporate Control Management and Delivery System,” Serial No. (To Be Assigned), filed Jul. 18, 2002.

This application is related to the following co-pending United States patent applications which are fully incorporated herein by reference:

Ser. No. 09/626,100 filed Jul. 26, 2000 titled “A Method and System for Content Management Assessment, Planning and Delivery;” and

Ser. No. 10/071,357 filed Feb. 7, 2002 titled “Improvements in and Relating to Multi-Media Management Systems.”

### COPYRIGHT NOTICE

A portion of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to the field of computer systems. More particularly, the present invention relates to a method and system for a web-based repository and content ordering mechanism which allows companies to more efficiently manage the procurement, administration, and distribution of physical and digital corporate content.

### BACKGROUND OF THE INVENTION

A technical problem presently exists in the efficient management of content and knowledge data which allows companies to more efficiently manage the procurement, administration, and distribution of physical and digital corporate content. Content management involves the storage and processing of any type of data fragment. A data fragment might include a bit of text, a document, presentation, image, audio file, video file, etc. In essence, any discrete electronic file can be stored and managed as a piece of meaningful content. Types of content that must be managed include documents and digital files—as well as formalized knowledge. The processes for managing these items are generally common to document management, digital asset management, and knowledge management. These terms—document management and digital asset management—and relationships to content management are described in more detail below.

Over the recent past, there has been a significant increase in demand for content management and delivery solutions. This demand is driven by several factors in the marketplace:

Content management is being recognized as critical to efficiently and effectively supporting and operating publication process and supporting commerce in the current Knowledge-Based economy. Content management is also being recognized as playing a key role in electronic and on-line learning.

The amount of content in enterprises is increasing dramatically, as is the demand for more efficient management of content. (Gartner Group States that: By 2002, escalating costs of managing Web content and components will drive more than 80 percent of Global 2,000 enterprise sites to purchase packages or build applications to automate these functions (0.8 probability).

The demand for point and place of time delivery of content in a consistent and personalized fashion across multiple channels is increasing. (Gartner Group states that: By 2004, leading-edge enterprises will have formal content management (business processes and integrated technology) in place for Web, inter-enterprise and intra-enterprise environments (0.8 probability). The tremendous increase in demand for content management skills is in keeping with these projections.

The number and capabilities of packaged software and application platforms supporting efficient and effective content management is increasing.

There are a number of companies which now offer solutions to portions of the problem of content management and distribution. For example:

Interwoven™ Now Advertises its Enterprise Content Management Product Suite as Follows:

Interwoven has a complete and powerful enterprise content management product suite. Interwoven products deliver business results by reducing the time it takes to manage and deploy web sites, share documents across departments, get portals up and running, reuse content across multiple business initiatives, or syndicate content to business partners around the world. Interwoven's product suite is comprised of three product lines. Each product line provides robust, feature-rich functionality designed to meet your demanding Web, portal and eBusiness needs:

TeamSite Content Management—Interwoven's flagship product Teamsite is the cornerstone of the content management product line. TeamSite unleashes the power of content contribution, collaboration and management across the enterprise. Versioning, workflow, site roll back, work areas, staging, editions, and more are included. Unparalleled ease of use is a TeamSite hallmark with browser-based, email and Microsoft Office interfaces. Reduce training means you get results fast. TeamSite works in Solaris (or most of the other leading Unix platforms) and Windows/NT environment. TeamSite also works with the industry leading application servers, databases and portal servers.

MetaTagger Content Intelligence—Customers and employees need to find business information fast and easy. MetaTagger makes it possible by automatically enriching content with metadata. This ensures business information is readily available to those who need it most. MetaTagger is based on third generation classification and categorization technology developed by the world's foremost library scientists and engineers. Maximize your investment in portal and search infrastructure by organizing and describing your enterprise content for precise content delivery. Boost employee productivity and efficiency by minimizing the time spent searching for content and by avoiding reauthoring of existing content.

OpenDeploy Content Distribution—Increase competitive edge and customer satisfaction with live content that's always right. With automated content deployment, OpenDeploy reduces costly Web operations expense. More importantly, it eliminates manual deployments, hand coding, and complicated synchronization of web sites. OpenDeploy efficiently delivers content to all corners of a global enterprise, regardless of the network topology. OpenDeploy also provides security measures including sender authentication, distribution through firewalls, and data encryption.

Vignette™ Corp Advertises its Vignette V/5 E-business Platform as Follows:

The Vignette V/5 E-business Platform provides a proven, enterprise-ready architectural foundation that powers many of the largest and most successful e-business applications today. It is unique in providing a modular and reusable e-business applications framework that helps you respond and adapt quickly to changing market demands. It leverages your existing IT investment in open standards, component models, technical skills, and best practices. The V/5 E-business Platform provides a scalable, reliable, and high-performance foundation for delivering content, profiling, and managing interactions across multiple communication channels such as the Web, pagers, mobile phones, and e-mail.

Documentum™ Corp Advertises its Documentum 4I eBusiness System which Includes its Dynamic Content Assembly Manager (DCA) as Follows:

DCA is the eBusiness tool offering intelligent content assembly and publishing to power your most valuable customer and partner connections. With it, you can gain a valuable advantage from accelerating the creation and delivery of reliable, personalized content that will reduce the costs and risks of eBusiness.

Documentum Dynamic Content Assembler (DCA) automates the routine, labor-intensive tasks of creating and publishing content. As the industry's premier content assembly and publishing solution, DCA lets you securely manage all your content and personalize it for delivery to the Web and, through the Documentum Open Content Architecture (OCA), to a printer, CD, fax, e-mail, cellular phone, or PDA device. This is a significant advance from first-generation content management systems, which do not offer the same level of personalization and publishing capabilities and require extensive programming for all but simple modifications.

DCA automates routine tasks such as dynamic assembly and delivery of trusted content. Through an advanced framework that makes use of software agents, DCA lets you quickly create and publish all kinds of valuable content, within and between companies, with fewer errors. This content can contain standard sections that can be reused in many ways, and tailored to the specific requirements of your customers and business partners.

DCA is based upon Documentum's Internet-scale content repository that manages all content as well as the related workflows and attributes for personalization. With DCA, content can be pulled directly out of the repository and dynamically assembled into Web pages tailored to the interests and preferences of specific customers and partners to guarantee high-impact and scalable Web publishing.

DCA delivers its unique capabilities through three main processes: load, build, and publish. The load agent provides methods for gathering information to be included as part of the content. The build agent selects the correct virtual content template and builds the new content based on these templates. The publish agent performs the final processing of the new documents. It merges sections together and includes the appropriate client information as part of the final content. The user, or a system application, submits a request. The load agent picks up this request and queues it to the build agent.

The build agent selects a Virtual Document Management template, which contains the rules for when each component should be copied into the new document. The build agent will create a new virtual document and link in the documents. Also associated with the template is a configuration object, which identifies where the documents will be stored in the repository. The build agent processes this structure and creates a new document. The build agent then passes the new document to the publish agent. The publish agent publishes the documents. It merges the sections, runs mail merge and optionally creates a PDF rendition. The final documents are now available for the end user to review.

Knowledge-based assembly—Using Documentum's rules-based Virtual Document Management capability, DCA delivers enterprise-wide, knowledge-based content assembly that enables content to be shared between many templates. Of equal importance, your staff can maintain and modify the content in a strict and audible way without any programming, and apply compliance rules, style, and variable substitution on a global scale.

Cost and risk reduction—DCA dramatically reduces the costs of generating tailored content while maintaining editorial control over the content. The result is lower costs and risks.

Ease of use—Users can continue to use their existing desktop tools for content creation. Using a simple point-and-click interface, users can easily build templates that contain conditional sections.

Automated data access and process flow—Client information held in existing database systems can be automatically incorporated with the documents at publish time. In addition, DCA automates many of the approval processes needed to approve client communications.

Autonomy™ Inc. Advertises its Dynamic Reasoning Engine (DRE™):

Autonomy's Dynamic Reasoning Engine is based on advanced pattern-matching technology that exploits high-performance probabilistic modeling techniques. The DRE™ performs the core information operations:

Concept matching: The DRE™ accepts a piece of content* or reference (identifier) as an input and returns references to conceptually related documents ranked by relevance, or contextual distance. This is used to generate automatic hyperlinks between pieces of content.

Agent creation: The DRE™ accepts a piece of content* and returns an encoded representation of the concepts, including each concept's specific underlying patterns of terms and associated probabilistic ratings.

Agent retraining: The DRE™ accepts an agent and a piece of content* and adapts the agent using the content.

Agent Matching: The DRE™ accepts an agent and returns similar agents ranked by conceptual similarity. This is used to discover users with similar interests, or find experts in a field.

Agent Alerting: The DRE™ accepts a piece of content and returns similar agents ranked by conceptual similarity. This is used to discover users who are interested in the content, or find experts in a field.

Categorization: The DRE™ accepts a piece of content and returns categories ranked by conceptual similarity. This is used to discover which categories the content is most appropriate for, allowing subsequent tagging, routing or filing.

Summarization: The DRE™ accepts a piece of content and returns a summary of the information containing the most salient concepts of the content. In addition, summaries can be generated that relate to the context of the original inquiry—allowing the most applicable dynamic summary to be provided in the results of a given inquiry.

Clustering: The DRE™, in conjunction with the Clusterizer module, can organize large volumes of content or large numbers of profiles into self-consistent clusters. Clustering is an automatic agglomerative technique which partitions a corpus by grouping together information containing similar concepts.

Active Matching: The DRE™ can accept textual information describing the current user task and returns a list of documents ordered by contextual relevance to the active task.

Retrieval: The DRE™ accepts natural language queries and returns a list of documents containing the concepts looked for, ordered by contextual relevance to the query. The DRE™ also supports Boolean queries.

These products and related systems are but a few of a number of similar products now offered to businesses to address the general “Content Management and Delivery” problem. While these products address specific parts of the general problem and indeed can be used as third party tools/assets in a specific solution to the general problem, they do not address or solve several key areas of need for successful overall content management and delivery solutions. The present invention is a unique, automated approach to providing corporate content management services and delivery capabilities to help large enterprises manage physical and digital content more effectively. A company's brand, products, and/or services are represented by its content. Nowadays, products and services have even shorter life cycles, unpredictable volume levels and an unprecedented number of marketing and sales channels. It is crucially important that businesses and their partners (e.g. marketing, design firms, fulfillment providers, print fulfillment providers) operate under a comprehensive methodology along the content value chain.

The content management and delivery framework described more fully below, and the supporting methods aid in critical discussion and analysis of content management and delivery needs. The framework lays out related areas that should be involved in content management and delivery implementation efforts (e.g., content creation and management, content sourcing, web-based ordering, content fulfillment and distribution, and supplier functions). Whereas the products and providers described earlier assist with addressing certain content management needs, this method, framework, key considerations and processes address the up-front steps of assessing/determining specific needs and planning specific implementation approaches.

These demands for improved content management have led to the conceptualization of “Enterprise Content Management” (ECM) designed to create successful synergies between paper, documents and web content. The product development companies mentioned above and others generally belong to the Association for Information and Image Management (AIIM) (formerly known as the National Microfilm Association) to promote ECM. The defined Enterprise Content Management (ECM) technologies are key enablers of e-Business and include: Content/Document Management, Business Process Management, Enterprise Portals, Knowledge Management, Image Management, Data Warehousing, and Data Mining.

While many of the companies and applications mentioned above focus on one or more of these processes, there is a need for a system to cover the entire process. That is a system and process to efficiently integrate the handling of content creation and availability, management of content data, handling of content order processing, sourcing content to fulfill orders and manufacturing production of content. Such an integrated process, to be successful, must also effectively deliver content to users, reasonably price such content delivery services and efficiently bill users for such services, and effectively provide for cultural differences related to the location of users through an efficient Internationalized system design which permits easy and effective localization of as much content as possible. Such cost efficient localized content management considerations and processes are applicable to the management and delivery of educational material, marketing material, human resources information, formalized knowledge, product information, electronic learning and training, news and articles, collateral, travel information, and personalized content to name just a few areas.

### SUMMARY OF THE INVENTION

The present invention provides a solution to the needs described above through a corporate content management and delivery system and method.

The present invention provides a computer-based corporate content management and delivery (CCMD) system. The CCMD system provides efficient storage, management, and delivery of corporate content in response to orders for such content. The CCMD system includes a first module configured to create digital and/or acquire digital content for repurposing in a digital and/or a physical format. A second module, which is electronically coupled to the first module, manages data necessary to process and execute orders for such corporate content in one of digital format and physical format. A third CCMD system module integrates operations of the first module and the second module. The third module also coordinates these operations with internal and/or external third party content/product providers and customers.

Still other embodiments of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

The features and advantages of the system and method of the present invention will be apparent from the following description in which:

FIG. 1 shows one embodiment of the architecture for the Corporate Content Management & Delivery (CCMD) System.

FIG. 2 shows another embodiment of the CCMD System.

FIG. 3 shows a detailed drawing of the vertical applications and how the CMMD integrates with internal and/or external systems.

FIG. 4 shows one embodiment of the network and physical machine components which make up the CCMD core infrastructure.

FIG. 5 shows a process flow diagram of the User Login and Registration module.

FIG. 6 shows a process flow diagram of the Company Information module.

FIG. 7 shows a process flow diagram of the Profile Administration module.

FIG. 8 shows a process flow diagram of the Catalog Browse & Search module.

FIG. 9 shows a process flow diagram of the Shopping Basket module.

FIG. 10 shows a process flow diagram of the Checkout module.

FIG. 11 shows a process flow diagram of the Order History module.

FIG. 12 shows a process flow diagram of the user account help module.

FIG. 13 shows a process flow diagram of the order processing module.

FIG. 14 shows a process flow diagram of the returns processing module.

FIG. 15 shows an embodiment of the CCMD production environment.

FIG. 16 shows a diagram of the internal/external system integration server messaging architecture.

FIG. 17 shows a process flow diagram of CS2k_EmployeeInfo Application Integration Component (AIC).

FIG. 18 shows a process flow diagram of CS2k_InternalCodes Application Integration Component.

FIG. 19 shows a process flow diagram of the Staging_Items Application Integration Component.

FIG. 20 shows a process flow diagram of CS2k_Items Application Integration Component.

FIG. 21 shows a process flow diagram of Yantra_Inventory Application Integration Component.

FIG. 22 shows a process flow diagram of Yantra_Orders Application Integration Component.

FIG. 23 shows a process flow diagram of Yantra_ShipDetails Application Integration Component.

FIG. 24 shows a process flow diagram of the WMS_Items Application Integration Component.

FIG. 25 shows one embodiment of the physical layout of the staging environment.

FIG. 26 shows one embodiment of the Staging to Production Migration Process.

FIG. 27 shows one embodiment of the demo environment, development environment, and assembly test environments.

FIG. 28 shows one embodiment of the Product Test environment.

FIG. 29 illustrates the differences between parallel sites versus independent sites.

FIG. 30 shows a process flow diagram for the language selection process.

FIG. 31 shows a process flow diagram of the exception processing module.

FIG. 32 shows a navagation map having possible navigation locations.

FIG. 33 shows a process flow diagram for the DAM/CS2k interface.

FIG. 34 depicts a representation of the general CCMD preferred embodiment.

### DETAILED DESCRIPTION OF THE INVENTION

The present invention provides a solution to the needs described above through a system and method for a web-based repository and content ordering mechanism which allows companies to more efficiently manage the ingestion, administration, and distribution of physical and digital corporate content.

The Corporate Content Management & Delivery System (CCMD) is a unique, automated approach to providing corporate content management services and delivery capabilities to help large enterprises manage physical and digital content. CCMD provides a new business capability that can be potentially hosted through a Managed Services provider. This would provide large enterprises open access through a browser for procurement, distribution, and administration for digital and physical content (brochures, training, materials, advertisements, et al) and Point of Sale materials (tent cards, pamphlets, CDs, VHS tapes).

The CCMD framework described more fully below, and the supporting methods aid in the description of content management and delivery needs. The CCMD framework lays out primary components involved in content management and delivery implementation efforts including:

Content Creation, Management and Acquisition—functionality regarding the creation, management and content submission process for repurposing in digital or physical format and association of metadata. This enables corporations to effectively aggregate their content assets (digital “finished goods” and digital components) into a single repository.

Content Sourcing—support for the sourcing of content for physical and digital fulfillment. This addresses functionality related to the quotation and purchase order creation for physical and digital products or services.

Content Ordering and Administration—provides the vehicle for ordering physical and digital content and supporting processes. Includes the administration functionality related to content fulfillment processing (i.e. billing, settlement, inventory visibility).

Content Fulfillment—functionality managing the physical or digital fulfillment of content. Includes capabilities and the workflow involved with all aspects of an order from completion of input through fulfillment.

Supplier Functions—supports the main interface solution for the system to communicate with the solution suppliers. Includes sending and receiving: status, orders, inventory levels, files, data, ship/order confirmations, and billing/accounting information.

Content Reporting/Pipeline Visibility—functionality that allows companies real time views into the usage of corporate materials; giving them the opportunity to respond to fluctuations in demand for information/products more quickly.

Core product capabilities of the CCMD include:

Internationalization—Internationalization is the process of developing an application so that it can be adapted to different languages and regions, using generic coding and design strategies and whose source code base simplifies the creation of different language programs. An internationalized application allows users to enter, store, process, retrieve, print, and display data in their language of choice in formats matching their cultural expectations. This includes date formats, currencies, symbols, sort order, pictures, measurement systems, system messages, product information (metadata), and so on. Products tested include English and one other European language. CCMD's approach to multi language/globalization is to design the database and applications to support internationalization and localization for user interfaces, templates, pricing, shipping methods, and privacy and local business rules. In one embodiment the site does not include a multi language version but appropriate product testing can be conducted to test multi language capability. Multi language/globalization can be incorporated into the system upon client request.

Stateless Architecture—The system is designed to maintain no state (user data) thereby promoting robust scalability.

Multi-enterprise capabilities—The CCMD architecture can be used to host a system for multiple clients or departments within a client. CCMD is designed with hosting in mind to support multiple enterprises within the same hardware configuration. In addition, CCMD can be packaged as a non-hosted, single-enterprise solution. The CCMD makes three primary modifications to build the multi-enterprise feature: installs separate Microsoft's® Commerce Server 2000 (CS2k) sites, uses a page controller development framework, and enhances Microsoft's® Commerce Server 2000 BizDesk Application (BizDesk) tool for enhanced content, product and campaign management.

Configurable options for user profile, shipping methods, and catalog management by client/department.

Staging content/product updates from the administrative system to production. This includes completing the CS2k data staging architecture so that it is completely reusable.

Personalized catalogs based on user profiles

Created BizTalk™ framework and interfaces for third party fulfillment and Digital Content ingestion.

Warehouse integration and application to application integration.

Complete XML communication layer

Full integration with Avanade Connected Architecture™ from Avanade™, Inc. for state management, code/decode, error handling, validation, XML interface, templates, security, and logging.

Through joint discussions and analysis using this framework and associated processes and key considerations, a common understanding of needs, and best implementation approaches can be determined. The Framework and associated processes and key considerations describe in detail the module descriptions within CCMD, the data flow between the modules and any custom development for the modules. The CCMD solution can be easily re-used across different enterprises, and to create an architecture that enables a quick development cycle for each additional client.

CCMD Preferred Embodiment Overview

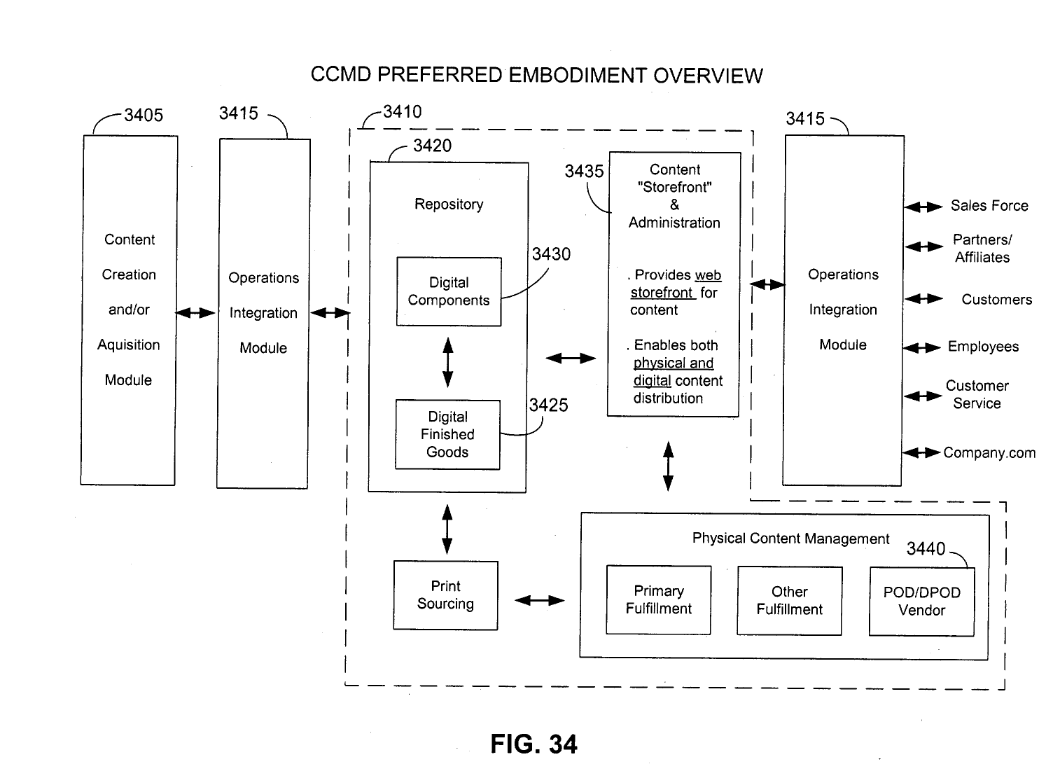

Referring now to FIG. 34, the basic CCMD system is described in general. The CCMD system includes a content creation and/or acquisition module 3405, a digital content and order management module 3410, and an operations integrations module 3415. The content creation and/or acquisition module 3405 is responsible for the content creation and submission process of digital content for repurposing in digital or physical format. The creation or acquisition of digital content can come from creative agencies, marketing, human resources, graphics, or training representatives, etc.

The digital content and order management module 3410 enables corporations to effectively aggregate their digital content (digital “finished goods” 3425 and digital components 3430) into a single repository 3420. The digital content and order management module 3410 also provides a content “storefront” 3435 which serves as the vehicle for ordering physical and/or digital content and supporting processes. This includes the administration functionality related to and necessary for content fulfillment processing and dealing with print-on-demand (POD) and digital print-on-demand (DPOD) vendors 3440. Furthermore, the digital content and order management module 3410 provides support for sourcing of the content for physical or digital fulfillment. This addresses functionality related to the quotation and purchase order creation for physical print products or services from completion of input through fulfillment. The operations integration module 3415 integrates the operations of the content creation and/or acquisition module 3405 and the digital content and order management module 3410. The operations integration module 3415 also coordinates these operations with internal and/or external third party content/product providers. This includes the guarantee of sending and receiving: status, orders, inventory levels, files, data, and billing/accounting information, et al. Such third party content/product providers can include a sales force, partners/affiliates, employees, customer service, a company website, or even end customers.

Architecture Overview

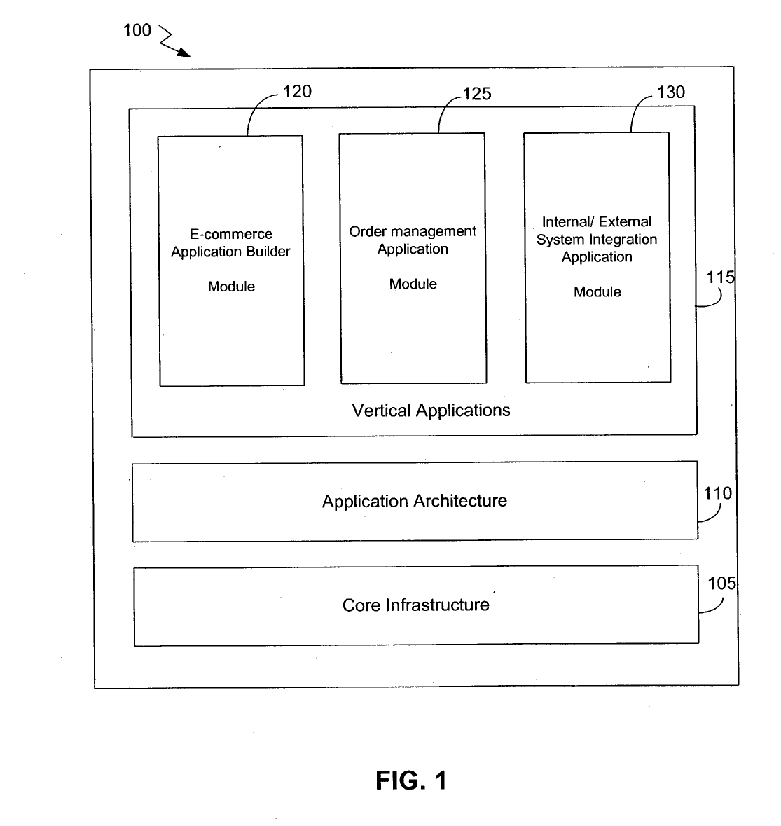

The Corporate Content Management & Delivery (CCMD) 100 architecture shown in FIG. 1 is composed of three primary layers: a core infrastructure 105, a application architecture 110, and vertical applications 115. The vertical applications 115 which make up the core pieces of the business logic in the CCMD 100 include at a minimum an e-commerce application builder module 120, an order management application module 125, and an internal/external system integration application module (I/E integration application module) 130. The remainder of this patent application describes the present invention in terms of presently preferred embodiments and examples.

Following is an example provided to help increase the understanding of the system and method of the current invention, including use of the CCMD framework and the development and use of key considerations and specific processes inherent in any particular content management and delivery system. Mention of vendor and product names is meant to be representative, and where appropriate, particular vendors/products used in a current best mode will be indicated. Those skilled in the art will recognize that additional equivalent products are made available by vendors frequently. It will also be apparent to those skilled in the art to which the invention pertains that variations and modifications of the various embodiments and examples shown and described herein may be made without departing from the spirit and scope of the invention.

A Solution Example

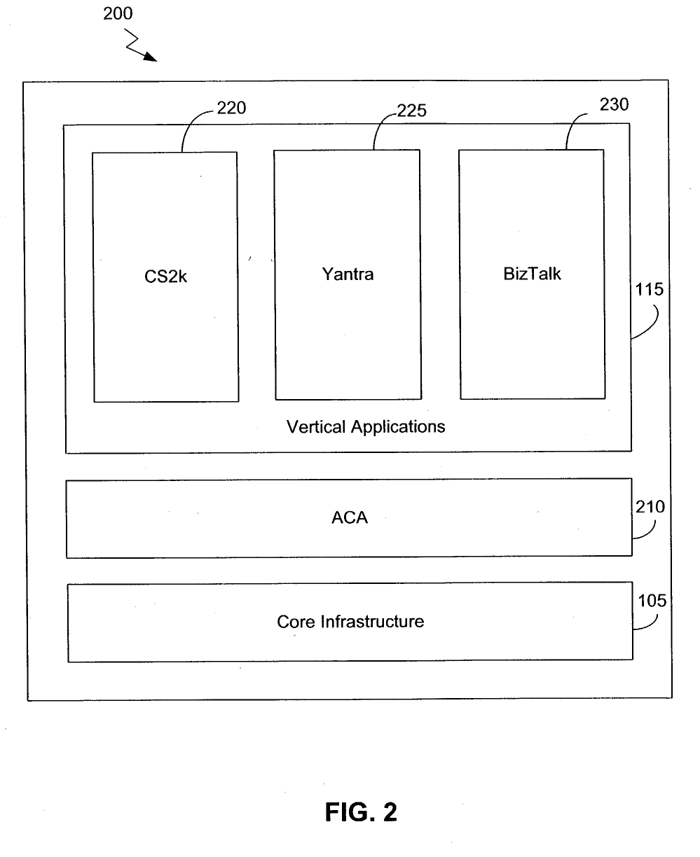

FIG. 2 shows one embodiment of the Corporate Content Management & Delivery (CCMD) 200. The application architecture 110 is Avanade's Connected Architecture™ (ACA) 210, the e-commerce application builder module 120 is Microsoft's® Commerce Server 2000 (CS2k) 220, the order management application module 125 is Yantra's Order and Inventory Management Application™ (Yantra) 225, and the Internal/External system integration application module 130 is Microsoft's® BizTalk™ (BizTalk™) 230. In another embodiment, the core infrastructure 105 is Unix operating system, the application architecture 110 is WebLogic, the e-commerce application builder module 120 is Broadvision, and the Internal/External system integration application module 130 is WebMethod.

The Core Infrastructure 105 is the hardware, operating system, and network infrastructure on which the vertical applications 115 are executed. In one embodiment, the core infrastructure 105 is Microsoft® Advanced Server. The core infrastructure 105 is discussed in greater detail below. In this exemplary configuration, the underlying CCMD architecture leverages the Avanade Connected Architecture 210. The Avanade Connected Architecture 210 is an application architecture ‘starter kit’ that provides a foundation for building robust, scalable eBusiness solutions. The Corporate Content Management & Delivery System in this exemplary configuration 200 uses the Avanade Connected Architecture 210 framework (ASPs calling page controllers that use Data Access components) with CS2k 220. The Avanade Connected Architecture 210 is used to handle areas such as runtime error handling, message logging, data access, and client side validation. Other Avanade Connected Architecture 210 components such as custom caching and initiation of batch operations may also be integrated. In addition, Avanade Connected Architecture 210 can be extended to support Yantra 225, BizTalk™ 230 and similar applications.

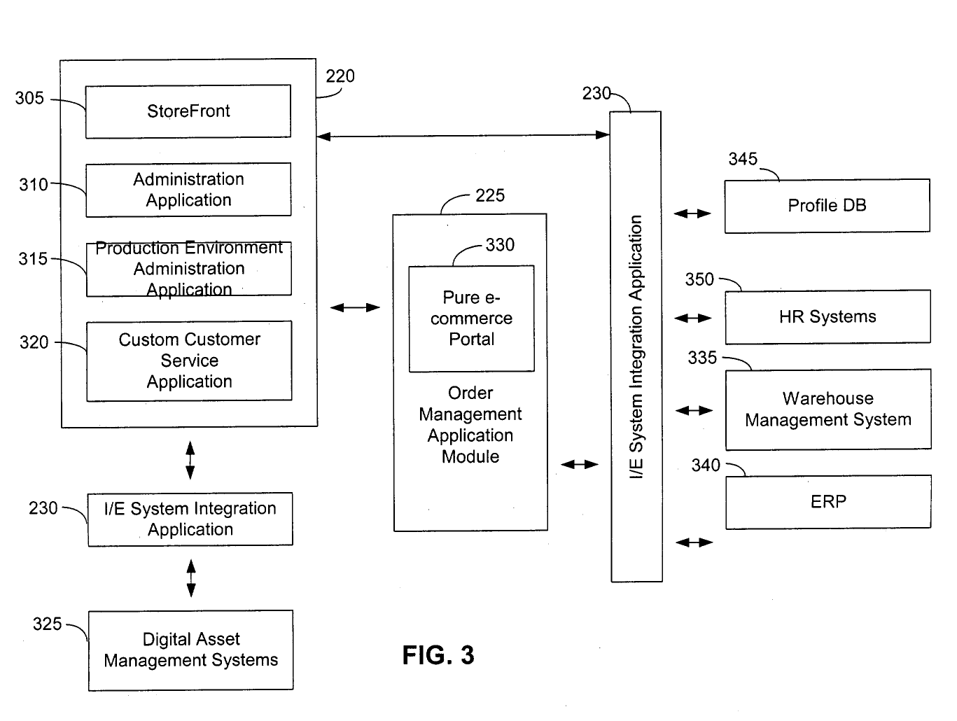

Referring now to FIG. 3, CS2k 220 vertical application can comprise the following:

StoreFront Application 305—a customer interface for the presentation of product browsing, ordering and shopping.

Administration Application 310—The administration application 310 is used by Administrators and content/product owners to create and manage products, campaigns, and customer profiles. In one embodiment, the administration application 310 can be a new, custom, web-enabled version of BizDesk.

Production Environment Administration Application 315—The production environment administration application is an application used by the CCMD administration team to maintain and manage the production environment. In one embodiment, the production environment administration application 315 can be Advanced Server Management Utilities.

A Custom Customer Service Application 320—The custom customer service application 320 uses CS2k 220 framework and accesses order information via Yantra 225 Pages.

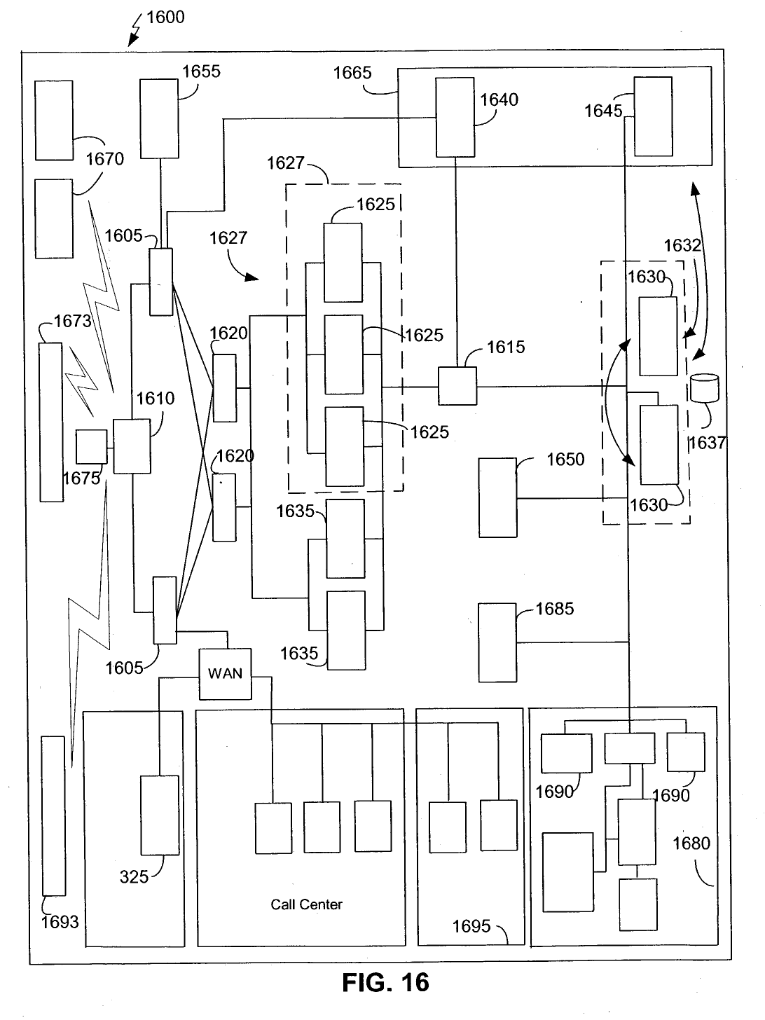

Yantra 225 manages orders across client warehouses 1670 which are described below with reference to FIG. 16. Part of the CCMD solution provides a Warehouse Management System 335 (WMS) interface to Yantra 225. In addition, CCMD provides a pure e-commerce portal 330 that gives warehouse 1670 users on-line access to new order information. The warehouse users 1670 can also use the pure e-commerce portal 330 to update inventory and order status. In one embodiment, the pure e-commerce portal can be Yantra's Pure eCommerce Portal.

BizTalk™ 230 integrates the CCMD systems with external systems (e.g. Digital Asset Management (DAM) systems 325, WMSs 335, HR systems 350, ERP systems 340, profile databases 345, etc.) In addition, CCMD uses BizTalk™ 230 for internal system interfaces where delivered APIs are not available (i.e. passing of product information from CS2k 220 to Yantra 225) or not appropriate (i.e. Create Order).

The Technical Architecture of CCMD comprises three major environments:

Production Environment 1600 (See description below re: FIG. 16)—The production environment 1600 is the customer-facing, run-time environment. The production environment 1600 is built-out on a per client basis. The production environment 1600 can also be located at a Hosting Provider site.

Staging Environment 1665—The client's content/product owners and managers are the primary user of the staging environment 1665. The content/product owners and managers use the staging environment 1665 to confirm web site and content changes before deploying them to production. This environment is built-out on a per client basis. The staging environment 1665 can be located at a Hosting Provider site.

Development and Test Environment—The web pages and back-end functionality for the CCMD system are developed and tested in this environment. Performance testing and product testing are included. An exemplary development and test environment can be located at a developer business launch center such as, for example, Accenture's Solution Centers.

Core Infrastructure 105

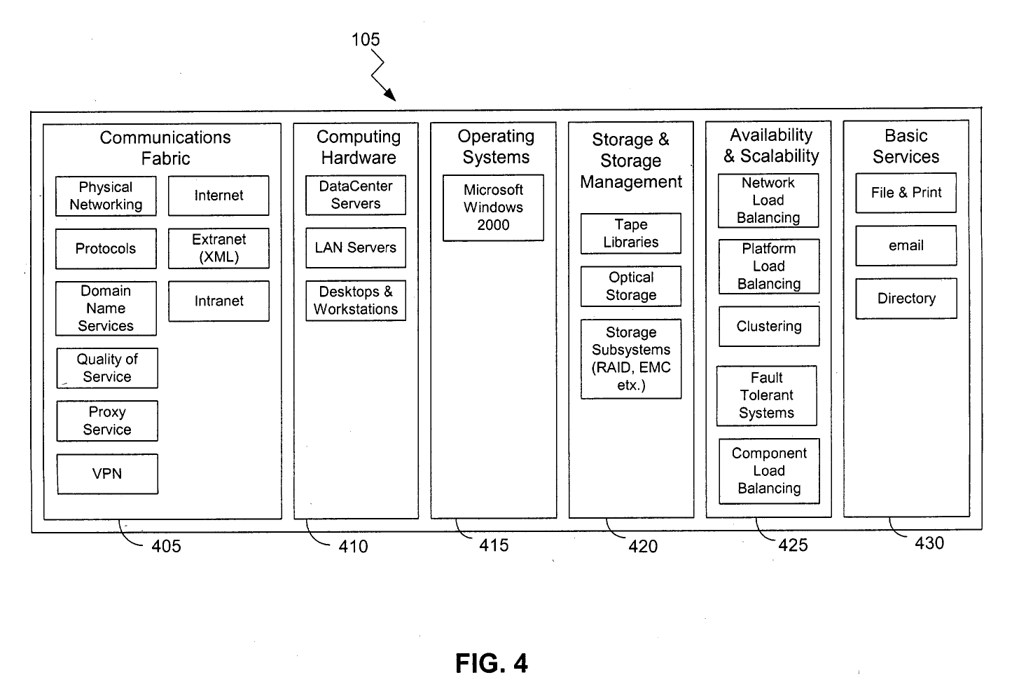

The services within the core infrastructure 105 of the CCMD shown in FIG. 4 can be provided by an outsourced solution. A hosting provider can implement, manage, and maintain the core infrastructure 105. Core infrastructure 105 services include the underlying network and physical machine components. FIG. 4 shows one embodiment of the network and physical machine components which make up an exemplary CCMD core infrastructure 105.

The Core Infrastructure 105 is comprised of six major areas:

Communications Fabric 405—The communications fabric 405 provides the hardware, software, protocols, and services necessary to facilitate communications as well as network management. The Hosting Provider can provide the physical networking infrastructure and connectivity. The Hosting Provider can manage and maintain the network and Internet access components. A virtual private network (VPN) can be established between the client and the Hosting Provider to support the upload/download of digital assets and metadata, if necessary.

Computing Hardware 410—The computing hardware 410 is physical hardware components of the infrastructure including strategies for sustaining growth and performance. The CCMD architecture can define the hardware configuration, but the Hosting Provider can acquire and manage the physical hardware.

Operating Systems 415—The operating system 415 includes the operating system software, the management and configuration processes for ensuring standardization and interoperability. In one embodiment, the standard operating system 415 for the CCMD architecture can be Windows Advanced Server 2000. Those skilled in the art will understand that other operating systems may be used such as Sun Microsystems Solaris™ or a Unix based equivalent. The Hosting Provider can install, support, and maintain the operating system 415 software.

Storage and Storage Management 420—Storage and storage management 420 includes database and file management and backup/restore capabilities. The Hosting Provider can define appropriate storage management 420 for the system so long as minimum requirements of the CCMD architecture are implemented. The Hosting Provider has primary responsibility for executing backup and restore functions.

Availability and Scalability 425—Availability and scalability 425 includes the components and processes that enhance the availability and scalability of the complete CCMD system. The Hosting Provider has sole responsibility for ensuring the 24×7 availability and scalability of the network and data center facilities. The CCMD architecture specifies the production architecture to provide the appropriate amount of availability as defined by the clients but also with the appropriate degree of scalability to easily add on new clients.

Basic Services 430—Basic services 430 covers email forwarding, file and print sharing, directory services and other common infrastructure services. CCMD can provide email-forwarding capabilities to send emails from the particular applications to end users.

Storefront Application 305

Functionality

The StoreFront application 305 is the customer-facing application through which an enterprise can market, sell and deliver their products. For the CCMD solution, these products can primarily be marketing materials that are digital in format. However, the StoreFront 305 is designed to handle assets of a physical nature as well. The StoreFront application 305 is further broken down into the following functional modules:

User Login and Registration Module

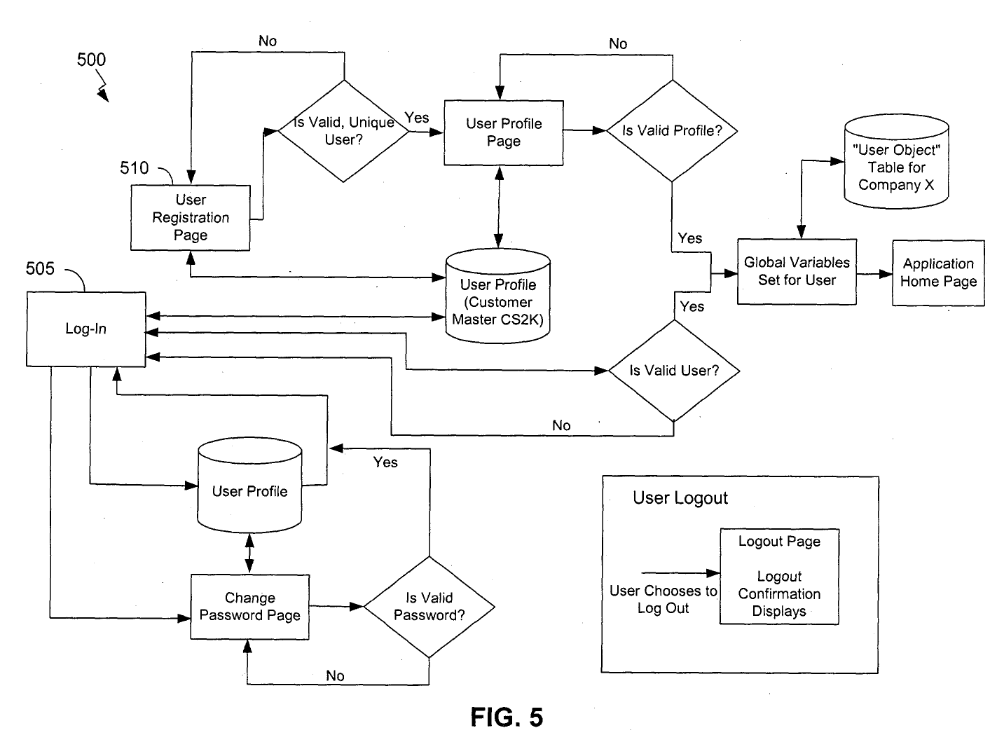

FIG. 5 shows a process flow diagram 500 of the User Login and Registration module. The user login and registration module is responsible for providing registered users a mechanism for logging into the StoreFront application 305 and CCMD site (step 505). The user login and registration module may also provide a means for anonymous users to register on the StoreFront application 305 and CCMD site(step 510). The CCMD site login can determine the user's role (e.g. customer, content creator/owner, content approver/administrator, customer service rep, marketing rep) and the appropriate menu options are displayed.

Company Information Module

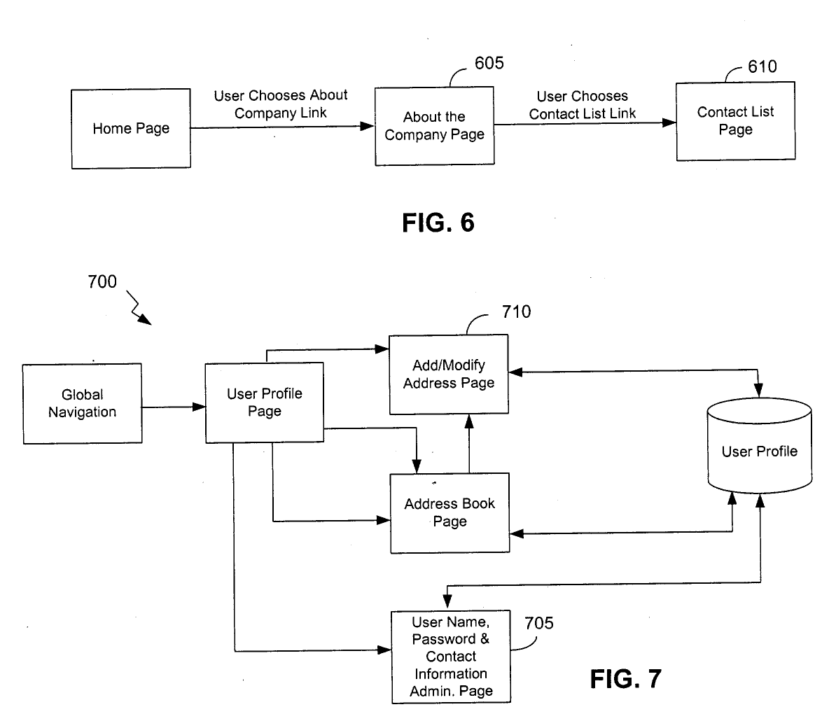

FIG. 6 shows a process flow diagram of the Company Information module. The company information module is responsible for displaying enterprise information to the end consumer such as “About Company” info (step 605), and contact information (step 610), returns/cancellation policy, etc.

Profile Administration Module

FIG. 7 shows a process flow diagram 700 of the Profile Administration module. The profile administration module is responsible for providing users a mechanism for managing their profile information. This includes changing name or passwords in step 705, creating and updating addresses (e.g. bill to, ship to and forward to) in step 710, etc.

Catalog Browsing and Search Module

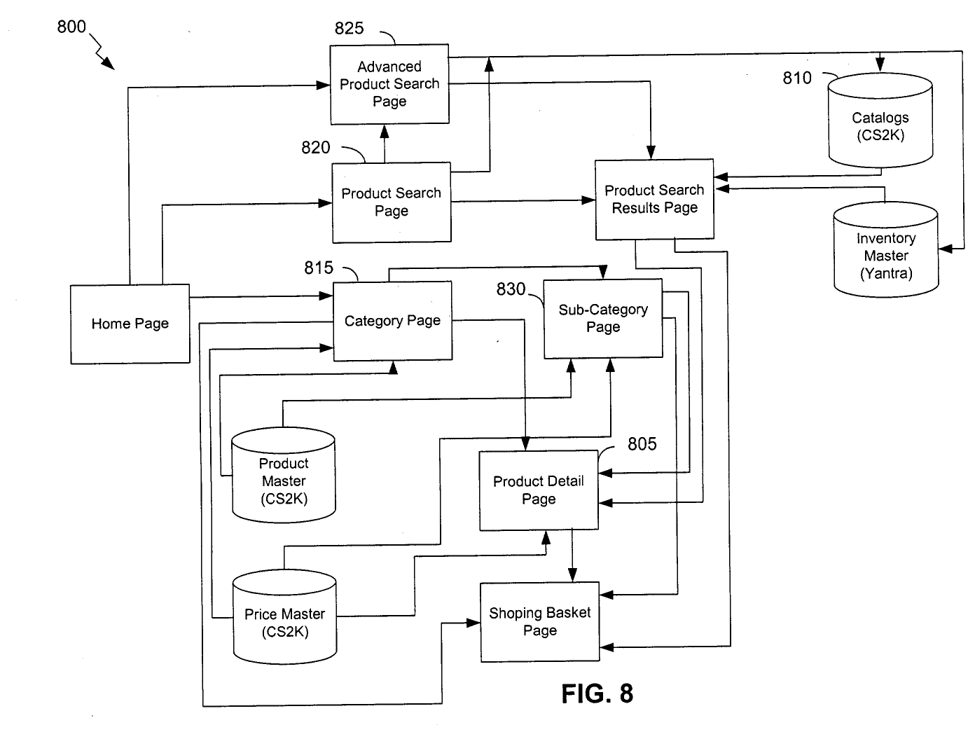

FIG. 8 shows one embodiment of a process flow diagram 800 of the Catalog Browse & Search module. The catalog browsing and search module is responsible for displaying the enterprise's product detail information to the user. Products are organized within catalogs 810 that are further broken down into categories 815. The categories 815 are then further broken down into sub-categories 830. The sub-categories 830 can have one or many products pages associated with it. Furthermore, each product page can have one or more product detail pages 805. Product detail pages 805 provide additional information about a product, including whether or not the product is in stock. Users are able to search across catalogs for a particular product as shown in step 820. Note that the location of master files is dependent on client specific requirements (excluding catalogs and inventory). An advanced searching mechanism 825 based on keywords is also available in addition to the basic catalog search. In one embodiment, the advanced searching mechanism is the default advanced searching mechanism from CS2k and can search by SKU ID, product ID, title, description and keywords.

Shopping Basket Module

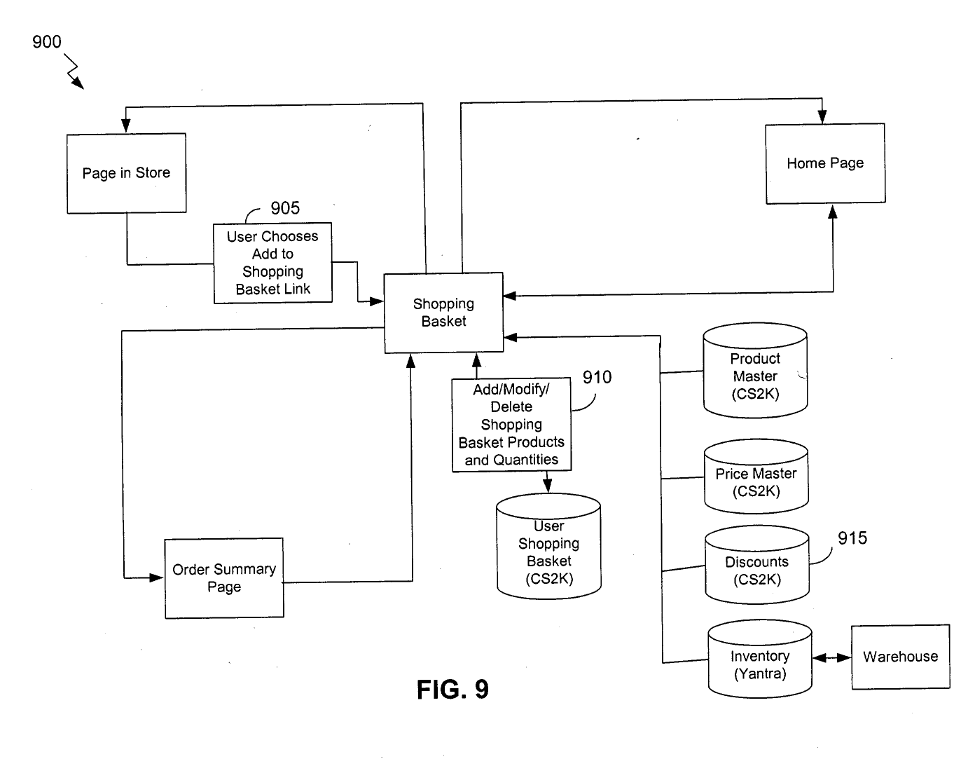

FIG. 9 shows a process flow diagram 900 of the Shopping Basket module. The shopping cart module is responsible for managing a user's shopping basket. A user can add and delete products from their basket in step 905. In addition, a user can modify quantities of products from their basket in step 910. As products are added to the shopping basket, a “soft reserve” is made within the Inventory Master (a.k.a. Yantra 225). Users may also view a running subtotal for the products in their basket, along with any discounts 915 that may be applied from the shopping basket or from the Home Page.

Checkout Module

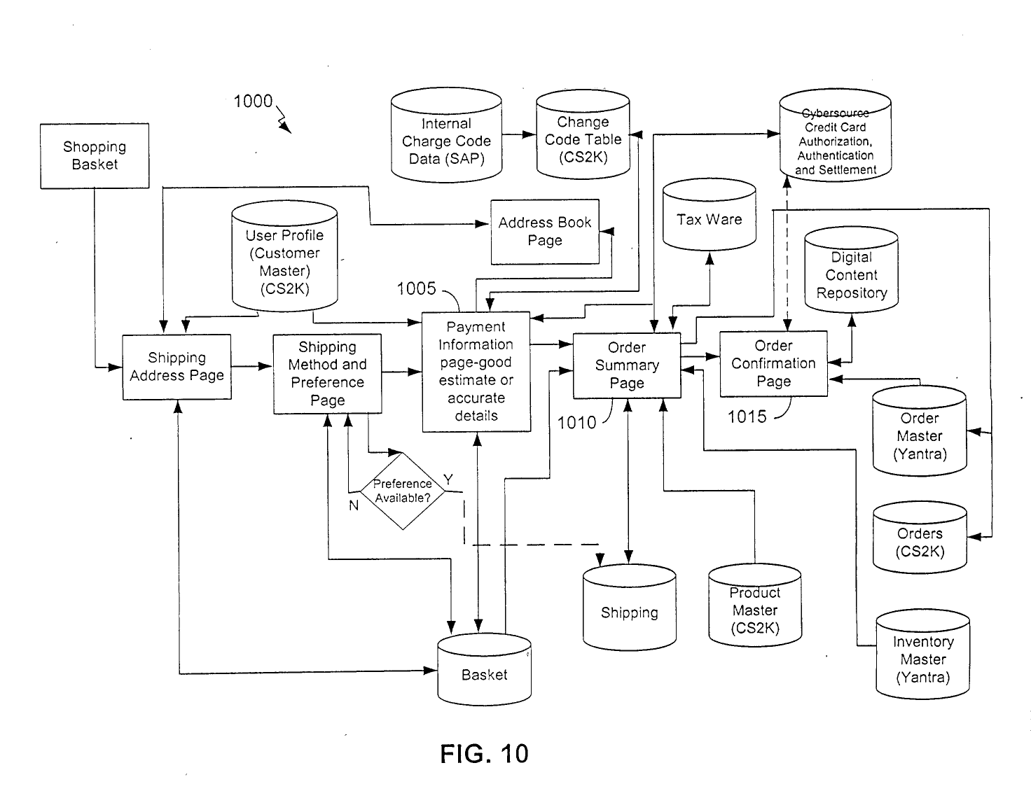

FIG. 10 shows a process flow diagram 1000 of the Checkout module. The checkout module represents the checkout process (e.g. taking a shopping cart from “basket” stage to an actual completed order). This includes functionality for capturing payment information in step 1005, bill to address information, shipping method, and shipping address in an order summary at step 1010. An order confirmation and shipping confirmation can also be obtained (after submitting the order from CS2k 220 to Yantra 225) in step 1015.

Order Status/History Module

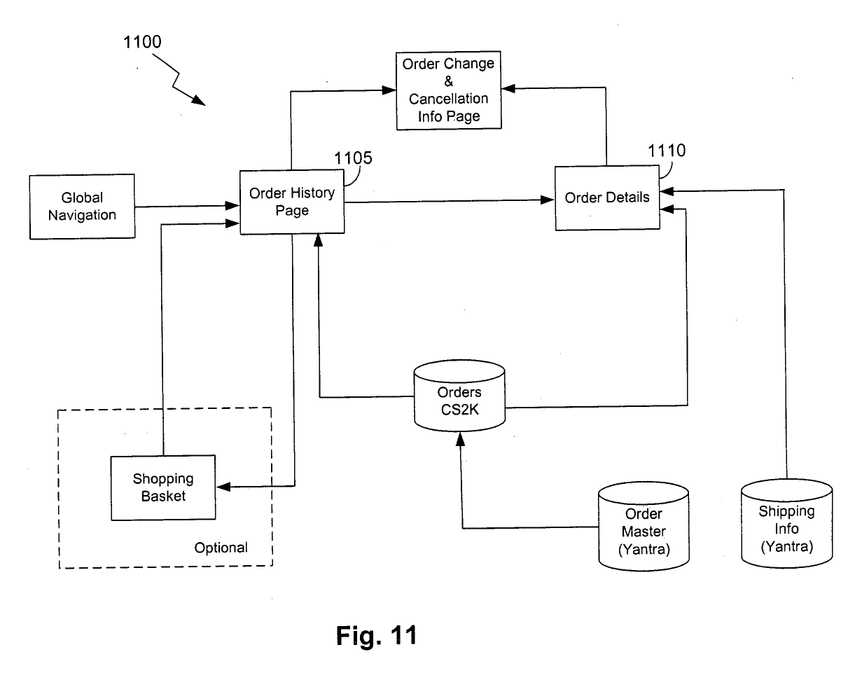

FIG. 11 shows a process flow diagram 1100 of the Order History module. The order status/history module is responsible for allowing a user to view their order history or check on the status of an outstanding order. A user can view all recent orders within a specified timeframe and search for a particular order beyond that timeframe if desired at step 1105. Users can also view the details of the order at step 1110. If the order is designated as “shipped”, the user is provided with a carrier tracking number that can be used to obtain further details from the carrier's website. This tracking number can be displayed as a hypertext link which directs them to the carrier's website.

Design Considerations

Leveraging Available Assets

The StoreFront application 305 leverages BizTalk™ 230 components and pipelines for user login & registration, profile management, catalog management and checkout which have already been developed as part of Microsoft® CS2k Capability Development Project. The Microsoft® CS2k Capability Project is based off the Retail Solution site which is a part of CS2k 220. Each window within the StoreFront application 305, as well as the underlying business functionality, can be built following the application architecture methodology defined by ACA 210 (e.g. page controllers, error handling and other architectural components). The code within the existing ASPs can be relocated so that the logic is encapsulated in page controllers, business components, and comply with CCMD standards. There may also be some customization with respect to digital downloads and robust, real time integration with Yantra 225.

In summary, the Retail Solution Site will be leveraged for the following functionality:

User Login/Authentication

Product Catalog (Browsing and Search)

Address Management

Profile Management

Shopping Basket

Payment Options

Checkout

Order Summary

Order Confirmation

Features requiring slight customization:

Catalog Browsing—A user can view the inventory level of a product as they browse. This requires a call to Yantra 225 to check the inventory level for that product. There may also be additional product attributes that can be displayed, not currently available in the CS2k 220 product schema. Some attributes for the management of digital products can include file size and file type, etc. Some attributes for the management of physical products can include fulfillment vendor and lead time, etc. Also included is the ability to navigate an N-tier product hierarchy and associate products at any level.

Shopping Basket—As products are added to the basket, Yantra 225 is called to reserve inventory.

Order Confirmation—To support the delivery of digital assets to the end user, links to the assets are provided so the user can download the assets after purchasing. Order confirmation is integrated with security and authentication/settlement.

Address Management—Additional attributes such as billing content information and multiple ship-to addresses are captured as part of the address object.

Profile Management—Additional attributes such as product owner, content author, content editor, and content approver are captured as part of the user profile object.

Features requiring major customization:

Checkout—To support payment-processing requirements, CyberSource™ is integrated into CCMD for credit card authorization and settlement. When orders are placed using a charge code, the charge code is validated against internal charge code tables. Once the order is submitted, the order and all other required information are passed to Yantra 225 for fulfillment. This is accomplished by generating the order as XML, sending the order to a BizTalk™ 230 queue, and then having the order picked up from BizTalk™ 230 queue and processed via Yantra's 225 create rder API.

Catalog Search—Search results are configured by the CCMD System and limited to twenty per page.

Shipping Methods—The CCMD System allows for multiple shipping orders and The delivery services offered and their associated costs need to be customized. The systems allow for multiple shipping vendors and methods (e.g. by weight or fixed unit cost). Tables may need to be loaded and the system configuration may need to be set to associate particular methods with particular vendors.

Features requiring complete customization:

Order Status/History/Tracking—Yantra 225 is the Order Master so available Yantra 225 APIs are used to feed custom pages to present the information to the user.

About Company and Customer Service pages—The Company and Customer Service pages are designed/built so that the entire site can be re-skinned and content can be modified per enterprise.

Customer Data

The Customer Master resides within the CS2k 220 environment. The authentication of users is also performed within the CS2k 220 environment. Yantra 225 needs to know the customer placing the order (and their enterprise) in order to execute the appropriate fulfillment rules for the order. Yantra 225 also requires customer contact information for following up on orders (e.g. sending order confirmation emails). Consequently, when an order is placed, CS2k 220 passes the necessary customer information to Yantra 225, thus eliminating the risk of an order being placed by a customer that is unknown to Yantra 225. Furthermore, since the customer is authenticated prior to placing the order, Yantra 225 can assume that the customer id and enterprise id are valid and just apply the appropriate fulfillment rules to that enterprise/customer, thus Yantra 225 requires less logic. CS2k 220 also passes the customer's contact information to Yantra 225 with the order so Yantra 225 can send order confirmation emails.

Enterprise information is setup in CS2k 220 as new companies sign up with CCMD. Yantra 225 requires specific enterprise information for configuring fulfillment rules. CS2k 220 requires enterprise information for setting up access control. The enterprise id can be the same across both Yantra 225 and CS2k 220. In one embodiment, ensuring that the enterprise id is the same across both Yantra 225 and CS2k 220 can be a manual process that is part of the process for adding a new enterprise to CCMD.

Pricing Data

Pricing information can be stored in CS2k 220 as part of the Product Master. Yantra 225 may need access to the prices in order to re-price an order that may have changed during the fulfillment process. Consequently, the price per product may need to be sent to Yantra 225 as part of the order. Since re-pricing an order is an exception and not the norm, it does not make sense to replicate this vast amount of information in Yantra 225. When products are placed on backorder, the original product price is used so Yantra 225 does not have to obtain the latest pricing information from CS2k 220. In the case where a discounted product price is used due to the quantity ordered and the order quantity is later reduced during the fulfillment process, the discount may no longer apply and Yantra 225 may have no knowledge of this. However, since this is the exception and not the norm, Customer Service can handle these cases manually.

Payment Processing

In one embodiment, the StoreFront application 305 can support payment by credit card authorization and settlement and/or internal billing using charge codes.

Credit Cards—CyberSource™ can be integrated into the CS2k 220 checkout pipeline for credit card authorization. Authorization of the credit card can occur up-front in the StoreFront application 305, which ensures that Yantra 225 only receives orders that are authorized for fulfillment and shipment. Note that both the authorization and fraud detection services of CyberSource are leveraged. In one embodiment, the fraud detection service can be implemented so that it can be turned on/off according to the asset type and enterprise. In another embodiment, the fraud detection can only be turned on for purchases of digital assets. Regardless, the fraud detection service is configurable because the implementation decision can vary according to enterprise. Finally, Yantra 225 can perform the settlement of the order on the backend (also using CyberSource).

Charge Codes—Support for payment by charge codes are custom-built functionality within CCMD. A custom business component is designed\built that accepts a charge code, enterprise id, department id and amount and validate whether or not the charge code can be used by the customer placing the order for the specified amount (for example, is the amount requested within the specified min/max spend limit for that charge code). This capability extends each enterprise the visibility into departmental accounting for their procurement of content material. This allows for greater flexibility in allocating for a budget.

Tax Calculations

In one embodiment, tax calculations can be performed at a product level and done via integration with CyberSource's tax service. In a preferred embodiment, the tax is calculated prior to loading the Order Summary window so that it can be displayed to the user on the screen and stored as part of the order object. The tax per product is sent to Yantra 225 along with the order in case it is needed for re-pricing an order (due to changes in quantity) or re-extending an order. As each new enterprise is configured in CCMD, part of the setup includes determining the enterprise's nexus for doing business. This information can then be used to configure the CyberSource tax service for that enterprise.

Freight Estimates

Freight estimates are performed in CS2k 220. An estimated shipping cost and a pre-determined handling cost can be applied to all orders and passed to Yantra 225 as part of the order. Yantra 225 “settles” the user's credit card (or charge code) based on this estimated shipping cost, even if it is under/over the actual shipping cost. Estimated vs. actual shipping costs are tracked so that they can be viewed as a report and used for further refinement of estimates.

Third party data warehouses may have preferred carriers. At the time the order is placed, it is unknown how the order might be fulfilled and consequently, which carrier might be used. Users are only given the option of delivery service at the time of placing their order. The delivery service options provided are generic enough so as to reflect services common across all carriers (e.g. UPS, USPS and FedEx). Consequently, the associated cost with each service is an average across these carriers and updated to account for rate changes.

Freight is typically calculated by knowing the total weight of the order and the ship to/from locations. Consequently, the product weight may be a required attribute when adding products to the product catalog. Since the ship from location is not determined until allocation, a central, standard location may need to be selected to use for this estimate.

Digital Downloads

The StoreFront application 305 supports the selling of both digital and physical assets. If a physical asset is ordered typically an identifier of the asset is placed in the shopping cart for later use in obtaining the asset. If a digital asset is free, the user can download the digital asset without putting it in their shopping cart. A “download now” link is provided in the product listing within the catalog and on the product detail page. CCMD can track the download of digital products (by customer) and integrate this log into the existing data warehouse for analyzing buyer purchase behavior.

If a user places a digital asset with a price >$0 in their shopping cart and the user only purchases digital products, CCMD bypasses the Shipping Method and Shipping Address screens since they are no longer relevant. The user can still enter their payment information and billing address. The payment method is authorized appropriately (depending on whether it is a credit card or charge code). If the authorization succeeds, the user receives a link to download their digital assets on the Order Confirmation window. The order is passed to Yantra 225 with a status of “Shipped”. Yantra 225 recognizes the products as being digital, allocates them to the “digital” ship node, and then processes the order as normal (settling the credit card/charge code, etc.). Note that the order of a digital asset is settled by Yantra 225 when Yantra 225 receives it. Therefore, if a user experiences problems downloading the product, the user must contact Customer Service who will then deliver the product in an alternative fashion. For example, Customer Service can arrange for appropriate distribution through a secure site using a one time link.

Administration Application 310

Functionality

The administration application 310 is an entirely custom built application leveraging the underlying components and pipelines of Microsoft® BizDesk which allows an enterprise to enter content, approve content, upload digital assets and metadata, create campaigns, organize products into catalogs, and manage users. Although the Microsoft® BizDesk application already provides most of this functionality, the custom built administration application 310 provides significant advantages over BizDesk. Some advantages the administration application 310 has over BizDesk include the following:

The administration application 310 is more user friendly or intuitive than BizDesk.

The administration application 310 performance is faster than the BizDesk Application—performance problems exist when running BizDesk Application in a hosted environment. For example, BizDesk Application requires a dedicated high-speed connection. A 56K connection is not fast enough to run BizDesk Application. Microsoft® CS2k BizDesk recommends using a T1 line or using terminal Services. It is difficult to guarantee using a T1 line or Terminal Services on behalf of the administration application 310 users.

Access to certain modules within BizDesk can be restricted using NTFS file system ACL's making it difficult to maintain in a hosted model for thousands of accounts.

The number of administration application 310 users within an enterprise could be large.

BizDesk requires Internet Explorer 5.5, causing potential browser 1673 compatibility problems.

BizDesk is intended to be run as an HTML Application. Although it is possible to run BizDesk directly from a browser 1673, issues may arise if a user clicks on any of the BizDesk browser buttons (e.g. BizDesk does not respond properly when one tries to navigate Biz Desk using browser 1673 controls as opposed to the actual navigation controls within BizDesk itself).

Note that CCMD site administrators can still use CS2k BizDesk if desired. The administration application 310 is broken down into the following functional modules:

The user management module is responsible for creating new users, assigning users to groups and roles, and “inactivating” users. These screens are only accessible by an enterprise administrator. The administrator has the ability to assign the following roles to a user—content creator/owner, content approver/admin, customer service rep (CSR) and marketing rep. Each of these roles has increased permissions beyond that of a normal StoreFront 305 customer. Users may also be further grouped according to organization (e.g. departmental entities within an enterprise). Catalog sets will be assigned by organization. The User Management Module can perform the following processes:

Profile Creation—administration application 310 users can both create and edit users as necessary. Please note that this application will also have the ability to connect with disparate systems via an XML based interface to import or build a user base.

Organization Creation—Organizations are departmental entities and can be created using the administration application 310. The purpose of organizations are to both help organize enterprises and determine which catalog sets are visible to a department. Note that organizations are optional.

User Search—Searching for users is a key capability for administrative users to find and edit existing users. The administration application 310 allows for user searching based on fixed flexible parameters. Results are displayed in a tabular format where a user can be selected for editing.

User Edit—Users can be edited subsequent to performing a search. An administrator can edit all attributes for a user at any time. Editing a user utilizes the same active server pages as adding a new user. Much of the functionality is the same.

Search Organization—Searching for organizations is one of the searching capabilities available to users to help find and edit existing organizations. The administration application 310 allows for user searching based on fixed flexible parameters. Results are displayed in a tabular format where a user can be selected for editing.

Edit Organization—Administration application users can edit organizations after performing a search. These can be modified at any time and can alter the way users view catalogs.

Content Creation Module

The content creation module is responsible for enabling specified people to submit products to be marketed and sold on the StoreFront 305. If desired, the creators may also assign the products to a particular product catalog and category. The content can undergo an approval process, if necessary, before being published to the production site. The content creation screens capture the necessary information on a product such that the appropriate fulfillment rules can be configured in Yantra 225 (minimum inventory level, preferred fulfillment vendor, order quantity limit, backorder-ability, etc.). The screens can also enable the upload of a digital asset into the CCMD digital repository for selling and distribution on the site, as well as thumbnails for other products. Finally, users can quickly update multiple product prices from a single screen. The Content Creation Module can perform the following processes:

Product Creation—Product creation is a very common functionality with the administration application 310. The product creation process may be necessary for interacting with Yantra and CS2k to specify inventory, product, and reservation information. The product type can either be digital and/or physical.

Product Approval—Products have a lifecycle or workflow which helps to control which products are available to the end user. Having administrators check data also can help control the lifecycle of a product. The product approval process can help companies be more effective by eliminating or reducing errors or inaccuracies and assure legal and Section 508 compliance.

Product Search—Searching for parts is an effective way to find various parts within the catalog structure. Searching for parts is also an effective way to locate products for editing and approving.

Content Approval Module

The content approval module is responsible for enabling content approvers/administrators to review new or updated content submitted by the creators prior to posting it on the production StoreFront 305 site. The screens enable the approvers/administrators to assign product categories and catalogs and change any other attribute of the product if desired. Some enterprises may not have the concept of a “content approver” and rather, trust the content creators/owners to post product information without review. Therefore, the approval process is configurable such that it can be easily turned on (required process) or off.

Catalog Management Module

The catalog management module is responsible for enabling content approvers/administrators to manage the catalogs on the StoreFront 305 site. Catalog management tasks include: activating and deactivating catalogs, adding new catalogs, adding new categories, adding new product definitions, adding new part properties, creating customized catalogs, and assigning catalogs to catalog sets. The Catalog Management Module can perform the following processes:

Catalog Management—The administration application 310 allows products to be grouped within catalogs and categories. Within this structure, proper hierarchical product viewing is possible from the StoreFront 305. Products belong to one catalog but can exist in multiple categories.

View Catalog—In one embodiment of the StoreFront application 305, the catalog can be the first level of navigation for products. The administration application 310 allows administration users to enter in new catalogs and categories.

New Category—In one embodiment of the StoreFront application 305, the category can be the second or N-level within that catalog. The administration application 310 allows administration users to enter categories to which products can be applied.

New Custom Catalog—A custom catalog can be created when a catalog's entire category requires special pricing for certain user groups. The custom catalog contains all the products of the model catalog, however, it contains special pricing at the category level. The custom catalog can then be used in place of the model catalog in the user's catalog set.

New Catalog—The administration application 310 allows administration users to create new catalogs and categories.

View/Edit Custom Catalog—When a catalog's entire category requires special pricing for certain user groups, a custom catalog can be created which contains all the products of the model catalog, but which contains special pricing at the category level. The custom catalog can then be used in place of the model catalog in the user's catalog set.

View Catalog Sets—Catalogs need to be added to a catalog set before the products they contain are viewable on the StoreFront 305. There are two default catalog sets: one for registered users and one for anonymous users. Additional catalog sets can be added and applied to individual users or organizations.

View/Modify Catalog Set—Catalog sets can be modified to reflect new catalogs or to remove out-dated catalogs.

Create New Catalog Set—New catalog sets can be added so that certain users or organizations are limited to different catalogs then that are available to all registered or anonymous users. New catalog sets can be applied at the user profile or organization profile.

Campaign Management Module

The campaign management module is responsible for enabling marketing reps or administrators to create discounts, ads, and promotions for particular products on their site. The discounts, ads, and promotions can be personalized based on the end user. The screens enable the upload of advertisement images for ad campaigns. The Campaign Management Module can perform the following processes:

Campaign Management—The administration application 310 allows marketing personnel to enter in advertisements and discounts that apply to target user groups of the system as well as to products purchased through the StoreFront application 305.

View Campaign—Advertisements and discounts are part of a campaign. Administration application users can edit campaigns as necessary at any time. Note any change to a campaign affects any discounts or advertisements contained within the campaign.

Modify Owner—An owner is associated with every campaign to serve as a point of contact for changes and requests.

View Ad—Advertisements can be added through the administration application to highlight new or featured individual products or group of items. They can be specific to a target user group or viewable to all that browse the StoreFront 305.

Add New Target Group—Target groups are used in order to apply discounts and advertisements to subsets of the site's user population. Any user profile object can be used to define the target group.

View Discount—Discounts can be added through the administration application 210 to allow individual products or group of items to be sold at a reduced price. They can be specific to a target user group or to all that browse the StoreFront 305.

Add New Target Group—Target groups are used in order to apply discounts and advertisements to subsets of the site's user population. Any user profile object can be used to define the target group.

Add New Product Expression—Product expressions are used in order to apply discounts to a product or group of products. Any product's property can be used to define the product expression.

Create Campaign—Administration application users can add campaigns as necessary at any time. After the campaign and owner information are established, discounts and advertisements can then be added to the campaign.

Create Ad—Advertisements can be added through the administration application 310 to highlight new or featured individual products or group of items. They can be specific to a target user group or viewable to all that browse the StoreFront 305.

Create Discount—Discounts can be added through the administration application 310 to allow individual products or group of items to be sold at a reduced price. They can be specific to a target user group or to all that browse the StoreFront 305.

Search Module

The search module provides a mechanism for searching products and users within an enterprise. Depending on the type of search (product or user) requested, the screen may provide the appropriate criteria. Search criteria is flexible and wildcards can be accepted.

Help Module

The help module provides guidance to the administration application 310 users on how to accomplish certain tasks. In one embodiment, the scope of this module is minimal (i.e. a simple HTML page listing Frequently Asked Questions). However the help module may be enhanced in future embodiments on a per enterprise requirement basis to include such areas as content sensitive help.

Product Data

The Product Master resides within the CS2k 220 environment. A subset of product information will need to be extracted and sent to Yantra 225 and the WMS 335. Yantra 225 needs some product information in order to be able to recognize the Stock Keeping Units (SKUs) and apply proper fulfillment rules on the orders. Likewise, the warehouses require knowledge of the products they need to supply and ship. It is assumed that during data conversion, there will be a bulk load of product information into both the CS2k 220 catalogs and Yantra 225.

As products are added to the product catalog through the administration application 310, part of the submission process will include the generation of the product information as XML that is sent to a BizTalk™ Message Queue for pickup on a scheduled basis. The product XML will be mapped to what is required by Yantra 225 and the WMS 335 and then sent to those systems for upload.

Staging Environment 1665

Since some enterprises require an approval process before content, products and campaigns are posted to the live production site, it is important that a staging area exist. Therefore, all new and updated content can be written to CS2k 220 tables in a staging area and these changes can be replicated to the production CS2k 220 tables on a scheduled basis. In one embodiment, the CS2k replication has been extended to accommodate a synchronization between a staging CS2k environment and the production CS2k environment.

Customer Service Application 320

Functionality

The Custom customer service application 320 is the application through which the customer service representatives of an enterprise can assist StoreFront 305 customers with their accounts and orders. The Custom customer service application 320 is further broken down into the following functional modules:

User Account Help Module

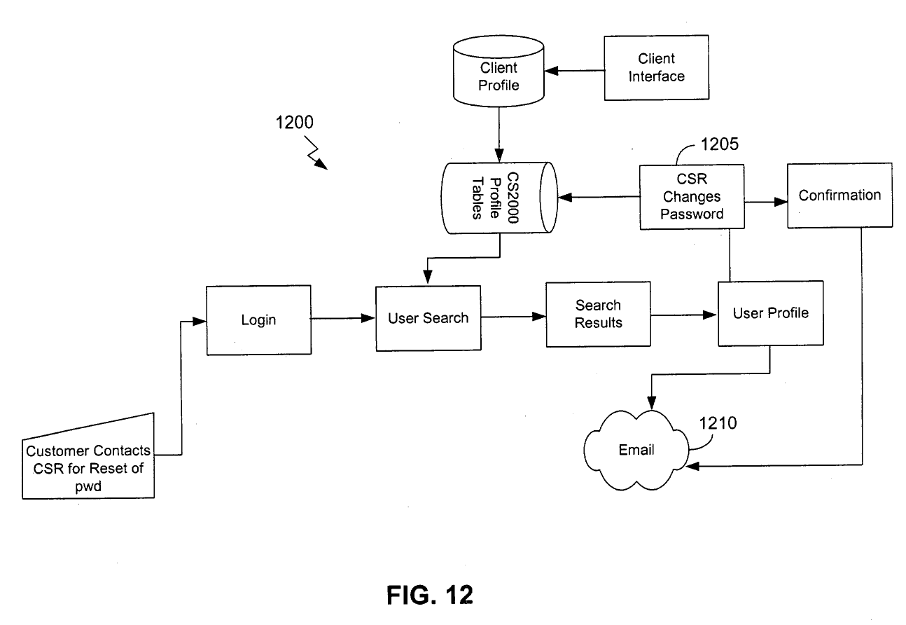

FIG. 12 shows a process flow diagram 1200 of the user account help module. The user account help module is responsible for enabling customer service representatives to reset a user's password if the user calls for assistance. The customer service rep can reset/change the user's password in step 1205, which triggers an email to be sent to the person's email address (as listed in their profile) with the new password in step 1210.

Order Processing Module

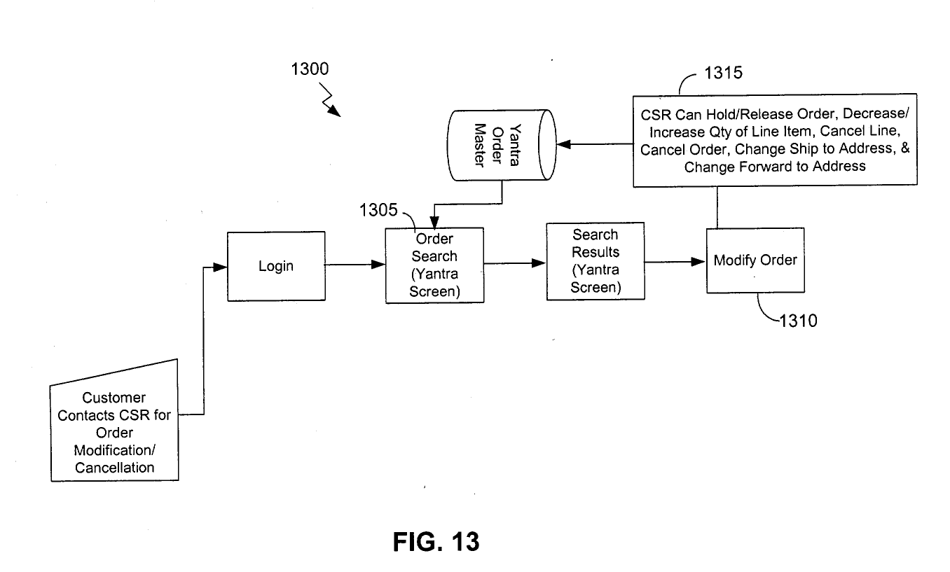

FIG. 13 shows a process flow diagram 1300 of the order processing module. The order processing module enables a customer service representative to check on the status of an order for a particular user in step 1305 and, if requested, make modifications to the order (provided it is in the appropriate status) in step 1310. Through these screens, a CSR can put an order on/off hold, change the quantity of a product, cancel lines on an order, cancel the entire order, change the ship to address, and change the forward to address in step 1315.

Returns Processing Module

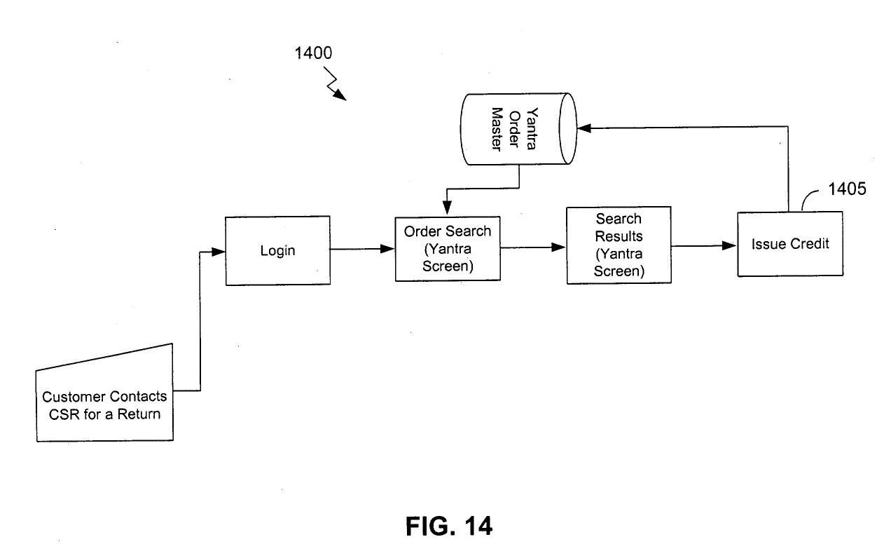

FIG. 14 shows a process flow diagram 1400 of the returns processing module. The returns processing module enables a customer service representative to create a return and issue a credit memo for a particular order in step 1405. In one embodiment, CCMD provides the capability to create a credit memo.

Exception Processing

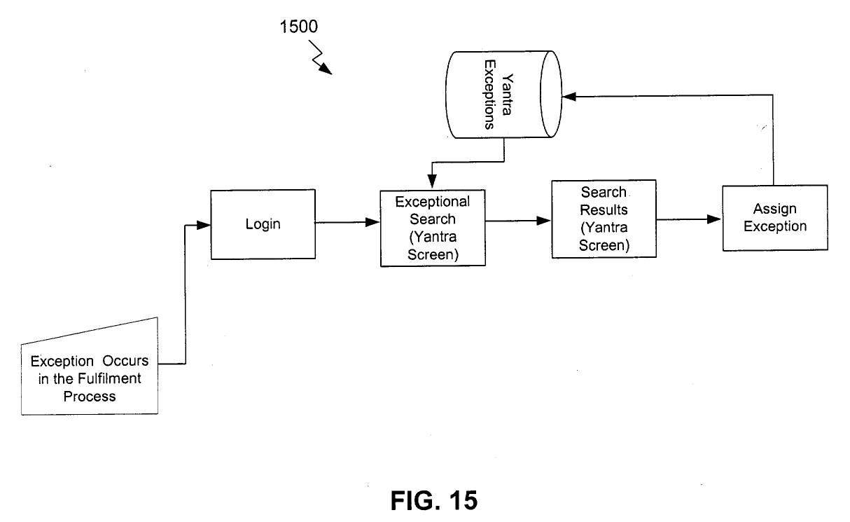

FIG. 15 shows a process flow diagram 1500 of the exception processing module. The exception processing module enables customer service representatives to view exceptions and handle them appropriately. The actual handling of an exception is done outside of the CCMD application. For example, when product inventory falls below a particular level, one can set an exception to raise an email to the product owner in order to have more inventory ordered.

Design Considerations

Leveraging Available Assets

Yantra Platform application 225 provides customer service representative (CSR) functionality in regards to order processing and return processing. The amount of functionality provided in these existing screens is quite detailed and not all of it is easily duplicated via an existing Yantra 225 API (see Table 1.0 below). If the CSR Console is custom built, some of the existing functionality in Yantra 225 can be limited and additional functionality can be provided as part of future upgrades. Therefore, the actual Yantra Platform 225 screens are leveraged. For Order Processing, the Order and Status tabs in the Order Console may need to be accessed. For Returns Processing, the Payment and Invoices tabs (for creating credit memos and verifying that the credit was issued) may need to be accessed.

TABLE 1.0

| | | Existing Yantra |
|---|---|---|
| Capability | Yantra Platform | API |
| Modify/Cancel | Yes | Yes |
| Order | | |
| Create Return | Yes | Yes |
| Order Search/Results | Yes | Yes |
| Return | Yes | No |
| Search/Results | | |
| View Order Status | Yes | Yes |
| View Return Status | Yes | Yes |
| Issue Credit | Yes | No |
| Reset Password | No | No |

Common Look & Feel

The CCMD site (StoreFront 305, administration application 310 and Custom customer service application 320) has a common look and feel. The look and feel of Yantra Platform 225 screens were modified to comply with 200 UI standards for a particular enterprise.

Seamless Login from CS2k 220 to Yantra 225

The user login id and password are passed from CS2k 220 to Yantra 225 (provided the user is a CSR) providing a seamless login to the Yantra 225 pages. As customer service representatives are added to CS2k system 220, their login and password information to Yantra 225 are replicated. Any password changes are also replicated.

The Yantra 225 pages can either appear within the CCMD frameset or be launched in a separate browser window. In one embodiment, a link can be provided on the CCMD menu for a specific CSR functionality and only link directly to that particular section of Yantra Platform 225.

Production Environment 1600

An embodiment of the production environment 1600 is shown in FIG. 16. The production environment 1600 includes all the hardware and software components necessary to operate and run the “live” CCMD. The production environment 1600 allows users to directly invoke e-commerce capabilities (product catalogs, shopping carts, etc.) to order and purchase products and to download digital assets. The CCMD team can specify the physical layout and hardware configuration for the production environment 1600. The CCMD team can work with the Hosting Provider to acquire and install the physical layout and hardware configuration for the production environment 1600 at the Hosting Provider's data center. The Hosting Provider is responsible, per the CCMD's specifications, for monitoring the site from the operating systems 415 and hardware down to the network components per the run book. CCMD is responsible for monitoring and maintaining the applications (CS2k 220, Yantra 225, and BizTalk™ 230) and third-party integration components (Digital Asset Management systems 325, HR systems 350, ERP systems 340, WMSs 335, etc.). The Hosting Provider can provide database administration functions for the databases (e.g. SQL Server)

CCMD web pages, digital assets and data can be loaded onto the Hosting Provider environment during a conversion processes once the necessary software is installed. When the web site is enabled, changes to the Hosting Provider environment follows a detailed change control process, which can be maintained by the Hosting Provider but defined by CCMD. The client's administration users 1695 are responsible for day-to-day maintenance of the web site (adding products to assortments, setting up promotions/discounts, creating catalogs, etc).

The production environment 1600 for CCMD is designed to provide maximum protection against downtime for core functionality (product browsing, shopping cart, order processing, etc.) Additional functionality not considered core to the systems operating capability (inventory updates, fulfillment, 3rd party integration) can also be designed with highly available failover solutions.

CCMD components are defined as fully redundant or highly available, while others are stand-alone servers and are not redundant. The decision to make an application/server redundant or non-redundant is based on the functionality of the application. “High availability” is defined as the capability of the application to automatically recover from hardware and system software errors with minimal or no impact to users of the application. Some applications support high availability natively while others may only have a redundant server. In the situation where there is only a redundant server, users may experience a small amount of downtime, as they are re-directed to the redundant server.

All servers installed and configured by the Hosting Provider can have the following:

Redundant power supplies

Redundant disk controllers

Redundant network connections

The following servers/utility machines can operate in a redundant, highly available mode:

In one embodiment, all Hosting Provider Network Hardware can include:

Firewall Servers 1605—Firewall Servers 1605 can filter request addresses against certified customers and suppliers 1693, provide packet filtering, and provide virus protection.

Routers 1610—Routers 1610 can filter request addresses against certified customers and suppliers 1693 and provide packet filtering.

Switches 1615—Switches 1615 can be a gigabit switch.

Domain Controllers 1620—Firewalls 1605 route data to domain controllers 1620 which forward the data to various servers 1625 and 1635.

CS2k Web/App Servers 1625—CS2k Web/App Servers 1625 can be configured as a cluster 1627 and can be load balanced. CS2k Web/App Servers 1625 can be load balanced using Microsoft's® Network Load Balancing capability in Microsoft's® Application Center 2000 (Application Center).

Database Servers 1630—Database servers 1630 can be configured as a cluster 1632. In one embodiment, the database servers 1630 can be configured as a cluster 1632 using Application Center. One can support CS2k 220 data access and another can support Yantra 225 data access. Each database server 1630 can have the capacity to handle the load from the other server to support failover.

The following servers/utility machines can operate in a redundant mode:

Yantra Web/App Servers 1635—Yantra Web/App Servers 1635 can be active and the front end can be load balanced. Note that Yantra 225 does not have automatic failover capabilities however, the load balancer can re-route Yantra 225 requests to the live server in case of failure. From the backend, the proxy application configuration for CS2k 220 calls to Yantra 225 APIs can be manually updated to failure to the other operating Yantra Web/App Server 1635 in case of failure. Yantra web/app servers 1635 can be load balanced by either Microsoft's® Network Load balancing capability in Application Center or by a hardware solution.

The following servers/utility machines can operate in a non-redundant mode:

Staging CS2k Web/App Server 1640

Staging database server 1605

BizTalk™ 230—no failover solution is provided because a failure in BizTalk™ 230 does not affect the ability to accept orders. However, a failure would affect the ability to send orders to Yantra 225 and the warehouses 1670. A failure in BizTalk™ 230 can also impact the communication between Yantra 225 and the integrated Warehouses 1670 meaning there can not be any shipping updates loaded into Yantra 225. Therefore, in the case of a failure of BizTalk™ 230, orders can be batched up and sent to the warehouses 1670 via other methods (e.g. email, fax, phone, etc.) until BizTalk™ 230 problem is resolved. Alternatively, once BizTalk™ 230 problem is identified, the outstanding items can be moved from an BizTalk™ Exception Queue to the active Outbound Queue, and BizTalk™ 230 can resume processing these orders normally. BizTalk™ 230 database can be stored on one of the database servers 1630, thus there is a failover solution for the database components of BizTalk™ 230.

FTP Server 1655—provide the ability for content owners to transfer digital assets to the CCMD system.

Digital Asset Repository 1685—no failover solution is provided but backups can occur on a regular basis.

In one embodiment, the production environment 1600 of the CCMD is designed to support up to 30,000 orders per month or 3 clients (enterprises) assuming each client has only 10,000 orders per month. The fourth client and/or when orders increase to over 30,000 orders/month can require additional hardware.

For a non-hosted solution, some servers can be consolidated or eliminated. However, depending on the requirements, multiple servers may be needed to support redundancy and failover capabilities. In one embodiment, CCMD can support five primary user types, however, in another embodiment, more than five primary user types can be supported. The five primary user types are listed below:

Content/Part Managers—responsible for adding and maintaining products and content/digital assets; can access a portion of the Administration Application 310 via the staging environment 1665.

Site Administration/Approvers—Site administration/approvers are responsible for day-to-day site operations (i.e., defining product assortments, entering prices, setting up promotions, content approval and cross/up-sells); can access the Administration Application 310 via the staging environment 1665.

StoreFront Application Users—StoreFront application users can browse and purchase items from the production StoreFront Application 305 site.

Customer Service Users—can assist users with password resets and navigation and can provide information on order status; can access a custom customer service application 320 built using CS2k 220 framework.

Non-integrated Warehouse Users 1670—can access the pure e-commerce portal 330 via the Internet 1675 to enter order and inventory updates.

A virtual remote network (VPN) can be set up from the Hosting Provider Data Center location to a client's administrative office. The VPN can provide secure access for the Part Managers and Site Administration users 1695 to the Administration Application 310. An id and password may be required for Part Managers and Site Administration users 1695.

StoreFront Application 305 users can access the production environment from the Internet 1675 and can authenticate with an id/password combination. CCMD can provide basic security services regarding access to site functionality via role, group, and profile capabilities. The client can provide user id/password and profile information, as necessary. Customer Service Representatives can also access the site via the Internet 1675 and can authenticate using a secure id/password combination. The pure e-commerce portal 330 can be accessed via the Internet 1675. The suppliers 1693 can have an enterprise specific id/password to authenticate.

Hardware Configurations

The table below outlines one embodiment of the configuration for each of the servers in the Production Environment 1600.

Server Configuration

| | | | | | |
|---|---|---|---|---|---|
| Server | System | Count | CPU | Memory | Software |

Production Environment

| | | | | |
|---|---|---|---|---|
| CS2k Web/App, | 3 | 2 x | 2 GB | Windows Advanced Server |
| BizDesk | | 500 MHz | | 2000 |
| Application*, and | | | | Windows 2000 Server Service |
| Customer Service | | | | Pack 2 |
| | | | | Windows 2000 Hotfixes |
| | | | | IIS 5.0 |
| | | | | Commerce Server 2000 |
| | | | | BizDesk application |
| | | | | Customer Service Application |
| | | | | SQL Server 2000 Client |
| | | | | SAFileUp v3.2 |
| Domain | 2 | 1 x | 1 GB | Windows Advanced Server |
| Controllers | | 450 MHz | | 2000 |
| | | | | Windows 2000 Server Service |
| | | | | Pack 2 |
| | | | | Windows 2000 HotFixes |
| | | | | Application Center 2000 |
| Digital Asset | 1 | 1 x | 1 GB | Windows Advanced Server |
| Repository | | 450 MHz | | 2000 |
| | | | | Windows 2000 Server Service |
| | | | | Pack 2 |
| | | | | Windows 2000 HotFixes |
| BizTalk ™ | 1 | 2 x | 500 | Windows Advanced Server |
| server | | 450 MHz | MB | 2000 |
| | | | | Windows 2000 Server Service |
| | | | | Pack 2 |
| | | | | Windows 2000 HotFixes |
| | | | | BizTalk ™ Server 2000 |
| FTP Server | 1 | 1 x | 500 | Windows Advanced Server |
| | | 450 MHz | MB | 2000 |
| | | | | Windows 2000 Server Service |
| | | | | Pack 2 |
| | | | | Windows 2000 HotFixes |
| Yantra Web/ | 2 | 1 x | 2 GB | Windows Advanced Server |
| App | | 450 MHz | | 2000 |
| | | | | Windows 2000 Server Service |
| | | | | Pack 2 |
| | | | | Windows 2000 HotFixes |
| | | | | IIS 5.0 |
| | | | | Yantra v3.1 SP2B |
| | | | | Yantra 3.1-SP2B Option Pack 1 |
| | | | | Yantra 3.1-SP2 HF5 |
| | | | | Weblogic v5.1 |
| | | | | Weblogic v5.1-SP8 |
| | | | | Sun JDK 1.3 HotSpot Server |
| | | | | VM |
| | | | | Sprinta2000 ver3.5 JDBC |
| | | | | Driver |
| | | | | SMTP |
| | | | | SQL Server 2000 Client |
| Database | 2 | 4 x | 4 GB | Windows Advanced Server |
| | | 450 MHz | | 2000 |
| | | | | Windows 2000 Server Service |
| | | | | Pack 2 |
| | | | | Windows 2000 HotFixes |
| | | | | SQL Server 2000 |

Staging Environment

| | | | | |
|---|---|---|---|---|
| CS2k Web/ | 1 | 1 x | 1 GB | Windows Advanced Server |
| App and | | 450 MHz | | 2000 |
| Administration | | | | Windows 2000 Server Service |
| Application | | | | Pack 2 |
| | | | | Windows 2000 HotFixes |
| | | | | IIS 5.0 |
| | | | | Commerce Server 2000 |
| | | | | Administration Application |
| | | | | SQL Server 2000 Client |
| | | | | SAFileUp v3.2 |
| Database | 1 | 2 x | 2 GB | Windows Advanced Server |
| | | 450 MHz | | 2000 |
| | | | | Windows 2000 Server Service |
| | | | | Pack 2 |
| | | | | Windows 2000 HotFixes |
| | | | | SQL Server 2000 |

*The BizDesk Application in the production environment 1600 may not be available to the Part Managers, Site Administration users 1695, StoreFront application 305 users or end users in any fashion. Only Host site personnel, in the event of an emergency to fix site content, should use the production copy of the BizDesk Application.

Internet Users

As stated above, the CCMD can have 5 primary user types that can connect through the Internet 1675:

Content/Part Managers—these users are responsible for creating and maintaining parts/content/digital assets.

Site Administration users 1695—these users are responsible for day-to-day administration of the site

StoreFront application 305 Users—these users can access the site to purchase assets and to download digital assets

Customer Service—these users are the first line of support for Customers. They can reset passwords and assist customers with their orders. Customer Services representatives can pass on the more technical problems to Tier 2 support, the CCMD support team.

Non-integrated Warehouse Users—warehouses 1670 that are not integrated via BizTalk™ 230 can update inventory and shipping information via the pure e-commerce portal 330.

In one embodiment, requirements for browser 1673 support for CS2k 220 includes IE4.0+ and Netscape 4.0+ on Windows 95, NT4, 2000, and MAC 8.0+. The BizDesk Application may require an IE5.5 browser or better. The pure e-commerce portal 330 may require IE5.5. The pure e-commerce portal 330 may also support Netscape Navigator 4.75.

In one embodiment, the method for CCMD authentication can be through unique id/password combination. Authorization to use CCMD can be determined by the role, group, and privilege definitions. In another embodiment, other options, such as Lightweight Directory Access Protocol (LDAP) integration can be considered for user authentication and authorization.

Digital Asset Repository Server 1685

In one embodiment, the Digital Asset Repository (DAR) server 1685 is specified as a Windows 2000 server with a large amount of disk space for storing the digital assets. When the volume of assets and/or frequency of download on the DAR server 1685 reach a level where performance degradation results, the assets can be placed on an external high-speed access disk array.

The DAR server 1685 can be accessed when customers are requesting assets that can be digitally downloaded to their workstation. For assets that have $0 price, the asset can be downloaded from the product detail page. For assets that have an associated price, users have the ability to download the digital asset once the checkout process is completed via cyber source. Note that the DAR server 1685 is located behind a firewall and switch 1615 to protect the assets.

In another embodiment, a Digital Rights Management (DRM) application can be run on the DAR server 1685 to service secure assets to the purchaser and not allow distribution to non-authorized persons.

Web/App Servers 1625

In one embodiment, CS2k Web/App Servers 1625 can run an IIS Web Server and a CS2k application. CS2k Web/App Servers 1625 can support the StoreFront application 305 user interface (UI) for browsing and searching products, shopping cart, and ordering functionality. Authentication of users and their authorization for which catalog to view can occur at this level.

The IIS web server can maintain the Active Server Pages (ASPs) that are requested by the users through the URL. The ASPs can call the page controllers (COM+ objects written in Visual Basic (VB)) that can in turn call either COM+ objects for processing business logic or stored procedures for accessing or updating data. Data can be returned to the page controller, which can pass that information to the ASP pages in the form of XML. The ASP page can then generate the HTML that is passed back to the user.

IIS Web Server

Each IIS Web Server is configured to support the HTTP requests for multiple enterprises. A new Web Site has been created within CCMD for each enterprise in the IIS web server and a new directory. Domain Name adjustments were also made within CCMD. These tasks can be completed by the hosting provider.

In one embodiment, a number of files can be installed in the root directory of the IIS web server including:

ACAConfig.xml

biztalkInterchange.msi

YantraCaller.msi

Furthermore, all of the IIS web server specific files (ASPs, images, config files, etc.) can be stored under an enterprises root directory.

There may also be 3 main files under the root directory:

global.ASA

default.asp

rc.xml

Splash.asp

There can be 5 main directories or “sites” under each directory:

Store—This is the site for the StoreFront application 305.

Production environment administration—The site for CS2k 220 delivered BizDesk Application that points to the production database.

Administrator—This is the site for the Administration Application 310.

Staging Production environment administration—This is the site for CS2k 220 delivered BizDesk Application that points to the staging database 1625.

Customer Service Representative (CSR)

Common—

Under each one of these directories are the enterprise-specific files.

In one embodiment, the http requests to the IIS web server can be load balanced using Microsoft's® Network Load Balancing (NLB) with Application Center. The domain controller 1620 section below provides more information as to how network load balancing can be implemented for CCMD.

Application failures that are fatal and require a re-direct to an error.asp page can be sent from the page controllers to the ASP pages following the Avanade Connected Architecture Framework. If an application server fails, the failure message is sent back to Application Center. Application Center evaluates the error message. If the error is a time out error or system not available error, Application Center can route the message to another web/app server 1625 pair. The end user will not experience any complications from this type of failure. However, if the error sent to Application Center is a fatal error, (such as a problem with business logic) then the error handling and logging routines execute and eventually forward an error message to the end user.

CS2k Application Server 1625

The CCMD leverages CS2k's 220 session maintenance functionality and can maintain session information in the AuthManager and Profile tickets and in the Profile service. Cookies or the URL query string can be used to store the user's preferred language so that that parameter can be used to display the home page in the appropriate language. Session information is not stored in server memory and is never cached.

In one embodiment, CS2k 220 is responsible for calculating pricing information and for executing the credit card authorization and fraud check. CS2k 220 is also be responsible for calculating the price for orders including calculating the sales tax and for estimating shipping. CS2k 220 sends an HTTP request to Cybersource™ or equivalent credit card processing systems, passing the order total and receiving back the tax amount and percentage. CS2k 220 can make another HTTP call to Cybersource passing the credit card number and user information to Cybersource. CS2k 220 then receives an HTTP response back with the authorization information.

CS2k 220 can call Yantra 225 APIs to access order and inventory information. The page controller can call Yantra 225 e-commerce Adapter APIs.

In one embodiment, Microsoft's® Commerce Server Manager tool provided with CS2k 220 can be used to manage and configure CS2k 220 resources, sites, and applications. The Microsoft® Management Console (MMC), a Windows-based interface included in Microsoft® Windows 2000, hosts Commerce Server Manager.

In one embodiment, CCMD uses the SAFileUpv3.2 application from Software Artesians™ to upload product images. Administration users 1695 can create new products using the Administration Application 310. The SAFileUp application allows the administration user to upload product images and the asset to CS2k Web/App Server 1625.

Domain Controllers 1620

In one embodiment, Application Center is installed on the Domain Controllers 1620. Application Center is a tool for creating, deploying, and managing Web and component-based applications. In addition to offering optimal load balancing algorithms for different types of applications, Application Center provides tools for monitoring system performance, and allows the system administrator to adjust load on a server-by-server basis. Within CCMD, Application Center can be used for creating server clusters (DB Server clusters 1632 and CS2k Web/App Server clusters 1627, Yantra Web/App Servers 1635) and for load balancing (CS2k web/app servers 1625, Yantra Web/App Servers 1635).

Cluster Services

Application Center's cluster services support the creation and general administration of the cluster infrastructure—from creating a cluster to adding or removing members. In one embodiment, clusters are created using Cluster Wizard. Administrative tasks are those that deal with the composition of a cluster and the current state of its members. These tasks include activities such as adding a server to a cluster or taking a member offline. Cluster Services can be used to create both CS2k Web/App cluster 1627 and the Database Server cluster 1632.

Network Load Balancing

Application Center has three options for load balancing:

Network Load Balancing (NLB)

Component Load Balancing (CLB)

No Load Balancing.

CCMD can use NLB across its web/app server layer of both CS2k 220 and Yantra 225. In the case that the web/app servers are split so that there is a web server layer and an application server layer, CLB can also be used to load balance the calls to the application server from the web servers. Note that CLB may cause performance drains and should be thoroughly performance tested prior to implementation.

NLB is a distributed IP-level load-balancing solution that works by having cluster members see the packets sent to the virtual IP (VIP) addresses associated with a cluster. The cluster member that actually processes a particular packet depends on the load-balancing rules that are in effect.

NLB cluster servers emit a heartbeat message to other hosts in the cluster, and listen for the heartbeat of other hosts. If a server in a cluster fails, the remaining hosts adjust and redistribute the workload while maintaining continuous service to their clients. Although existing connections to an offline host are lost, the Internet 1675 services nevertheless remain continuously available. The main element of the NLB configuration for a cluster is selecting an appropriate load-balancing algorithm for the cluster. This algorithm, or affinity, is based on the source of the bulk of the incoming client requests. Application Center offers three types of affinity settings:

None—Multiple requests from the same client can access any cluster member. The IP address and port number identifies the client.

Single—Multiple requests from the same client can access the same cluster member. This is the default setting for intranet clients. The IP address identifies the client.

Class C—Multiple requests from the same TCP/IP Class C address range can access the same cluster member. This is the default setting for Internet 1675 clients because it provides optimum support for “sticky sessions”.

CCMD uses the “Single” affinity so that each client can continue to work with the same host/server once they establish a session. While CS2k 220 applications for CCMD can be designed to store session information at the database level, thereby not requiring sticky routing and providing a capability for failover, the use of Secure Socket Layer (SSL) for secure transactions requires sticky routing. Otherwise the client may receive messages asking if they want to continue with a non-secure server.

In mapping clients to hosts, NLB cannot directly track the boundaries of sessions (such as SSL sessions) since it makes its load balancing decisions when TCP connections are established and prior to the arrival of application data within the packets. Also, it cannot track the boundaries of UDP streams, since the logical session boundaries are defined by particular applications. Instead, NLB's affinity settings are used to assist in preserving client sessions. When a cluster host fails or leaves the cluster, its client connections are always dropped. The clients that previously mapped to the failed host are remapped among the surviving hosts. All other client sessions are unaffected by the failure and continue to receive uninterrupted service from the cluster. In this manner, NLB's load-balancing algorithm minimizes disruption to clients when a failure occurs.

NLB employs a fully distributed filtering algorithm to map incoming clients to the cluster hosts. This algorithm enables cluster hosts to make a load-balancing decision independently and quickly for each incoming packet. NLB load-balances incoming client requests by directing a selected percentage of new requests to each cluster host. The load percentage is set in the NLB Properties dialog box for each port range to be load-balanced. The algorithm does not respond to changes in the load on each cluster host (such as the CPU load or memory usage). However, the mapping is modified when the cluster membership changes, and load percentages are renormalized accordingly. Another load balancing configuration option provided by Application Center is the ability to adjust individual server weights in response to performance data or to accommodate different classes of members. Finally, any server can be taken offline or put online to remove or add a server from the load-balancing loop, respectively. In one embodiment, Microsoft® Management Console (MMC) can be used to remove or add a server from the load-balancing loop.

Yantra Servers 1635

In one embodiment, Yantra servers 1635 rely on Internet Information Servers (e.g. IIS 5.0) as their web server application. For the application component, the order management server 1635 can support JDK 1.3, Weblogic 5.1 SP8, and Yantra v3.1 SP2BB. WebLogic is the Java application server for Yantra 225. Yantra 225 is a 100% Java application. Yantra 225 can integrate with commerce applications via http and COM. Yantra 225 commerce-related APIs can be called by 3rd party applications via an http call or through a COM-Java bridge. In one embodiment, the commerce-related APIs can be Yantra's PureEcommerce Adapter APIs. The http request calls a JavaServer Page™ (JSP™) on Yantra server 1635 which calls the Java API directly. Yantra's 225 other method for calling its commerce-related APIs is via a COM proxy. Yantra 225 has wrapped its Java classes with a Java Native Interface (JNI), which serves as the COM Bridge for the Java objects. The JNI is then wrapped in a COM layer allowing access to the Java classes. Other COM objects such as CS2k 220 COM objects can call these Java classes via DCOM.

Yantra 225 has multiple entry points:

XML/XSL based UI for administration/configuration

XML/XSL based UI for customer service (look up shipping/order status information)

XML/XSL based UT for suppliers 1693 (This is called the Supplier Portal)

COM wrapped-APIs

The UI's can all be load balanced by either Application Center or a hardware solution to be provided by the Hosting Provider. The load balancing routine can be round robin and may provide sticky routing so that after the first request the user continues to work with the same server. If there are any failures within the user interface, the user may receive a failure message. Yantra 225 does not provide an automatic failover solution for the UI applications so a user has to log out and log back in to another server. Those skilled in the art will understand that automatic failover capabilities can be added via customized routines.

In one embodiment, the API calls can be called from CS2k 220 application. Yantra 225 is a single threaded application and the APIs are stateless and are not load balanced. CCMD can directly link one CS2k 220 server to a single Yantra server 1635. Yantra 225 does not provide an automatic failover solution for the API calls. To handle failures, CS2k 220 code calling Yantra 225 API may, depending on the error, either report a failure to the user and error logs or re-try the API call. CS2k 220 code is actually a custom COM object that receives the API name and XML input string from a page controller and then calls the appropriate API via COM. The custom COM object receives any potential errors from the APIs and sends the errors back to the calling page controller, which evaluates the error and takes appropriate action (either logging the error and continuing, providing an error message to the user, or re-calling the API).

Simple Mail Transfer Protocol (SMTP) can also be configured within the internet information servers on Yantra servers 1635. Most emails (order confirmation, shipment confirmation, etc.) can be sent from Yantra 225. If CS2k 220 application needs to send any emails, it can also point to the SMTP service on Yantra server 1635.

BizTalk™ Servers 1650

Overview

BizTalk™ Messaging Architecture 1700 Overview

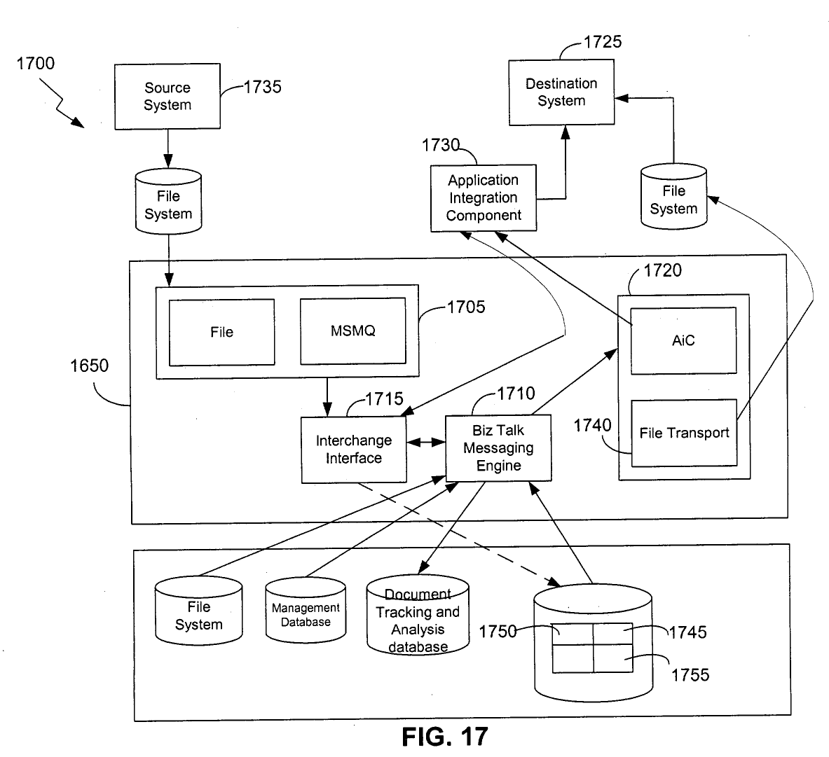

FIG. 17 shows a diagram of BizTalk™ messaging architecture 1700 which shows a high level overview of how data (XML, documents, etc.) is brought into BizTalk™ 230 from external systems, the different processes that occur within BizTalk™ 230, and the delivery of the transformed document to the destination system 1725. A general overview of the BizTalk™ Framework 2.0 conceptual architecture including the BizTalk Documents and BizTalk Message as well as detailed specifications for the construction of BizTalk Documents and messages, and their secure transport over a number of internet standard transport and transfer protocols are contained in the “BizTalk™ Framework 2.0: Document and Message specification” published December 2000 by Microsoft Corporation, which is hereby incorporated fully herein by reference.

BizTalk™ 230 is used as the messaging and application integration component 1730 to pass data between applications. Primarily BizTalk™ 230 is used to integrate internal systems and/or the external applications (Digital Asset Management systems 225, HR systems 350, and ERP systems 340) with CS2k 220 application and also to integrate Yantra 225 with any external warehouse management systems 235.

In one embodiment, the CCMD can support one BizTalk™ server 1650. That one BizTalk™ server 1650 can support the BizTalk™ application 230, MSMQ, and CS2k 220 COM objects. CS2k 220 is initially installed on BizTalk™ server 1650 to facilitate local API calls, thus improving Application Integration Component (AIC) performance. If necessary, CS2k 220 can be removed from BizTalk™ server 1650, and the API's can be called remotely. In one embodiment, BizTalk™ 230 database resides on the production database servers 1610. In another embodiment, multiple BizTalk™ servers 1650 can be clustered around a single database server 1630 to handle a greater volume of transactions passed through BizTalk™ 230. In yet another embodiment a warm, stand-by database server 1630 can be used as the BizTalk™ database server.

BizTalk™ 230 supports XML, EDI and ANSI X12 formats. CCMD's standard supported data format can be XML. BizTalk™ 230 translations and interfaces can be written assuming XML as both the input and output data format. BizTalk™ 230 provides a graphical mapping tool that can be used to translate data formats of various types. This function may be used if CCMD's clients are not able to provide or receive data in the XML format or if they have a preferred XML format that does not match our internal XML format.

BizTalk™ Server 1650 features that can be of use for CCMD include

integration among existing applications via XML and application integration components (AICs) 1730,

the definition of document specifications and specification transformations via BizTalk™ Editor, and

the monitoring and logging of run-time activity via BizTalk™ server 1650 Administrator and BizTalk™ Document Tracking Database.

BizTalk™ Messaging Services include receiving incoming documents, parsing the documents to determine their specific format, extracting key identifiers and identifying specific processing rules, delivering documents to their respective destinations, and tracking documents. Also included are services for data mapping, receipt generation and correlation, and services to ensure data integrity and security.

BizTalk™ Server 1650 provides receive functions 1705 that enable the server to monitor directories and submit documents to BizTalk™ server 1650 for processing. BizTalk™ Server 1650 also provides transport services 1720 that enable the transmission of documents to their destinations. Transport services 1720 enable the server to send documents to organizations and applications whether or not the applications are capable of communicating directly with the server by using a COM interface. CCMD can utilize two of BizTalk™ 230 transport services 1720; File Transport 1740 and Application Integration Components (AICs) 1730.

BizTalk™ Server 1650 provides data validation by verifying each instance of a document against a specification. A specification is a specific XML schema. If the document does not adhere to the specification rules, the document is placed into a suspended queue 1750 for further analysis. BizTalk™ Server 1650 also provides reliable document delivery by using configurable BizTalk™ 230 messaging services properties. These properties include setting service windows for sending documents, sending or receiving receipts, setting the number of retries, and setting the time between retries. BizTalk™ server 1650 supports the use of BizTalk™ Framework-compliant envelopes, which provide reliable messaging features. BizTalk™ server 1650 also queues documents to a central location. In the event of a server failure, rollover mechanisms enable new servers to take control of documents and process them.

BizTalk™ server 1650 supports encryption and digital signatures. Public-key encryption technology is supported for all documents that are transmitted by using BizTalk™ server 1650 transport services 1720. BizTalk™ server 1650 can also support decryption and signature verification for the documents that it receives.

Document Mapping Specifications

In one embodiment, the different incoming and outgoing document definitions are stored in this server 1650. These definitions and related mappings will be different for each customer and will be customized as specific information becomes available.

BizTalk™ Server 1650 Interfaces

This section contains detailed descriptions of how documents are brought into BizTalk™ 230 and the transformations that take place within BizTalk™ 230 for each of the different interfaces. This includes BizTalk™ receive functions 1705, channels, and ports.

Digital Asset Management (DAM) Items to Staging

Entry into BizTalk™ 230

When the customer adds or modifies an item in the Digital asset management system 325, the DAM automatically sends an XML document to the private\custName\DAM_Item MSMQ queue. This document should conform to the DAM_Item_Spec specification. This interface occurs in real time. In order to manage information for a product, when the product is first created in the CCMD system, the user must choose whether the product is digital or physical. If it is digital, then BizTalk™ has to send the information to the digital asset management system. In one embodiment, the digital asset management system is the CS2k.

Receive Function 1705

The DAM_Item_Recv receive function 1705 continuously polls the private\custName\DAM_Item queue for XML documents. When an XML document is received, it is automatically sent to the DAM_Item_Staging channel.

Channel

The inbound document specification is DAM_Item_Spec, and the outbound document specification is Staging Item Spec. BizTalk™ messaging engine 1710 is used to map the necessary information between the inbound and outbound specifications via the DAM_Item_Staging map created with BizTalk™ Mapper utility. The outbound document is sent to the Item_Staging port.

Port/AIC

The Item_Staging port calls the Item_Staging AIC. The Item_Staging AIC is described further below.

Physical Items to Staging

Entry into BizTalk™ 230

When the customer adds or modifies an item in the Physical Asset Management system, the system automatically sends an XML document to the private\custName\Physical_Item MSMQ queue. This document should conform to the Physical_Item_Spec specification. This interface occurs in real time. In order to manage information for a product, when the product is first created in the CCMD system, the user must choose whether the product is digital or physical. For physical items, BizTalk™ has to send information to a physical asset management system. In this embodiment, the physical asset management system is also CS2k.

Receive Function 1705

The Physical_Item_Recv receive function 1705 continuously polls the private\custName\Physical_Item queue for XML documents. When an XML document is received, it is automatically sent to the Physical_Item_Staging channel.

Channel

The inbound document specification is Physical_Item_Spec, and the outbound document specification is Staging_Item_Spec. BizTalk™ messaging engine 1710 is used to map the necessary information between the inbound and outbound specifications via the Physical_Item_Staging map created with BizTalk™ Mapper utility. The outbound document is sent to the Item_Staging port.

Port/AIC

The Physical Items to Staging interface use the same Item_Staging Port/AIC described above. The Item_Staging AIC is described further below.

Staging Items to CS2k 220

Entry into BizTalk™ 230

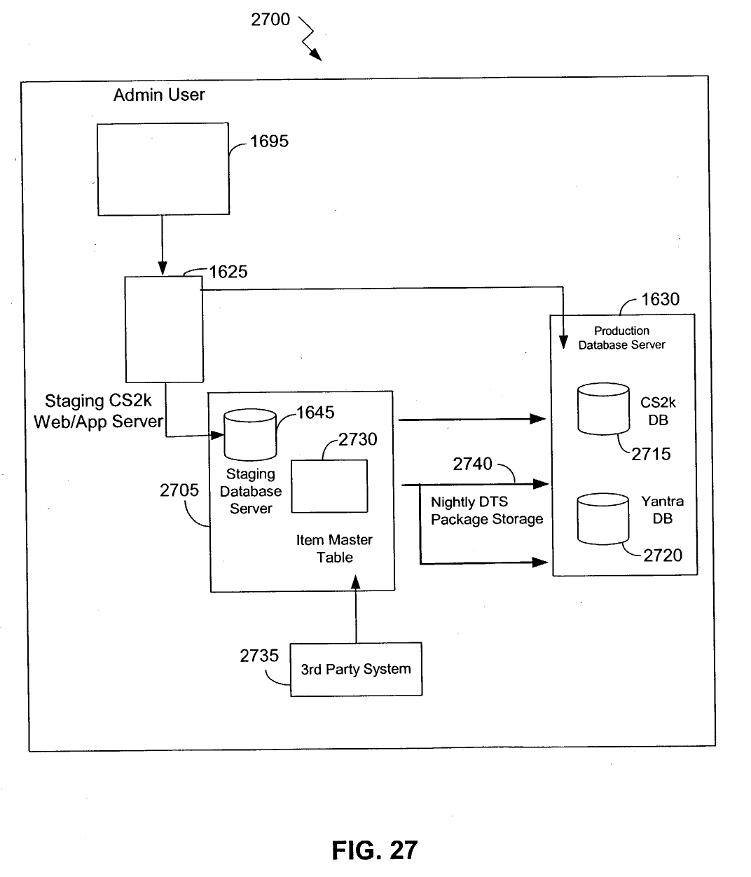

When the customer decides to publish items from the staging database server 1645 into the CCMD, the customer can use the administration publish functionality to mark the item in the Staging database 1645 (described more fully below with reference to FIG. 27). At an enterprise specified time, a DTS process automatically searches the staging database for items that are ready to publish and creates an XML document for each item that needs to be published. This document must conform to the Staging_Item_Spec specification. The DTS process sends the document to the private\custName\CS2k_Item MSMQ queue. This interface occurs once per day.

Receive Function 1705

The Staging_CS2kItem_Recv receive function 1705 continuously polls the private\custName\CS2k_Item queue for XML documents. When an XML document is received, it is automatically sent to the Staging_Item_CS2k channel.

Channel

The inbound document specification is Staging_Item_Spec, and the outbound document specification is CS2k_Item_Spec. BizTalk™ messaging engine 1710 is used to map the necessary information between the inbound and outbound specifications via the Staging_Item_CS2k map created with BizTalk™ Mapper utility. The outbound document is sent to the Item_CS2k port.

Port/AIC

The Item_CS2k port calls the Item_CS2k AIC. The Item_CS2k AIC is described further below.

Staging Items to the Warehouse Management System (WMS) 335

Entry into BizTalk™ 230

When the customer decides to publish items from the Staging server into the CCMD, the customer can use the Administration publish functionality to mark the item in the Staging database 1645. At an enterprise specified time, a DTS process automatically searches the database for items that are ready to publish and creates an XML document for each item that needs to be published. This document should conform to the Staging_Item_Spec specification. The DTS process sends the document to the private\custName\WMS_Item MSMQ queue. This interface occurs once per day.

Receive Function 1705

The Staging_WMSItem_Recv receive function 1705 continuously polls the private\custName\WMS_Item queue for XML documents. When an XML document is received, it is automatically sent to the Staging_Item_WMS channel.

Channel

The inbound document specification is Staging_Item_Spec, and the outbound document specification is WMS_Item_Spec. BizTalk™ messaging engine 1710 is used to map the necessary information between the inbound and outbound specifications via the Staging_Item_WMS map created with BizTalk™ Mapper utility. The outbound document is sent to the Item_WMS port.

Port/AIC

The Item_WMS port calls the Item_WMS AIC. The Item_WMS AIC is described further below.

HR Employee Info to CS2k 220

Entry into BizTalk™ 230

When the customer updates or adds employee information into their HR system, an XML document that conforms to the HR_EmployeeInfo_Spec is created and sent to the private\custName\EmployeeInfo MSMQ queue. This interface occurs in real time.

Receive Function 1705

The EmployeeInfo_Recv receive function 1705 continuously polls the private\custName\EmployeeInfo queue for XML documents. When an XML document is received, it is automatically sent to the HR_EmployeeInfo_CS2k channel.

Channel

The inbound document specification is HR_EmployeeInfo_Spec, and the outbound document specification is CS2k_EmployeeInfo_Spec. BizTalk™ messaging engine 1710 is used to map the necessary information between the inbound and outbound specifications via the HR_EmployeeInfo_CS2k map created with BizTalk™ Mapper utility. The outbound document is sent to the EmployeeInfo_CS2k port.

Port/AIC

The EmployeeInfo_CS2k port calls the EmployeeInfo_CS2k AIC. The EmployeeInfo_CS2k AIC is described further below.

Finance Internal Codes to CS2k 220

Entry into BizTalk™ 230

When the customer updates or adds internal code information into their Finance system, an XML document that conforms to the Finance_InternalCodes_Spec is created and sent to the private\custName\InternalCodes MSMQ queue. This interface occurs in real time.

Receive Function 1705

The InternalCodes_Recv receive function 1705 continuously polls the private\custName\InternalCodes queue for XML documents. When an XML document is received, it is automatically sent to the Finance_InternalCodes_CS2k channel.

Channel

The inbound document specification is Finance_InternalCodes_Spec, and the outbound document specification is CS2k_InternalCodes_Spec. BizTalk™ messaging engine 1710 is used to map the necessary information between the inbound and outbound specifications via the Finance_InternalCodes_CS2k map created with BizTalk™ Mapper utility. The outbound document is sent to the InternalCodes_CS2k port.

Port/AIC

The InternalCodes_CS2k port calls the InternalCodes_CS2k AIC. The InternalCodes_CS2k AIC is described further below.

WMS 335 Inventory to Yantra 225

Entry into BizTalk™ 230

When the WMS 335 updates their inventory, an XML document that conforms to the WMS_Inventory_Spec is created and sent to the private\custName\updateInventory MSMQ queue. This interface occurs in real time.

Receive Function 1705

The Inventory_Recv receive function 1705 continuously polls the private\custName\updateInventory queue for XML documents. When an XML document is received, it is automatically sent to the WMS_Inventory_Yantra channel.

Channel

The inbound document specification is WMS_Inventory_Spec, and the outbound document specification is Yantra_Inventory_Spec. The BizTalk™ messaging engine 1710 is used to map the necessary information between the inbound and outbound specifications via the WMS_Inventory_Yantra map created with BizTalk™ Mapper utility. The outbound document is sent to the Inventory_Yantra port.

Port/AIC

The Inventory_Yantra port calls the Inventory_Yantra AIC. The Inventory_Yantra AIC is described further below.

WMS 335 Shipping Details to Yantra 225

Entry into BizTalk™ 230

When the WMS 335 updates their shipping details, an XML document that conforms to the WMS_ShipDetails_Spec will be created and sent to the private\custName\shippingDetails MSMQ queue. This interface occurs in real time.

Receive Function 1705

The ShipDetails_Recv receive function 1705 continuously polls the private\custName\shippingDetails queue for XML documents. When an XML document is received, it is automatically sent to the WMS_ShipDetails_Yantra channel.

Channel

The inbound document specification is WMS_ShipDetails_Spec, and the outbound document specification is Yantra_ShipDetails_Spec. BizTalk™ messaging engine 710 is used to map the necessary information between the inbound and outbound specifications via the WMS_ShipDetails_Yantra map created with BizTalk™ Mapper utility. The outbound document is sent to the ShipDetails_Yantra port.

Port/AIC

The ShipDetails_Yantra port calls the ShipDetails_Yantra AIC. The ShipDeatils_Yantra AIC is described further below.

CS2k 220 Orders to Yantra 225

Entry into BizTalk™ 230

When user places an order via the front end, an XML document that conforms to CS2k_Orders_Spec is created and sent to the private\custName\IncomingOrders MSMQ queue. This interface occurs in real time.

Receive Function 1705

CS2k_Orders_Recv receive function 1705 continuously polls the private\custName\IncomingOrders queue for XML documents. When an XML document is received, it is automatically sent to CS2k_Orders Yantra channel.

Channel

The inbound document specification is CS2k_Orders_Spec, and the outbound document specification is Yantra_Orders_Spec. BizTalk™ messaging engine 1710 is used to map the necessary information between the inbound and outbound specifications via CS2k_Orders_Yantra map created with BizTalk™ Mapper utility. The outbound document is sent to the Orders_Yantra port.

Port/AIC

The Orders_Yantra port calls the Orders_Yantra AIC. The Orders_Yantra AIC is described further below.

Yantra 225 Orders to WMS 335

Entry into BizTalk™ 230

When an order is sent in to Yantra 225, Yantra system 225 publishes the order information in its export tables. The Windows scheduler then calls an executable to retrieve the XML document from the export tables and passes this document to the private\custName\OutgoingOrders MSMQ queue. Orders are published to Yantra's 225 export tables in real time, but BizTalk™ Server 1650 only receives orders when the executable is run to send the documents.

Receive Function 1705

YantraOrders_Recv receive function 1705 continuously polls the private\custName\OutgoingOrders queue for XML documents. When an XML document is received, it is automatically sent to Yantra_Orders_WMS channel.

Channel

The inbound document specification is Yantra_Orders_Spec, and the outbound document specification is WMS_Orders_Spec. BizTalk™ messaging engine 1710 is used to map the necessary information between the inbound and outbound specifications via Yantra_Orders_WMS map created with BizTalk™ Mapper utility. The outbound document is sent to the Orders_WMS port.

Port/AIC

The Orders_WMS port calls the Orders_WMS AIC. The Orders_WMS AIC is described further below.

Yantra 225 Settlement to Finance

Entry into BizTalk™ 230

When the user's order is placed with an internal code instead of a credit card, an XML document that conforms to Yantra_Settlement_Spec is created and sent to the private\custName\Settlement MSMQ queue. This interface occurs monthly based on configurations per client requirements.

Receive Function 1705

The Settlement_Recv receive function 1705 continuously polls the private\custName\Settlement queue for XML documents. When an XML document is received, it is automatically sent to Yantra_Settlement_Finance channel.

Channel

The inbound document specification is Yantra_Settlement_Spec, and the outbound document specification is Finance_Settlement_Spec. BizTalk™ messaging engine 1710 is used to map the necessary information between the inbound and outbound specifications via Yantra_Settlement_Finance map created with BizTalk™ Mapper utility. The outbound document is sent to the Settlement_Finance port.

Port/AIC

The Settlement_Finance port calls the Settlement_Finance AIC. The Settlement_Finance AIC is described further below.

Document Mapping Specifications

CS2k 220 Sending Published Items to Yantra 225

The ‘Published Item’ push from CS2k 220 to Yantra 225 is handled via a database to database transaction.

FTP of Files Versus Drop in MSMQ Queue

If a customer wants to ftp their XML files, receive functions 1705 can be written to poll a directory on the FTP server 1655 and to pick the file up from the FTP server 1655.

Document Formats other than XML

A client may wish to send/receive documents in a format other than XML, such as HTML etc. If so, additional work can be done at the channel level to convert the document format to or from XML.

Application Integration Component 1730

Overview of Application Integration Components (AIC)

The following contains detailed designs of each Application Integration Component (AIC) 1730 that is used in conjunction with BizTalk™ 230 messaging services to move data within CCMD. The AICs 1730 that are basically COM objects that are called from BizTalk™ 230 messaging ports. The input to each AIC 1730 is an XML string that represents the document that comes through a specific channel to a given port.

CS2k_EmployeeInfo AIC

General Information

Overview

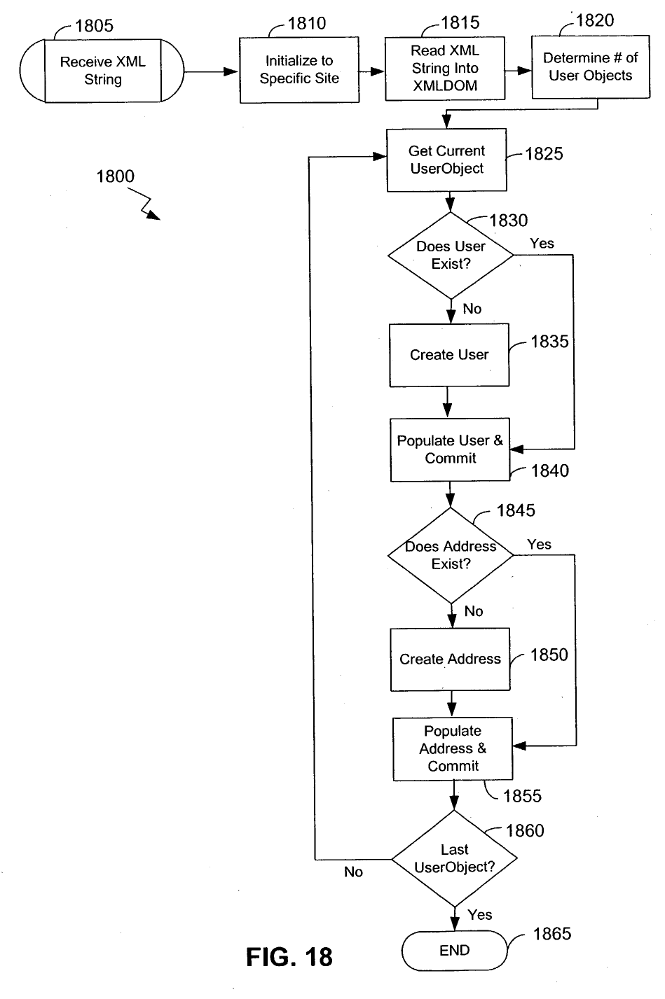

FIG. 18 shows a process flow diagram of CS2k_EmployeeInfo AIC 1800. CS2k_EmployeeInfo AIC processes Employee data coming from the HR system and writes the data to CS2k 220. The Employee data consists of both User and Address information.

An XML string is passed to the AIC 1730 from BizTalk™ 230, and the component strips out all relevant data and inserts it into the appropriate CS2k 220 tables. Most of the functionality is performed using the CS2k 220 API's, but the ‘get address’ functionality is implemented via custom code.

Detail

As shown in FIG. 18, an XML string is passed to the Staging_Items AIC 1800 from BizTalk™ 230 in step 1805. In step 1810, the Staging_Items AIC first initializes the XML string to a specific site. The Staging_Items AIC reads the XML string into XML DOM in step 1815. The Staging_Items AIC then determines the number of UserObjectives and obtains a current UserObject in steps 1820 and 1825 respectively. In step 1830, the Staging_Items AIC determines if a user exists. If no user exists, then a user is created and the Staging_Items AIC populates and commits the user in steps 1835 and 1840 respectively. If the user does exist, then the Staging_Items AIC populates and commits the user in step 1840.

Next, the Staging_Items AIC determines if an address exists in step 1845. If no address exists, then an address is created and the Staging_Item populates and commits the address in steps 1850 and 1855 respectively. If an address exists, then the Staging_Item populates and commits the address in step 1855. The Staging_Items AIC then determines if the last Userobject has been reached in step 1860. If the last Userobject has not been reached, then the Staging_Items AIC obtains the next current Userobject in step 1825. However, if the last Userobject has been reached, then the process ends at step 1865.

The AIC 1730 implements BizTalk™ 230 IBTSAppIntegration component. Necessary references include Microsoft® ActiveX Data Objects 2.6, Microsoft® Commerce 2000 Configuration, Microsoft® Commerce 2000 GenID, Microsoft® Commerce 2000 Profile Service, Microsoft® XML v3.0, and Microsoft® BizTalk™ Server Application Interface Components 1.0.

The message is passed in from BizTalk™ 230 via the IBTSAppIntegration ProcessMessage method. The string can be loaded into an XML DOM. CS2k 220 API's are used to initialize and configure the profile object based on the name of the site, get user and address objects from CS2k database, create user and address objects, and write user and address object data to the appropriate CS2k 220 tables.

The CS2k 220 Address table can include an extra Boolean field (c_system_created) so that users can have multiple addresses. Only the address created by the system is modifiable by the system.

CS2k InternalCodes AIC

General Information

Overview

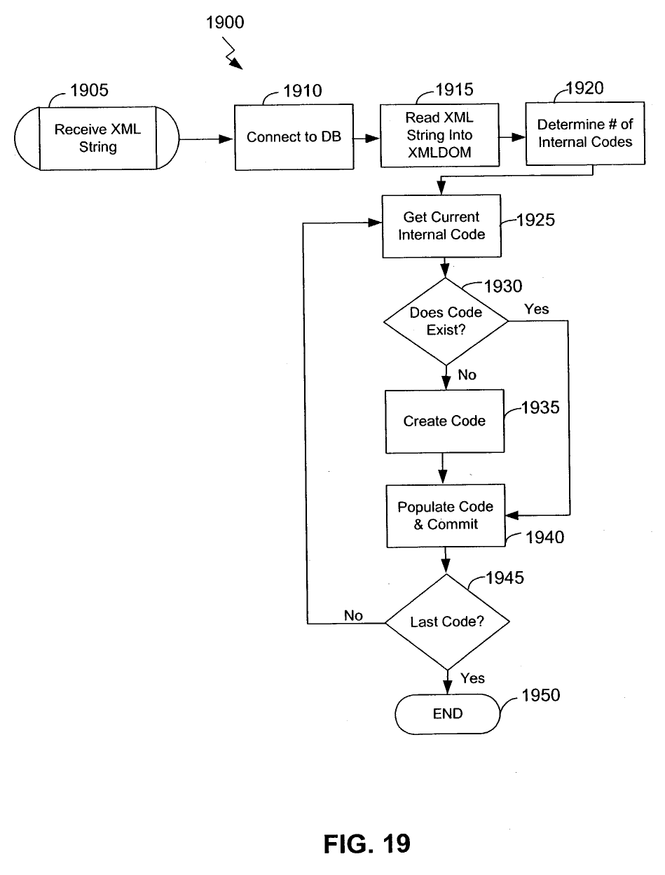

FIG. 19 shows a process flow diagram of CS2k_InternalCodes AIC 1900. CS2k_InternalCodes AIC processes Internal Code data coming from the Finance system and writes the data to CS2k 220. An XML string is passed to the AIC from BizTalk™ 230, and CS2k InternalCodes AIC strips out all relevant data and inserts it into the appropriate CS2k 220 tables. CS2k_InternalCodes AIC is implemented almost entirely with custom code as there are not any CS2k 220 APIs for this functionality.

Detail

As shown in FIG. 19, an XML string is passed to CS2k_InternalCodes AIC from BizTalk™ 230 in step 1905. In step 1910, CS2k_InternalCodes AIC connects to the SQL Server database that supports the Storefront and Administration. CS2k_InternalCodes AIC reads the XML string into XML DOM in step 1915. CS2k_InternalCodes AIC then determines the number of internal codes in step 1920 and obtains the current internal code in step 1925. In step 1930, CS2k_InternalCodes AIC determines if an internal code exists. If no internal code exists, then an internal code is created and CS2k_InternalCodes AIC populates and commits the internal code in steps 1935 and 1940 respectively. If the internal code does exist, then CS2k_InternalCodes AIC populates and commits the internal code in step 1940.

CS2k_InternalCodes AIC then determines if the last internal code has been reached in step 1945. If the last internal code has not been reached, then CS2k_InternalCodes AIC obtains the next current internal code in step 1925. However, if the last internal code has been reached, then the process ends at step 1950.

CS2k_InternalCodes AIC implements BizTalk™ 230 IBTSAppIntegration component. Necessary references include Microsoft® ActiveX Data Objects 2.6, Microsoft® Commerce 2000 Configuration, Microsoft® XML v3.0, and Microsoft® BizTalk™ Server Application Interface Components 1.0.

The message is passed in from BizTalk™ 230 via the IBTSAppIntegration ProcessMessage method. The string is loaded into an XML DOM. A CS2k 220 API is called to get a connection string to the proper database depending on which company the codes are from. After the connection is created, CS2k_InternalCodes AIC loops through each code and either updates or creates it in the SQL Server database that supports the Storefront and Administration.

Staging_Items AIC

General Information

Overview

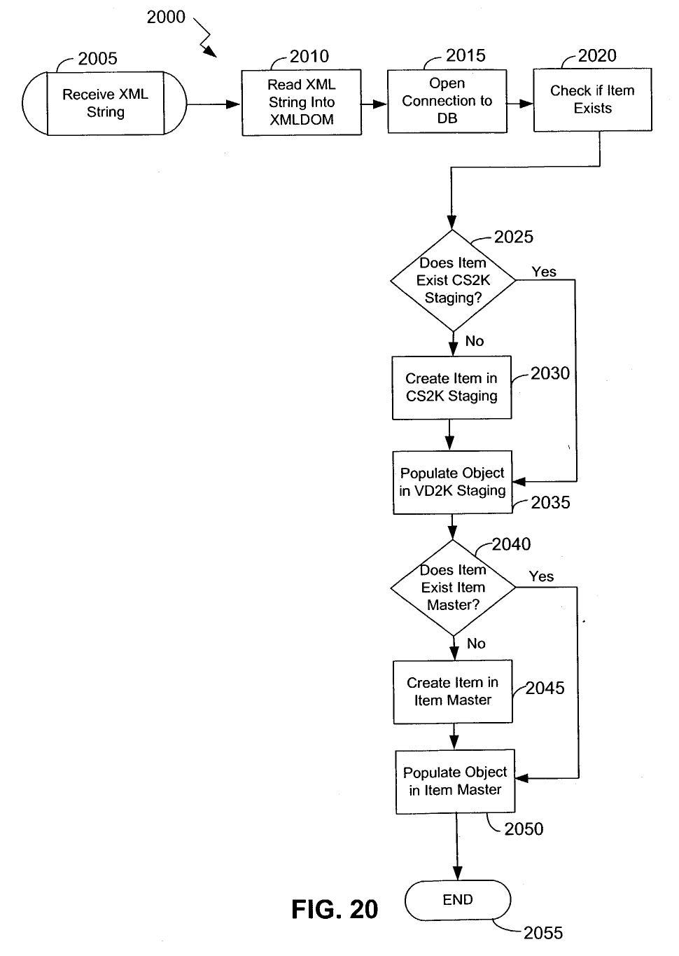

FIG. 20 shows a process flow diagram of the Staging_Items AIC 2000. The Staging_Items AIC processes Item data coming from either a Digital or Physical Asset Management system and writes the data to the Staging_Item Master.

Detail

As shown in FIG. 20, an XML string is passed to the Staging_Items AIC 1500 from BizTalk™ 230 in step 2005. In step 2010, the Staging_Items AIC reads the XML string into XML DOM. Next, the Staging_Items AIC opens a connection to the SQL Server database that supports the Storefront and Administration and checks if an item exists in steps 2015 and 2020 respectively. In step 2025, the Staging_Items AIC determines if the item exists. If no item exists, then an item is created and the Staging_Items AIC populates he Object in CS2k 220 staging in steps 2030 and 2035 respectively. If the item does exist, then the Staging_Items AIC populates the object in CS2k 220 staging in step 2035.

Next, the Staging_Items AIC determines if the item exists in Item Master in step 2040. If no item exists in Item Master, then an item is created in Item Master and the Staging_Item populates the object in Item Master in steps 2045 and 2050 respectively. If an item exists in Item Master, then the Staging_Item populates the object in Item Master in step 2050. The process ends at step 2055.

The Staging_Items AIC implements BizTalk™ 230 IBTSAppIntegration component. Necessary references include Microsoft® ActiveX Data Objects 2.6, Microsoft® XML v3.0, and Microsoft® BizTalk™ Server Application Interface Components 1.0.

The message is passed in from BizTalk™ 230 via the IBTSAppIntegration ProcessMessage method. The string is loaded into an XML DOM. The Staging_Items AIC is open a connection to the proper database. After the connection is created, the Staging_Items AIC traverses the DOM and either update or create items in the SQL Server database that supports the Storefront and Administration.

CS2k Items AIC

General Information

Overview

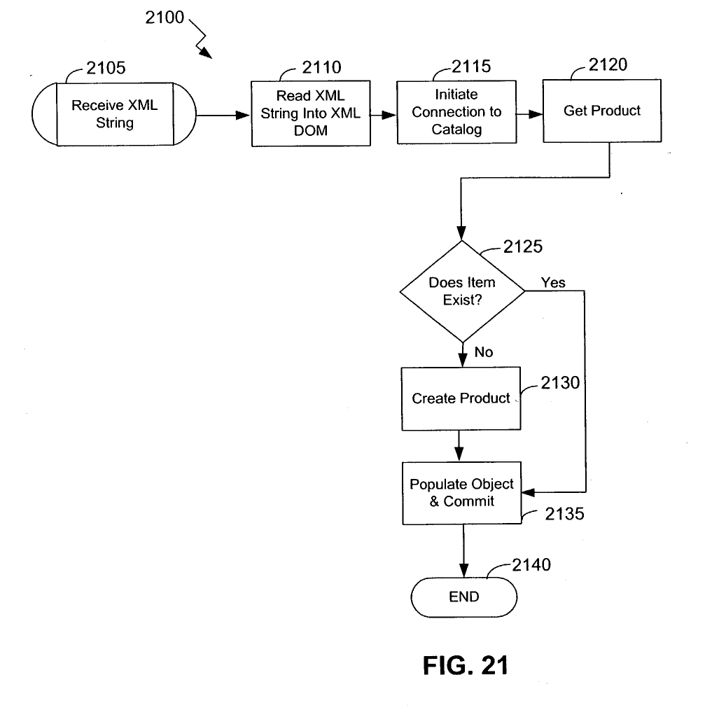

FIG. 21 shows a process flow diagram of CS2k_Items AIC 2100. CS2k_Items AIC processes Item data coming from the Staging_Item Master and imports Items into the CS2k 220 catalogs.

Detail

As shown in FIG. 21, an XML string is passed to CS2k_Items AIC 2100 from BizTalk™ 230 in step 2105. In step 2110, CS2k_Items AIC reads the XML string to XML DOM. Next, CS2k_Items AIC initializes a connection to the Catalog and obtains a product in steps 2115 and 2120 respectively. In step 2125, CS2k_Items AIC determines if the item exists. If no item exists, then the product is created and CS2k_Items AIC populates the object and commits in steps 2130 and 2135 respectively. If the item does exist, then CS2k_Items AIC populates the object and commits in step 2135. The process ends at step 2140.

CS2k_Items AIC implements BizTalk™ 230 IBTSAppIntegration component. Necessary references include Microsoft® ActiveX Data Objects 2.6, Microsoft® Commerce 2000 Configuration, Microsoft® Commerce 2000 Catalog, Microsoft® XML v3.0, and Microsoft® BizTalk™ Server Application Interface Components 1.0.

The message is passed in from BizTalk™ 230 via the IBTSAppIntegration ProcessMessage method. The string is loaded into an XML DOM. CS2k 220 API's are used to load site information, get catalog and product objects from CS2k database 1615, create catalog and product objects, and write catalog and product object data to the appropriate CS2k 220 tables.

Yantra Inventory AIC

General Information

Overview

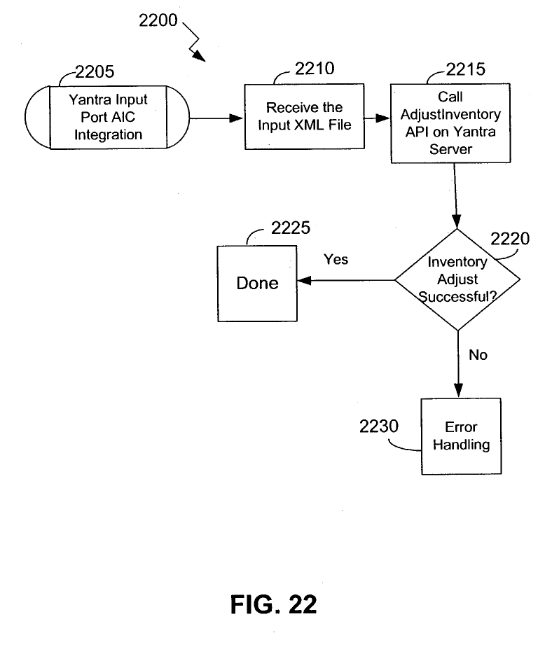

FIG. 22 shows a process flow diagram of Yantra_Inventory AIC 2200. The DLL processes information is passed from the warehouse management system 335 and calls an API adjustInventory to Yantra server 1635. Functions include executing the adjustInventory API, error handling and error logging.

Detail

As shown in FIG. 22, data is entered at Yantra Input Port AIC 2205. Yantra_Inventory AIC then receives an input XML file in step 2210. Yantra_Inventory AIC calls the adjustInventory API in Yantra Server 1635 and attempts to adjust the inventory level in Yantra 225 in step 2215. If the inventory adjustment is successful then the processes is finished as shown in steps 2220 and 2225 respectively. If the inventory adjustment is not successful, then a subroutine LogError is first called and errors are logged. Subsequently, the ErrorHandling subroutine is called and appropriate error handling is performed in step 2230.

Yantra_Orders AIC

General Information

Overview

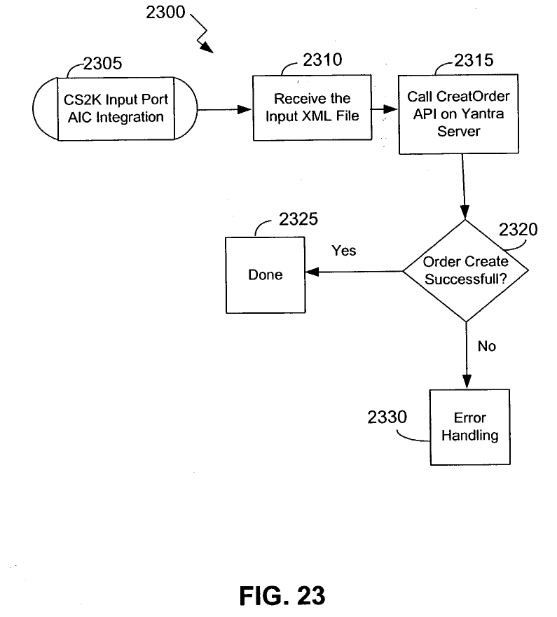

FIG. 23 shows a process flow diagram of Yantra_Orders AIC 2300. This DLL processes information passed from CS2k 220 and calls an API createorder to Yantra server 1635. Functions include executing the createOrder API, error handling and error logging.

Detail

As shown in FIG. 23, data is entered at CS2k input port AIC 2305. Yantra_Orders AIC then receives an input XML file in step 2310. Yantra_Orders AIC then calls the createOrder API in Yantra Server 1635 and attempts to create an order in Yantra 225 in step 2315. Yantra_Orders API then determines if the order creation is successful in step 2320. If an error occurs during order creation, then the subroutine LogError is first called and the error are logged. Subsequently, the ErrorHandling subroutine is called and the appropriate error handling is performed in step 2330. If the order creation is successful, then the process is complete in step 2325.

Yantra ShipDetails AIC

General Information

Overview

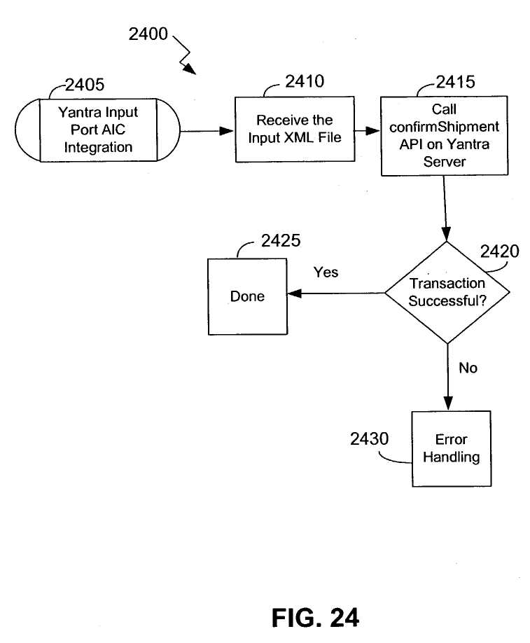

FIG. 24 shows a process flow diagram of Yantra_ShipDetails AIC 2400. This DLL processes information is passed from the Warehouse management system 335 and calls an API confirmShipment to Yantra server 1635. Functions include executing the confirmShipment API, error handling and error logging.

Detail

As shown in FIG. 24, data is entered at Yantra input port AIC 2405. Yantra_ShipDetails AIC then receives an input XML file in step 2410. Yantra_ShipDetails AIC then calls the confirmShipment API in Yantra Server 1635 and attempts to pass in the shipping details into Yantra 225 in step 2415. Yantra_ShipDetails API then determines if the transaction is successful in step 2420. If an error occurs during order creation, then the subroutine LogError is first called and the errors are logged. Subsequently, the ErrorHandling subroutine is called and the appropriate error handling is performed in step 2430. If the transaction is successful, then the process is complete in step 2425.

WMS Items AIC

General Information

Overview

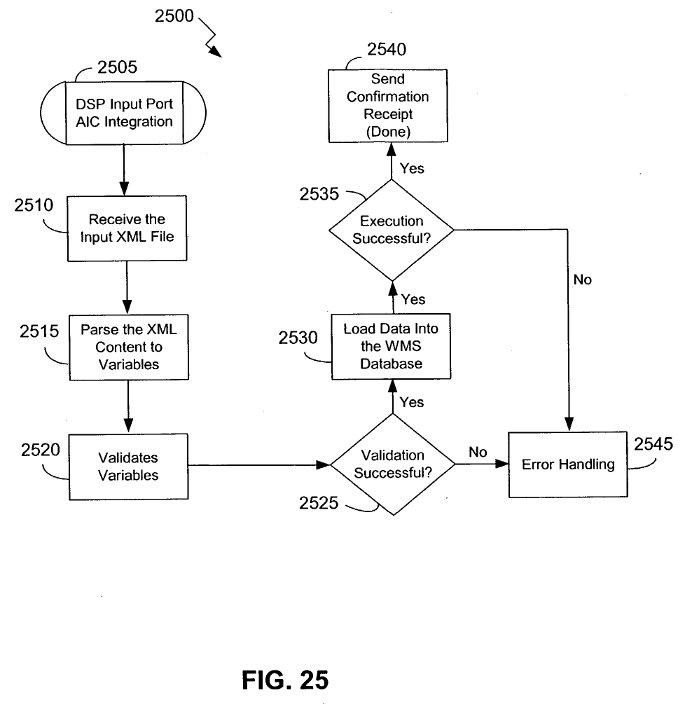

FIG. 25 shows a process flow diagram of the WMS_Items AIC 2500. This DLL receives the itemload XML document from Commerce Server and stores it into the Warehouse Management database. Functions include loading input data into the WMS 335 database, validating the input data such as checking whether the same file has been processed.

Detail

As shown in FIG. 25, data is entered at DSP input port AIC 2505. The WMS_Items AIC then receives an input XML file in step 2510. Next, the WMS_Items AIC parses the XML contents to variables and validates the variables in steps 2515 and 2520 respectively. The WMS_Items API then determines if the validation is successful in step 2525. If the validation is not successful, then the subroutine LogError is first called and the errors are logged. Subsequently, the ErrorHandling subroutine is called and the appropriate error handling is performed in step 2545. If the transaction is successful, then data is loaded into the WMS 335 database in step 2530. Next, the WMS_Items AIC determines if the execution of the database load is successful in step 2535. If the execution is successful then a confirmation receipt is sent and the process is complete in step 2540. If the execution is not successful, then the subroutine LogError is first called and the errors are logged. Subsequently, the ErrorHandling subroutine is called and the appropriate error handling is performed in step 2545.

The MSXML.DOMDocument object is used for XML parsing in the AIC. The submit method of BTSInterchangeLib.Interchange object is used for integration between the COM+ and the SCS channel.

WMS Orders AIC

General Information

Overview

This AIC integrates Yantra 225 with the WMS 335 to send orders to the WMS 335. The WMS Orders AIC is implemented based on client specification.

Finance Settlement AIC

General Information

Overview

This AIC integrates Yantra 225 with the Financial System by sending settlement information to the Financial System. The Finance Settlement AIC is implemented based on client specification.

BizTalk™ 230 Error Handling

AIC Level Errors

Local Error Handling

Errors that occur at the AIC level are handled via local error handling routines within the AIC itself. An example of an error which occurs at the AIC level is when an API is called and throws an expected error back. Since the error is expected, custom code in the error handling section of the method can determine a course of action and continue processing.

BizTalk™ 230 Error Handling

If the error is not handled locally, BizTalk™ messaging engine 1710 passes the document into the Retry queue 1755 within BizTalk™ 230 and waits for a specified period of time (e.g. 5 minutes). After the specified time, BizTalk™ 230 attempts to process the message again. If the processing is unsuccessful a total of three times, the document is sent to the Suspended Queue 1750 within BizTalk™ 230. At this point, an administrator will be responsible for managing suspended queues.

BizTalk™ 230 Suspended Queue Monitong

Description of Executable

Referring again to FIG. 17, a BizTalk™ queue monitor executable utilizes BizTalk™ Interchange interface 1715. The executable uses the IInterchange.CheckSuspendedQueue method to return a list of documents that may have been suspended for any reason. It then works through the list pulling out details via the IInterchange.GetSuspendedQueueItemDetails method. This method returns SourceName (where the document was sent from), DestName (where the document was going), DocName (document name), ReasonCode (reason why the document was sent to the queue), and ItemData (the text of the actual message itself).

From the ItemDetails information, the executable determines who needs to be aware of the Suspended document (i.e., if the source system 1735 is CS2k 220 and the destination system 1725 is Yantra 225, it notifies a specified distribution list for each team), and sends an e-mail to that list with the associated details. The executable is run via Microsoft Windows Scheduling during specified time intervals.

User Interaction

As teams receive e-mails concerning BizTalk™ Suspended Queue 1750 documents, they may have to manually look at the document and ReasonCode to determine why it was not processed correctly. If able, they can fix the document and manually resubmit the document to the proper channel by dropping the updated document into the appropriate file system directory.

Database Servers 1630 in FIG. 16

The database servers 1630 can run SQL Server2000™ and can operate as a cluster, which can be managed via Application Server2000™. Both Yantra 225 and CS2k 220 data files reside on the external disk raid array 1690. CS2k databases 1615 and Yantra databases 2720 can be accessed through their own database servers within the cluster that is connected to the same raid array 1690. CS2k database 1615 and Yantra database 2720 calls can be routed to back to CS2k database 1615 and the Yantra database 2720 respectively. In case of failure at the database server 1630 level, both CS2k database 2715 and Yantra database 2720 calls can be re-routed to the functioning or hot server. Application Center can handle the failure procedures and re-routing of calls.

The disk array 1637 can be triple mirrored to protect for failures and assist in the backup process. The mirroring can be a hardware-based solution provided with the disk array 1637 and does not require any multiple-phase commit from the applications. Full, cold backups can be taken from the third mirror easily without disrupting service to the end-user. The database on this disk array should also be configured to support point-in-time recovery.

The database of documents can be configured to support multiple languages. The requirements include not only database configuration to support additional character sets but also database structure changes using multiple catalogs that can support presentation of data in multiple languages. Although multiple languages may not be a requirement for the first client, the capability has been designed into the database architecture to simply transition to a multi-language site when needed.

In one embodiment, the multi-language site can also be designed to support multiple enterprises on a single database engine. The multi-enterprise does not affect the database configuration but does affect the database structure to some degree. In this embodiment, the profile for a user would reflect their enterprise id. This would keep all products, campaigns, customer information, etc. need to be kept confidential to the client organization.

The staging environment 1665 is required for the content and product owners so that they may test out their changes to the StoreFront application 305 site prior to implementing them in production. The staging environment 1665 is described further below.

Staging Environment 1665

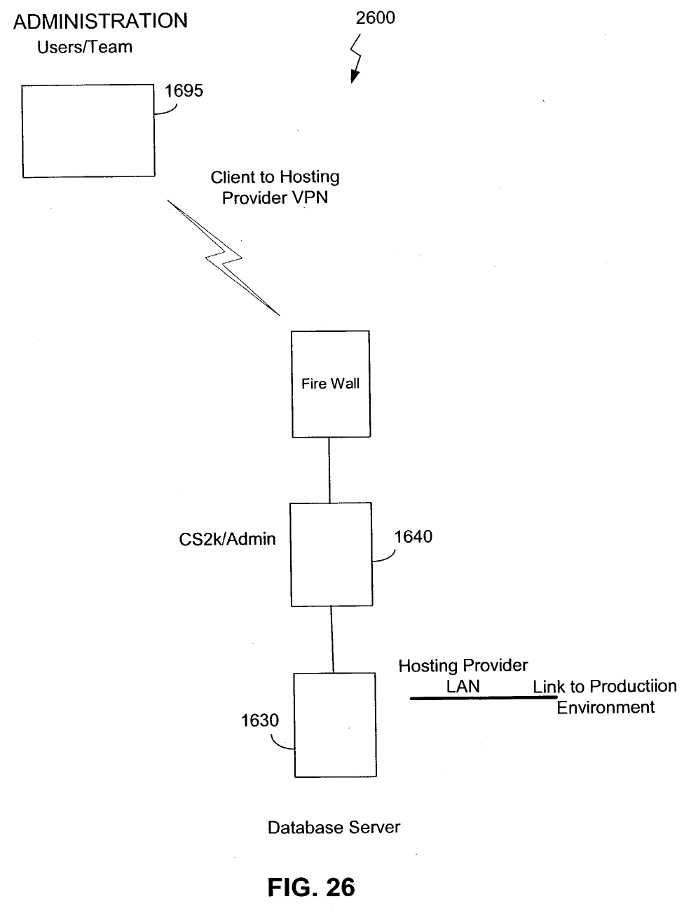

FIG. 26 shows one embodiment of the physical layout of the staging environment 1665. The Staging environment 1665 consists of all the hardware and software components necessary to operate and run the administration component of the CCMD web site. This environment allows Site Administration users 1695 and content/Part Managers to access the Administration Application 310 to conduct day-to-day web site management activities such as defining assortments, adding products to assortments, setting prices, creating campaigns, ingesting digital assets, etc. This environment is also used as a testing ground for the administration users 1695 to validate their changes prior to deploying their modifications to the website.

The CCMD team is responsible for specifying the physical layout and hardware configuration for the production environment 1600. This team can work with the Hosting Provider to acquire and install this infrastructure at the Hosting Provider's data center. The Hosting Provider is responsible, per CCMD's specifications, for monitoring the site from the operating systems 415 and hardware down to the network components per the run book. CCMD is responsible for monitoring and maintaining the applications (CS2k 220 and Yantra 225). The Hosting Provider can provide database administration functions for the SQL Server databases.

Once the Hosting Provider environment is built out and the necessary software is installed, CCMD web pages, digital assets and data can be loaded into this environment. Once the web site is live, changes to the environment follows a detailed change control process, which is maintained by the Hosting Provider but defined by CCMD. Those skilled in the art will understand that various change control processes may be used in this respect. The client's administration users 1695 are responsible for day-to-day maintenance of the web site (adding products to assortments, setting up promotions/discounts, assigning prices, content, etc.)

In one embodiment, the Staging Environment 1665 may not be designed to support high availability or hot failover solutions. This staging environment 1665 is not considered critical to the operation of the web site and therefore it may not have any application redundancy. Thus, in the case of a failure of any of the application components, the administration users 1695 can not access the staging environment 1665 until the problem is resolved.

The staging environment 1665 is used to validate modifications, new products/content to the site components such as catalogs, products, prices, campaigns and digital assets. This information is first entered into staging and can be viewed prior to releasing the modifications to production. The release to production is a scheduled batch execution. The schedule is dependent upon client requirements. Immediate changes that need to be made to the site can be made by system administration personnel (not client resources in a hosted environment) using the BizDesk Application. Information such as users, roles, addresses, and charge codes are modified directly in the production environment 1600 via the administration application 310 or via BizTalk™ 230 data loads from 3rd party applications.

Staging to Production Migration Process

FIG. 27 shows one embodiment of the Staging to Production Migration Process 2700. In this embodiment, staging is planned to be a nightly process. This schedule is flexible depending on the client. The staging process involves three major entities: products (including digital assets), catalogs and categories, and campaigns. The staging process 2700 for each entity is described below. Modifications to entities related to a user such as roles, addresses, profiles, and users is entered via the Administration Application 310 but written directly to production. This information is not staged. Authentication and authorization are always conducted via the production CS2k database 2715, even for the administrator database. In addition, BizTalk™ 230 is used to load user/profile data and charge code information from 3rd party systems directly to the production CS2k database 2715.

Products

Products, metadata, and product data can be loaded to CCMD in two ways:

Part Managers or Site Administration users 1695 can manually enter the product data into the staging database 1645 (specifically the Item master table 2730) located within the staging database server 2705 via the Administration Application 310. In addition, the actual digital asset data file can be loaded to the Digital Asset Repository (DAR) 1685 Server, which is simply a file server that sits in the production environment 1600.

A regular load (does not have to be daily) of product data and/or metadata can be sent from the client's digital asset management system 325 to staging database 1645 (specifically the Item master table 2730) located within the staging database server 2705 via a BizTalk™ 230 upload. The actual assets are ftp'd to the DAR server 1685, which is simply a file server that sits in the production environment 1600.

Metadata and product data can be initially loaded to CS2k staging database 1645. At that point there are a number of options for how the product can be added to production:

If the load from the 3rd party system 2735 already includes a category/catalog assignment and no approval is required, then the product can be automatically loaded to the production environment 1600 during the Nightly DTS Package stage 2740.

If the load from the 3rd party system 2735 already includes a category/catalog assignment and approval is required, then the product is defined as being in the “Ready”state. Once the approval is complete, the product can be automatically loaded to the production environment 1600 during the Nightly DTS Package stage 2740.

If the load (from the Administration Application 310 or the 3rd party system 2735) does not include the category/catalog assignment and an approval is not required then it can first be assigned to a catalog/category via the Administration Application 310 prior to the nightly load to production.

If the load (from the Administration Application 310 or the 3rd party system 2735) does not include the category/catalog assignment and an approval is required then it can first be assigned to a catalog/category via the administration application 310 and approved prior to the nightly load to production.

The actual asset can be directly loaded to the production asset repository file server. The actual assets are never staged. Once the product data and meta data are ready to be loaded into production, the Nightly DTS Package Stage 2740 process also loads the appropriate data set to the Yantra database 2720. Yantra database 2720 requires this data set to assign inventory.

Catalogs and Categories

Catalogs and Categories can be created or modified using the Administration Application 310. The following functions are made to both the environment 1665 and production environment 1600 at the same time:

Modification, creation, and deletion of new catalog

Modification, creation, and deletion of a category.

The following functions are made just to the staging environment 1665 and are pushed to production during the Nightly DTS Package Stage 2740 process:

Modification, addition, and deletion of products to catalogs and categories.

The functions made to both the staging environment 1665 and production environment 1600 at the same time are necessary since CCMD is using CS2k 220 APIs to create and delete catalogs/categories. The APIs create (or delete) all the necessary stored procedures during the API execution. The result of the catalog/category creation process can be difficult to replicate to another database using a custom solution. Therefore, CCMD does the create (or delete) to both environments at the same time. Neither the catalog nor category are visible to the end-user from production until products are added to them. And product addition is a function that goes to the staging environment 1665 first and then to the production environment 1600.

Campaigns

Campaigns can be created, updated, or deleted via the Administration Application 310. Once in the staging environment 1665 these items are replicated to the production database server 1630 on a nightly basis using SQL Servers replication feature.

Nightly DTS Package Stage 2740

The DTS package pulls the appropriate data (new items, item/catalog/category relationships, updates to items) from the staging database 1645 into a file, which is passed on to BizTalk™ 230. BizTalk™ 230 picks up the file and loads the data into the production database server 1630. BizTalk™ AIC for this process is referred to as CS2k_Staging.

Staging Users

The primary users of the staging environment 1665 are the content/product owners or managers. Requirements for browser 1673 support for the Administration Application 310 include IE4.0+ and Netscape 4.0+ on Windows 95+, NT4+, and MAC 8.0+. In one embodiment, the method for system authentication is through unique id/password combination. Authorization can be determined by the role, group, and privilege definitions. However, in another embodiment, other options can be used for user authentication and authorization such as LDAP integration.

CS2k/Administration Web/App Servers 1640 in FIG. 16

This CS2k/Administration Web/App server 1640 supports IIS 5.0, and the administration application 310. The administration application 310 has pages that provide a preview of what the production pages look like so that the administration user 1695 can view their modifications prior to publishing to production. The preview pages point to the staging database 1645.

The Site Administration users 1695 and the Part Managers can use CS2k/Administration Web/App server 1640 to enter new products and to maintain the production web site. This is the administration users 1695 primary tool for making changes to the production site. Since their changes are only staged to production nightly, if there are any emergency changes that need to be made to the site, the administration users 1695 can call the operations team (trained in suporting this embodiment) to make the change. The operations team can use the BizDesk Application, which points to the production environment 1600 to make the change.

Database Server 1630

The database server 1630 can be a single machine that supports MS SQL Server 2k 1645 and CS2k staging database 1645. The database server 1630 may or may not have a redundant failover, but the CS2k staging database 1645 can be updated on a regular, nightly schedule. The CS2k staging database 1645 should also be configured to support point-in-time recovery.

The CS2k staging database can be configured to support multiple languages. A single character set can be supported. Additional character sets can be supported with additional machines. While the Administration Application 310 may only be available to a user in a single language (the default language of the enterprise), each enterprise can have a different default language.

Developement and Test Environments

To support the application build there can be 4 primary development and test environments. They include:

Development

Assembly Test

Product Test

Performance Test—The intent is to conduct performance testing of key functions only using the product test environment.

Development and Assembly Test

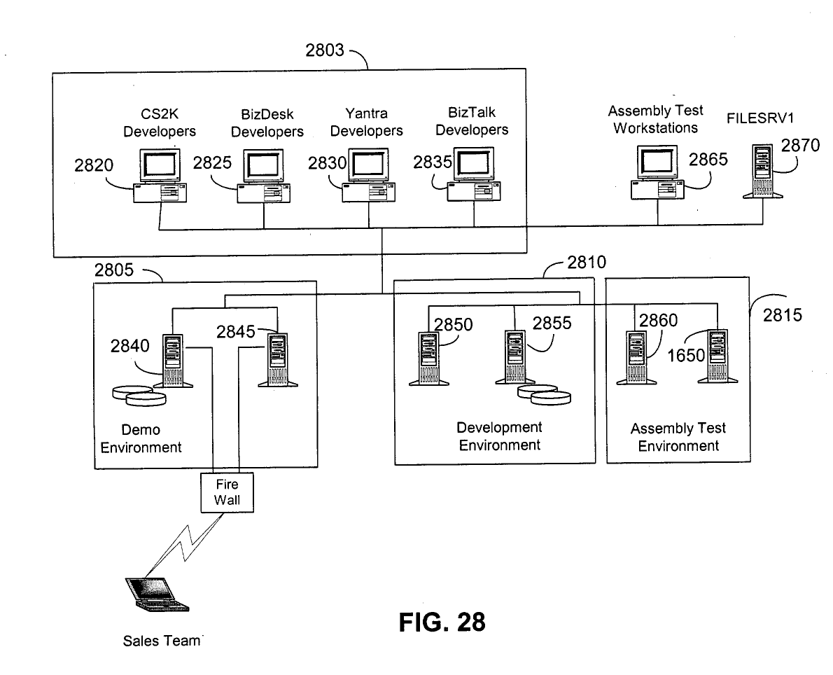

FIG. 28 shows one embodiment of the demo environment 2805, development environment 2810, and assembly test environments 2815. The demo environment 2805 includes a Demodatabase server 2840 and a Yantra demo server 2845. The demo environment 2805 provides a secure exemplary system for use by the sales team to illustrate to potential customers below the CCMD system functions. The development environment 2810 includes a Yantra development/assembly server 2850 and a development/assembly database 2855. The assembly test environment 2815 includes a CS2k/Production environment administration server 2860 and a BizTalk™ server 1650.

Development actually occurs on the developer's workstations 2803, where the developer's can have the appropriate applications loaded. The developer's workstations 2803 include CS2k Front-end Developer workstation 2820, the production environment administration developer 2825, Yantra developer workstation 2830, and BizTalk™ developer workstation 2835. The developer workstations 2803 can be connected to the database server 1630 via the LAN. There can be 3 primary databases for development purposes:

CS2k 220 Front-end

CS2k Administration

Yantra 225

In one embodiment, BizTalk™ 230 development environment can be entirely located on a single workstation. There is no need for BizTalk™ developer workstations 2835 to access the databases on the development server database. The following table outlines the software installed on each developer workstation:

| Workstation Type | Software |
|---|---|
| CS2k Front-end Developer | Microsoft ® Interdev |
| | Microsoft ® Visual SourceSafe Client |
| | Microsoft ® IIS v5.5 |
| | Microsoft ® Commerce Server 2000 |
| | ACA 2.0 |
| CS2k Administration Developer | Microsoft ® Interdev |
| | Microsoft ® Visual SourceSafe Client |
| | Microsoft ® IIS v5.5 |
| | Microsoft ® Commerce Server 2000 |
| | Microsoft ® Commerce Server 2000 |
| | BizDesk |
| | ACA 2.0 |
| Yantra Developer | Microsoft ® Interdev |
| | Microsoft ® Visual SourceSafe Client |
| BizTalk ™ Developer | Microsoft ® Interdev |
| | Microsoft ® Visual SourceSafe Client |
| | Microsoft ® BizTalk ™ Server 2000 |
| | Microsoft ® MSMQ |
| | Microsoft ® SQL Server 2000 |
| | ACA 2.0 |

The assembly test workstation 2865 provides a clean environment to combine all of the developer's workstations 2803 changes for release to the assembly test environment 2815 for testing. The file server (filesrv1) 2870 provides storage for developer code and design documentation.

Product Test

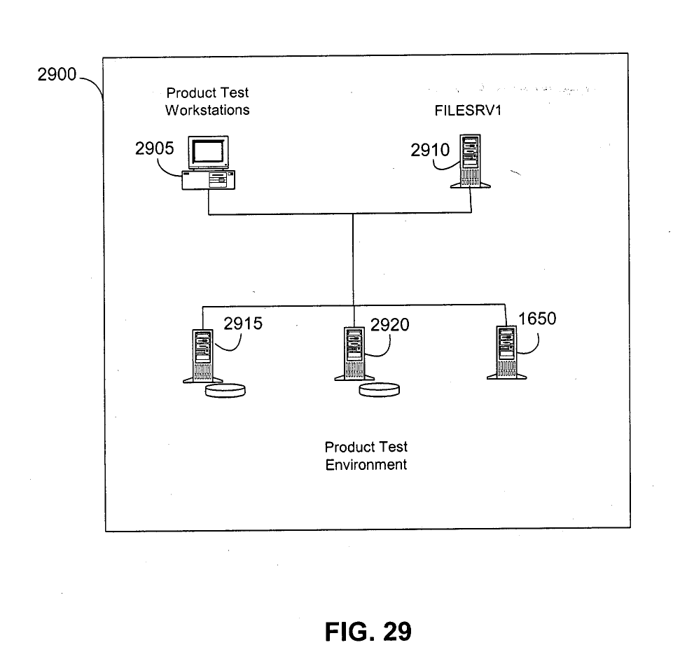

FIG. 29 shows one embodiment of the Product Test environment 2900. The product test environment 2900 includes multiple product test workstations 2905, a fileserver 2910, a Yantra product test server 2915, a CS2k/production environment administration server 2920, and a BizTalk™ server 1650. The CS2k 220 Production database and Staging database 1645 have been installed on separate machines to simulate the production architecture. Product Test is centered on testing functionality, multi-enterprise capability, and the multi-language capability. Product Test may or may not include testing of load-balancing, failover, or performance capabilities.

Performance Test

Performance test can be conducted in the product test environment. The performance test focuses on testing key metrics and scenarios to determine the response time. These response times can be specifically tied to the product test environment and configuration. The goal is to test the system to its extremes to determine performance of key metrics and scenarios.

Furthermore, key functions can be measured such as:

Response time to process an order from BizTalk™ 230 to Yantra 225

Response time to bring up a product detail page

Response time for searches of products

The administration application 310 can also be performance tested. In production, the administration application 310 and StoreFront application 305 can run on separate servers. In the product test environment, they are on the same servers so the performance test of the StoreFront application 305 may have to be run independently from the performance test of the administration application 310 There are many variables that are client specific as to where the administration users 1695 would be located and what time of day would then be the peak time, but the assumption is that highest usage may occur when 50% of the users are on-line with the system and that each user initiates a transaction every 10 seconds.

In addition, key functions can be measured such as:

Response time for adding new catalogs and categories

Response time for staging

Response time for searching for products and users

Response time for creating campaigns

Due to the restrictions of the product test environment, not all performance related architecture design decisions can be tested. The following conditions are not performance tested or operationally tested until a production environment 1600 or other suitable environment is provided:

Load balancing of the CS2k 220 application servers for the StoreFront application 305

Load balancing of Yantra Pure eCommerce Portal 230 application

Load balancing/failure of the Yantra 225 API calls

Failure of the CS2k 220 StoreFront application 305

Code Migration/Change Control

In the product test environment a code migration/change control system would prudently be used to maintain control of the versions of software under test. Any one of a number of available change control systems can be used.

Multiple Enterprise

CCMD is designed as a hosted solution to support multiple enterprises within the same hardware configuration. In addition, CCMD can be packaged as a non-hosted, single-enterprise solution. The CCMD makes three primary modifications to build the multi-enterprise feature: installs separate CS2k 220 sites, uses a page controller development framework, and re-builds the BizDesk Application. In one embodiment, separate CS2k sites are installed, the ACA page controller development framework is used, and the BizDesk Application is rebuilt.

The separate CS2k 220 sites obtain enterprise-specific Internet Information Server (IIS) directories and databases IIS is configured with a home directory for each enterprise. Each home or web root directory stores the ASP pages, images, and configuration files for a particular enterprise. A database per enterprise is preferable to maintain the security of an enterprise's data. CS2k 220, by itself, does not limit a system administration user's access to other enterprise's data. Therefore, CCMD uses multiple databases so that a system administration user only has access to the database that is specific to their enterprise. The database connection string is defined in an ACAconfig.xml file for page controllers. There is one ACAconfig.xml file per server, which contains multiple database connection string entries. The page controllers access a global.ASA file to determine which connection string to access and the value of the connection string is obtained from the ACAconfig.xml. For CS2k 220 APIs, the value of the connection string is obtained directly from a siteconfig object, which is set up in BizDesk Application. The siteconfig object is based on name/value pairs and multiple database connection strings can be configured for this object. The calling function passes the appropriate database connection string to the API. Each site has a separate globalASA, siteconfig object, and rc.xml file (for the storing of static data).

The ACA 210 page controller development framework is used so that a single set of page controller objects can access and manipulate data. Page controllers are inherently designed to access multiple data stores and to be called from multiple ASPs. Page controllers do not store hard-coded information related to a session, thus they cannot be limited to a single environment.

Although the BizDesk Application, the Microsoft's® CS2k 220 delivered administrator application for manipulating catalogs, products, campaigns, and users, provides the capability for a universal administrator, it does not provide the ability to segregate user access and functions to particular catalogs and data sets. Therefore, CCMD completely re-builds the equivalent of the BizDesk Application using CS2k 220 APIs with customized security functionality to restrict access to an enterprise's data. One of the security features is based on navigation. Users that have an administration user profile have a link to the administration application 310 displayed on their screen. Users that do not have an administration user profile do not have a link to the administration application 310. Furthermore, when a user tries to access an administrator page, their role is checked against the page to confirm that access to that page is allowed for that role.

Another modification is that CCMD's administration application 310 is web-enabled with a browser-based user interface. Thus, the CCMD solution requires nothing to be downloaded to the user's browser 1673. This is an improvement over Microsoft's® BizDesk application which downloads a HTA (hyper-text application) component on the desktop for security purposes. Furthermore, CCMD mitigates the need to use the preferred IE5.5 for HTA to work.

Multiple Language

Overview

Multi Language Concepts

One reason for enabling multiple languages within a single website is if the website is targeted to more then one country. Another reason is where there is more than one language within a country. There are also situations in which both scenarios apply. Multi language and globalization are similar concepts but have two primary components:

Internationalization—Internationalization is the process of developing an application so that it can be adapted to different languages and regions, using generic coding and design strategies and whose source code base simplifies the creation of different language programs.

An internationalized application allows users to enter, store, process, retrieve, print, and display data in their language of choice in formats matching their cultural expectations. This includes date formats, currencies, symbols, sort order, pictures, measurement systems, system messages, and so on.

Localization—Localization is the process of adapting/customizing software for a specific language or region by adding locale-specific components, translating text, and changing the user interface to accommodate different alphabets and cultures.

Site localization is not simply language translation of text. It also includes (among other things):

Defining & delivering relevant user experience to local audience

Ensuring data capture is sensitive to common local practices

Ensuring proper site security (security requirements differ by country)

Delivering appealing content to local users

Ensuring text on site is linguistically correct for local audience

Ensuring local business practices are accurately reflected by site content

Yantra v3.1 includes a limited multi language capability. Yantra uses a locale field to modify some localization parameters such as date/time format, timezone, etc. Yantra does not provide a feature to internationalize the user interfaces. Furthermore, CS2k does not include internationalization or localization capabilities either.

CCMD Approach

CCMD's approach to multi language/globalization is to design the database and applications to support internationalization and localization for user interfaces, templates, pricing, shipping methods, and privacy and local business rules. In one embodiment the site has not tested a multi language version but appropriate product testing can be conducted to test multi language capability. Multi language/globalization can be incorporated into the system upon client request.

The user interfaces for CS2k 220 are designed to support multiple languages. The administration application 310 for each site may only be available in the default language chosen by the client. This means the enhancements required can only be applied to the catalog and campaign sections of the database. There are no parallel sites constructed to handle different language types. Multiple sites can be independent of each other.

The items presented to a customer in Yantra 225 are internationalized. This includes primarily email templates. The CS2k 220 Administration interface, the Customer Service interface and the Supplier Portal are not internationalized but may be available in the default language only.

CCMD uses the CS2k database 2715 to store and maintain dynamic content and uses the rc.xml files for static content on the CS2k 220 side. Each enterprise has its own web root directory in IIS. Dynamic graphics can be stored with other graphics in the web root directory.

Note that even though all of the content on the site can be displayed in multiple languages, the site itself is only developed in one language. Thus, developers do not need to be multi-lingual to create a multi-lingual site. However, it is strongly recommended that multilingual sites be developed with local resources to accommodate local culture/custom requirements as well as language translations.

In one embodiment, the CCMD multi-lingual effort provides only a second language. CCMD does not actually translate text but provides different text simply to verify that the appropriate text has been selected. CCMD cannot develop an actual dual-language site as a final product, however, CCMD has the capability to support multiple languages.

Multi Language Considerations

Commerce Server2000™ Platform

Building an international site on the CS2k 220 platform can be implemented if languages included are of the same character set. For example, if all languages use the same Western-European character set (i.e. a site targeted for US/European-only markets except Greece), implementation is clear. However, when another character set or a double-byte language (Unicode) is introduced, certain limitations may arise.

In one embodiment, CS2k 220 and underlying product/technology do not fully support Unicode. CS2k 220 relies on IIS/ASP, which have certain limitations supporting languages with a different character set. The CS2k 220 COM+ components do not support languages outside the Operating System's (OS) default ANSI code page. In addition, CCMD uses the rc.xml file from CS2k 220 to store literals and error messages. The XML file is ANSI compatible and does not support Unicode. CCMD does not support Unicode but does support the Western European character set, which will extend support to Latin languages such as Spanish, Italian, etc. Those skilled in the art will recognize that Unicode support, though it may require significant alternative architectural design, can be developed if required.

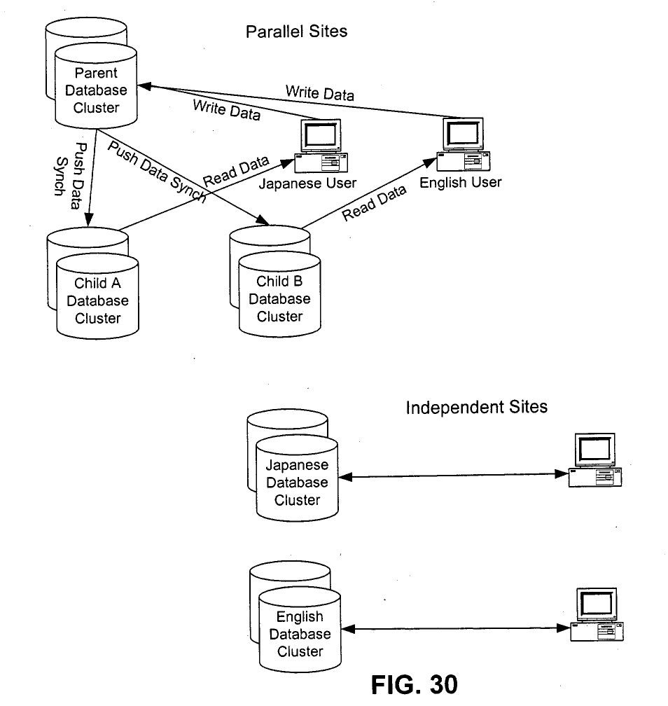

CCMD implements parallel sites versus independent sites for any languages supported by the Western European character set. FIG. 30 illustrates the differences between parallel sites versus independent sites.

When CS2k 220 delivers a Unicode-compatible version, CCMD may host parallel sites versus independent sites depending on the existing infrastructure and the client's preferred architecture (does the client want a hosted or non-hosted site). Note that in this embodiment, Yantra supports the Western European character set, but not the Unicode version.

Unicode Considerations

In the beginning, Unicode was a simple, fixed-width 16-bit encoding. Under its initial design principles, there was enough room in 16 bits for all modern writing systems. But over the course of Unicode's growth and development, those principles had to give way. As a result of these requirements, there are now three different forms of Unicode: UTF-8, UTF-16, and UTF-32.

Both UTF-8 and UTF-16 are substantially more compact in size than UTF-32, when averaging over the world's text in computers. UTF-8 is currently more compact than UTF-16 on average, although it is not particularly suited for East-Asian text because it occupies about 3 bytes of storage per code point. UTF-8 will probably end up as about the same as UTF-16 over time, and may end up being less compact on average as computers continue to make inroads into East and South Asia. Both UTF-8 and UTF-16 offer substantial advantages over UTF-32 in terms of storage requirements.

Character mapping, iteration, and indexing are very fast with UTF-32. A few extra machine instructions are necessary for UTF-16; UTF-8 is a bit more cumbersome. Conversion between different UTFs is very fast.

Microsoft® SQL Server 2000™ can store UTF-8 data. Earlier versions of SQL Server use a different type of Unicode encoding called UCS-2. If a client employs an older version of SQL Server, an additional component may be needed to convert UCS-2 data to UTF-8 so it is compatible with SQL Server 2000.

Using the CS2k 220 MessageManager to control static content (see below) restricts the number of character sets that can be used (rc.xml is ASCII) so the standard Western European settings are sufficient.

Yantra 225

Yantra 225 includes multi language capability for some localization. The locale can be used to determine date format, date/time format, time zone, currency, language, dimension UOM, volume UOM, weight UOM. The locale can be defined at the enterprise level and at the ship node level. However, it is not defined at the customer level or order level. Therefore the user's preferred language on the CS2k 220 side may not correspond to the language set for the enterprise/ship node. Moreover, locale is not included in the static set of fields that can be used to trigger actions (such as using a specific email template) in Yantra 225. To get around this, CS2k 220 passes the language code into the Order Type field in Yantra's 225 CreateOrder API. Yantra 225 interrogates the Order Type field to determine which language-specific email template to use. Yantra 225 does not provide a multi language user interface for the Platform, Portal, or Configurator.

The only language that is available in the current version of Yantra 225 is English. Multiple languages may be available in future versions of Yantra 225. CCMD can incorporate the new version of Yantra 225 having multiple languages in a future embodiment.

Administration Application 310

CCMD contains an administration application 310 to allow user to create and maintain catalogs and campaigns at the enterprise level. (the BizDesk Application cannot be used because the security architecture allows all users to see data from other enterprises). The CCMD administration application 310 is available to the system administration user in a single language only. This language is defined by the enterprise's default language code. This value is stored in the globalACA configuration file. In addition, field formats such as date/time, currency, and units of measure can be stored and displayed in a single format. This format can be defined by the format appropriate for the enterprise's default country code. This value is also stored in the globalACA configuration file. Production environment administration 215 is available only in English-US as CS2k 220 is not multi-language capable.

Static Versus Dynamic Data

The task of internationalization requires classification of language-dependent site content. The following classifications are used:

| | |
|---|---|
| Dynamic | Includes descriptions and images for products, ads, discounts, and |
| Content: | promotions. |
| Static | Includes menu text, site terms, profile attributes, product attributes, error |
| Content: | messages, shipping methods, form field validation messages, static |
| | content (HTML), button images, navigational aids, and logos. |

Dynamic Content

Dynamic content changes based on timeframes, user profiles, campaigns, etc., thus it is treated differently than static content, which remains relatively constant through the life of the site. The CCMD maintains dynamic content in the Product Catalogs (names, descriptions, etc).

Product Catalogs

In one embodiment each CCMD catalog contains the translated text for all supported languages. This can be done by extending the catalog schema to contain language-specific description properties. For example, description would become description_en, description_fr, description_es for English, French, and Spanish descriptions respectively. The advantage to this approach is that there is only one product catalog for all of the languages supported—data is somewhat normalized and there is no need to keep multiple product catalogs synchronized. Furthermore, when the user switches languages, their catalog (and catalog set) does not need to change. Full-text searching of a catalog is much more inefficient since all languages are encompassed in a single full-text search catalog.

In another embodiment of the CCMD, separate full-text search catalogs can be created for each language for every product catalog. In this embodiment, the site code can be modified to select the appropriate full-text search catalog for the currently selected language. Additional changes may need to be made with regard to searching by product categories. Categories that are only stored in one language may need to be displayed in the appropriate language, but search in the default language. For categories stored in multiple languages, the product hierarchy can be overly complex. In one embodiment, the products offered in all languages are the same.

In another embodiment of the CCMD, the existing catalog schema can be used to create separate catalogs for each supported language, thus providing a separate version of a product catalog for each language supported. This is advantageous since the user only searches relevant data (data for their language) and no additionally full-text search catalogs need be created—each product catalog will have their own. In addition, language-specific catalogs may now contain different products. Note that in this embodiment, the data is not normalized and the language-specific catalogs may need to be synchronized. In addition, code may need to be developed to change the user's catalogs (or catalog set) when the language is changed.

Multi-Language and Language Variant Support

The staging environment 1665 has an Item master table 2730 to control all items available on the site. All language specific versions of a product are stored as distinct rows within the Item master table 2730. All items are listed as variants under a parent product within each catalog. The parent products contain the text that is displayed on the CCMD site. Each language version of a parent product is stored as a distinct row in the Item master table 2730. This results in multiple parents for each item (one for each language option). The language, where applicable, is stored as an attribute of an item.

The parent product schema is in English with specific attributes translated into other languages. The following may be required in other languages:

Part_Name

Part_Desc

Part_Short_Desc

Part_Price

Catalog_Name

Category_Name

Shopping Basket

When a user switches languages (via the change language link), the user may have to re-enter through the catalog of their language choice. If the user has already placed items in their shopping cart, the items are maintained but not automatically switched to the new language choice. For example, if the product is added to the shopping cart from an English catalog, the description remains in English even if the user switched languages to French. Due to CS2k 220 limitations (CS2k 220 does not support multi-currency) all prices may need to be in the default price, which is based on the Enterprise's default country code set in the GlobalASA.

Catalog Sets

Separate catalog sets can be created for the different languages required. The CCMD administration application 310 is used to assign the appropriate language-specific catalogs to users.

Catalog Search

The existing search function from CS2k 220 is utilized. Searches occur within a catalog or set of catalogs that are grouped by language.

Catalog Naming Convention

In the CCMD, dynamic text occurs in the Product Catalogs (names, descriptions, etc). Following is the catalog naming format:

CatalogXXXXX_CatalogProducts where XXXXX represents the catalog name. Language is controlled with the locale of the catalog (eg. 1033=US English). All catalog names contain no spaces or punctuation characters. Each catalog has a display name used to represent that catalog on the web interfaces. The display name is stored in a table that is called to resolve the catalog that is being requested. Since each catalog is language specific, the display name is stored in the correct language.

Dynamic Graphics

In addition to text, graphics can also be internationalized. In the Solution Site, two types of graphics have internationalization potential: product images and campaign images. The images themselves are stored on the IIS web server within the enterprise's web root directory. The links to the appropriate image can be stored in the CS2k database 2715.

Product Images

By creating language-specific catalogs for each product catalog, it is a simple matter to just replace the image links with language-specific image links in the catalog database. Whether language specific images are required is determined on a client by client basis.

Campaign Images

Language can also play a role in campaign images. Advertisement images frequently contain language and even cultural references. Therefore, it is important to create campaigns targeted at specific language speakers. This is done by targeting the user's current catalog set (which is language specific). Thus, when an English User switches languages and becomes a Spanish User, the advertisements seen switch from the English language to Spanish language advertisements.

Country Names

Country names are needed for address display and for display on the splash page. In one embodiment, the country name can be displayed in the version used in the user's default country (e.g. Americans refer to Spain as Spain but Spainards refer to their country as Espana). In another embodiment, the country name can be displayed in the version specified by the country. For examples, Americans (and all users) will see Spain as España.

The language codes are stored in an ISO codes table that also contains two digit country and region codes. The ISO codes table contains a description for all codes. The description is stored in the default language of that country/region. For example, the description for ES would be España and not Spain.

Static Content

Static content does not change on the site, until a new version of the site is released. Examples of static text might be: days of the week, months of the year, error messages, site terms, product attributes, etc. The main sources for internationalization of static content are:

Rc.xml—The Rc.xml file holds web text (page titles and headers), error messages, product properties, shipping methods and site terms.

Site Graphics, Language Specific Pages, Client Side Validation—The site navigation bar and menu bar graphics make up the GUI interface of the site, while the ad and campaign graphics are dynamic and controlled by the business user. Text in graphics should be kept to a minimum in a multi-lingual site.

Shipping/Payment Methods—CS2k 220 provides database tables for shipping/payment information and APIs to access/update the information. While considered as static data, this information can be stored in the database since CCMD uses CS2k 220 provided functionality.

Literals

Literals include descriptive text that is static in nature. Some examples include labels for input text fields on a form page (i.e. “Name” and “Address”), directional text (i.e. “Select a Size”), and informational text (i.e. “Sorry this product is out of stock.”). Language variations of Literals can be stored in the rc.xml files.

Product Attributes

Product Attributes are relatively static, unless a new product type is introduced. If unified product taxonomies are used, then product attributes truly remain static. If non-uniform taxonomy is used, product attributes are expected to vary from one catalog to another. However, all product attributes are stored in the default language. Thus, if there is a Hardware catalog for each language (CatalogHardware_EN, CatalogHardware_ES, CatalogHardware_FR, and CatalogHardware_DE), the product attributes (schema) for these catalogs are all stored in the default language.

The values of the attributes for a specific product are language-dependent. For example, all hardware products have a Description attribute, but the value of the Description for a product is language-specific. The value of the Description attribute is considered dynamic and is stored in the CS2k database 2715. The text for “Description” is considered static and the default language is stored in the CS2k database 2715. The language variations for static variables are stored in the rc.xml files. This type of text is commonly referred to as literals.

Shipping Methods

The solution sites simply display Shipping Method names from the database. Language variations of the shipping method name and descriptions are all stored on the Shipping Methods table located in the CS2k database 2715. The developers can use the 2-character ISO language code to query the correct language version of the shipping method and description.

Payment Methods

Payment methods are stored in a lookup table within the CS2k database 2715. One row for each payment type in each language is stored. When the application requests a list of payment methods the language variable is required.

Client Side Validation Error Messages

All client-side validation code is stored in a single file, injValidation.js. Some validation procedures that may remain the same regardless of country (example: check if whole number, check if field populated, etc.). A single procedure exists for those cases. For validation procedures that differ based on country (example: date, phone number), the procedures are differentiated by its name [example: IsValidDateUS(United States), and IsValidDateES (Spain)]. Calling the correct validation code from the ASP page entails affixing the Enterprise's default country code value to the end of the validation procedure (“IsValidDate” & Language).

Client-side validation error messages are always returned with the ASP page, but they may be hidden when the page first loads. The error messages are stored in the rc.xml file. When the user submits the information (clicks on the “Submit” button), all the necessary validation will take place. For each validation failure, the corresponding error message(s) are then made visible to the user. The CS2k 220 team will determine where to display the error information on the page. In addition, when a user neglects to enter data into a required field and, instead, moves to the next field, the require field's text box is highlighted in a different color as a means to notify the user of its required status.

Pipeline & 3rd Party Component Error Messages

Commerce Server Pipeline components generate error messages. Translations for all of these messages are available out-of-the-box in rc.xml. However, when using additional third party pipeline components, additional rc.xml entries or possibly even code can be created to handle these new error messages. The technique is the same as with other messages. A language-independent message key is used to reference the language-specific text in MessageManager.

For example, the CyberSource pipeline component for credit card payment and authorization services writes out its error messages to the OrderForm. But, code can be written to handle the messages and translate them into specific languages.

To obtain language specific error messages from the rc.xml using the MessageManager, the following code can be used:

Err.Description=mscsMessageManager.GetMessage(“L_CCValidation_Failed_ID”, pl_sLanguage)

The MessageManager can be used to obtain the language specific error message from the rc.xml. As one example, note the error message translation group at the bottom of the screen capture provided above. To call the error message in the appropriate language, the following code can be used:

Err.Description=mscsMessageManager.GetMessage(“L_Error_Existing_ID”, pl_sLanguage)

The content of the information error.asp page may vary depending on the circumstance. Regardless, the information is provided in the user's selected language. If the error is a runtime type, then the following information is provided:

Page the error occurred

Generic apology message

Link back to the home page

Email address of the web master.

Otherwise, information to be provided by the error.asp page contains the following:

Page the error occurred

Description of the error

Link back to the home page

Email address of the web master.

Spacing

An extra 30% in spacing can be added to all English words to account for the word length of other languages. A user interface development team can manage the spacing requirements. However, the percentage of spacing added may change.

Navigation Images

Globalized, navigational images are non-product specific, non-assortment assigned, look and feel GIF and jpeg files that are language or country dependent. An example is an image associated with the home page such as the country flag in the home page. Some look and feel images are ‘go’, ‘log out’, and ‘sign-on’ buttons translated into different languages.

These multi-lingual navigational images are stored in language specific folders on the web servers under each enterprise's specific web root directory. All non-language specific images are stored in the enterprise specific folder.

Field Formats

Field Formats such as date, time, number, currency, address, and units of measure (UOM) can be internationalized and displayed based on a user's locale. In one embodiment, the CCMD can use Visual Basic which has functions that automatically perform date, time, and currency formatting based on the user's locale. There are variations that need to be considered in the application design, such as currency symbol placement, units of measure (Metric vs. Imperial), and the decimal and thousands separator. Some field formats can be handled in the user interface design, such as the field length of the address and telephone number fields.

CCMD stores the enterprise's default country code in the globalASA configuration file. All date/time formats, units of measure, currencies, numbers, and addresses can be displayed to the user in the format that is acceptable by the country identified in the default country code for both the administration application 310 and StoreFront application 305 and the Yantra 225 portals (although the Yantra 225 portal can read the country code value from the locale variable stored in the Yantra 225 database that is specific to an enterprise). Thus, an enterprise located in the US may always store and display currency in the USD format ($nn.nn), date/time in the format mm/dd/yy, and units of measure in the Imperial format.

Translations of these formats into other formats defined by the user's home country can be delivered in release 2 or in a specific client release. Ideas for how the translations may occur are provided below.

Date/Time Formats

The future approach for translating date/time formats can be to store the date/time field in the format of the users operating system 415, but translate the date/time value with a custom common object. The date can be stored in SQL Server in a universal date format and sent to the ASP page as a date variant. The page interprets the variant as a date and can call the common object to translate the date format based on the value in the country code setting in the user profile.

Unit of Measure

The approach for Unit of measure (UOM) is to store the UOM in the format defined by the enterprise's default country code, but translate the UOM for user display with a custom common object.

Currency

The display currency can depend on the user's country, the country of the biling address, or the country of the shipping address. Furthermore, the products can be locally priced based on their competitive value in each country's market, or it can be universally priced and then converted to different currencies. In the former, individual priced lists for each country are set, whereas in the latter case, one price light is set, and a conversion method is used to convert and display the price in the right currency.

In on embodiment, CCMD can store and display all currency in the format defined by the enterprise's default country code. This value is consistent across the StoreFront 305, admin, and Yantra 225 applications. The currency for CCMD can be revised based on client requirements once a client is identified.

Number

Numbers are stored and displayed in the format defined by the enterprise's default country code.

Address

Addresses are initially be in the US format until a client requirement identifies a need for multiple address formats.

Language Specific Pages

Some web pages on the CCMD site, such as frequently asked questions (FAQs) and Company Information, may be language specific and enterprise specific. These pages can have a unique and separate ASP and possibly page controller for display. The pages are typically text heavy or are specific to a country, language, or enterprise. CCMD can store the static text in the rc.xml file. CS2k 220 can use the MessageManager object to get the text strings and write them to the browser 1673.

Language Choice

In one embodiment, a multi-lingual site can be simulated by allowing the user to choose a language upon entering the site, and then sending them to the locale-specific site (a separate site). This simulates a multi-lingual site, but does not allow the user to dynamically choose a language at any time. In another embodiment, a true multi-lingual site can be used which allows a user to switch dynamically from one language to another at any time. To achieve this the site offers users a choice of language on the first visit. The choice is stored as a property in the user profile so that the appropriate language appears immediately whenever the user logs in to the site.

Changing Languages

Multi-lingual sites enable the user to change from one language to another. Four ways to encode language context are:

1. Use a client-site cookie to store the active language choice. A language code (en, es, fr, de) can be stored in the cookie and this cookie can be read on every page that displays language-dependent strings. The persistent cookie can have a future expiration date so that the site is always aware of a user's language (assuming that the user agrees to make the cookie persistent). This technique works best in situations where you can control the acceptance of cookies.

2. Encode the language code in the URL. The language code can be embedded in the URL, similar to how the Solution Sites generate the session ID ticket.

3. Store the language preference in the user profile. The language preference can be stored in the user profile. This requires that a language property be added to the user profile. The property is updated if a user changes languages. This is a cost-effective method of storing language preferences, since the only performance cost involved is retrieving and updating the profile.

4. Use pre-generated pages. If a site contains mostly static HTML pages, using pre-generated pages is a good option for encoding languages on the site. To pre-generate pages in all the languages, pages can be put in a source directory to mark all strings that can be pre-generated with delimiters in your ASP code.

The CCMD utilizes a combination of approaches. When a user enters the site, a splash page with a list of language choices appears. Once the user makes a choice, the user is directed to that languages home page. A persistent cookie is set with the language choice. While the user remains anonymous, the language choice is retrieved from the cookie. After the user logs into the site, the language preference in the User Profile is used.

User Profile

For most sites, the user can choose a language and save it in the user's profile. The next time the user logs on from any location, the site will automatically switch to the user's preferred language. To track the language choice of the user, a custom attribute, “Language,” is added to the user profile. The language property of the user profile, which is initialized when the user chooses a language, is accessed through the AuthManager in CS2k 220. Each page retrieves the language preference from the AuthManager and then uses that value to make selections for web text, site GIFs, catalog, articles and campaigns/ads.

An anonymous user coming to the CCMD site for the first time chooses a language from the splash page. A Guest User Profile is automatically assigned to an anonymous user. The Guest User Profile's Language attribute is based on the language contained in the cookie generated by the splash page. Once a user has registered, they may also select a new language by editing their User Profile and changing their Language attribute. A registered user has an Auth User Profile instead of a Guest User Profile, but both profiles behave the same with regard to language selection.

Change Language Link

In addition to letting the user choose a language that is saved in their profile, a user can change their language of choice while navigating the site. A “change language” link is placed on each page where it is required. If the user is logged in, they are directed to the user profile update screen. For guest users the link directs them back to the splash page to choose a different language. The user is re-directed because each catalog contains items for a single language and the user cannot automatically switch to another language while viewing a catalog (same product in a different language will be in a different catalog). The persistent cookie is updated to reflect the new language preference. The next time the user logs on from any location, the site will automatically switch to the last language that was chosen.

Language Selection Process Diagram

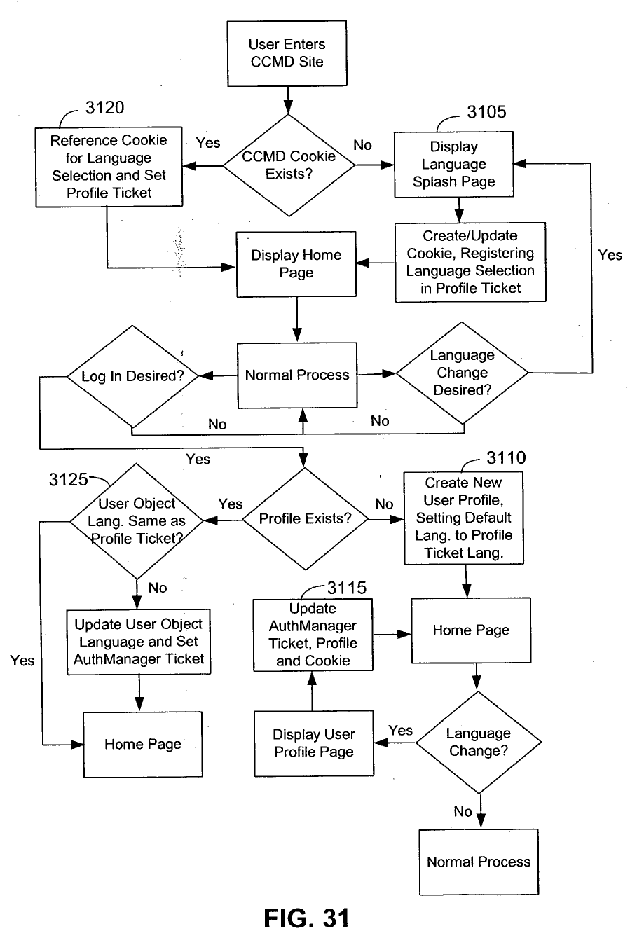

FIG. 31 provides a process flow diagram of the language selection process. The CCMD approach to dynamically set the display language is two-pronged. First, on the first visit, a language splash page is displayed and the user is asked to select a language at step 3105. The choice is stored in a persistent cookie on the user's computer so that the appropriate language appears immediately whenever the user revisits the site. In one embodiment, the default language is English.

Second, when a user chooses to create a profile at step 3110, the language preference can be stored in the profile. This requires adding a language property to the user profile, or AuthManager ticket. This property should be updated whenever the user changes languages as shown in step 3115.

Tracking the user's language choice is done by detecting the language selection from either the cookie in step 3120 or user object in step 3125 and then storing it in the field, pl_sLanguage (The process of populating the pl_sLanguage is provided in an include statement which is supplied by the application architecture team). Accordingly, the web pages display the appropriate language for web texts, site images, catalogs, articles and campaigns/ads. In the case where both a cookie and a user profile exist and the user is logged in, the language stored in the user profile overrides the cookie's language value. However, developers should force an update to the persistent cookie whenever a user changes their preferred language. Provided below in the table are sample ASPs that developers can examine to understand how the pl_sLanguage is set and referenced. The ASP samples are stored in the VSS path, “$/Documentation/Common/Internationalization.” Note that sLanguage is used in place of pl_sLanguage in the documentation.

| | |
|---|---|
| language.asp | Sets the pl_sLanguage to the user's language preference. |
| setupenv.asp | Sets up environment, including language, prior to displaying the web |
| | application's main ASP page. |
| Welcome.asp | Sample of ASP page referring to the pl_sLanguage field to determine |
| | which language to display in the Welcome page's text fields. |

### Sample Code Documents

Architecture Considerations

Enterprise Settings

Since multiple enterprises may be resident in one server environment there may be settings for each specific enterprise. A default language code can be assigned to each enterprise to direct the display language of the administrative functions. This default language code can be stored in the Global ASA configuration file along with the default country code. For SQL Server, the language character set is established upon install within the Advanced Options tab. This parameter cannot be changed once it is set.

For Microsoft® Advanced Server, the language character set and region (locale) are established during install. Unicode character sets are available but additional CDs are required to install these character sets. The locale and language information can be accessed from the Control Panel/Regional Options selection. The formats for number, currency, time, date, and keyboard input locale can also be changed from the Control Panel/Regional Options selection. Since Yantra 225 does not have a parameter for language at this time, the locale variable can be set at both the enterprise and ship node level using the Configurator application.

User Settings

When a user list is sourced from inside an existing client system the default language can be designated in one of two ways. If the source system contains language preference, then the language preference is passed to the user object table. If there is no language preference, then the default language of the site is passed to the user object table. When users are external to the clients existing system, then the language preference chosen on profile setup is written to the user object table.

Product Detail Sources

If a client has existing Digital Asset Management (DAM) or content management systems then the foreign language versions of their item data can be used. For items that lack a unique identifier for each language type (shirts, hats, etc), the language set determines which catalog name is passed through the CS2k 220 API. The sorting of data into language sets can be handled at the BizTalk™ 230 level.

email Architecture

CS2k 220

The email architecture in SMTP works using MessageManager. The text of CS2k 220 email messages (the only one in scope is for letting a user know their password was reset by a CSR), is set in the MessageManager object. This is consistent with CS2k's 220 approach for centralizing all text for a site.

Yantra 225

Email functionality in Yantra 225 is configured in the Communication System Rules. Within this System Rule, the email protocol, email server IP address and the email server listener port are set. For CCMD, the email protocol is SMTP, the email server IP address is the IP address of the Yantra 225 server and the listener port is 23.

Two emails are sent from the Yantra 225 server: an order confirmation email and a shipping confirmation email. These emails are sent once certain actions in the Yantra 225 pipeline have occurred. Custom XSL files have been created to specify the format and text of the email. The location of the XSL files have been specified within the action that sends the email.

rc.xml and Message Manager Implementation

The MessageManager (MM) object is used to store error messages and text strings used on the CCMD site. This object provides a mechanism for separating the symbolic name of the string from the language of the string. Whenever a string is needed, it is retrieved from the MM object with a call, such as:

Stext=mscsMessageManager.GetMessage(“L_FirstName_HTMLText”, pl_sLanguage)

The pl_sLanguage variable is used to determine the language used. In ASP, a case statement should be created to denote the language type based on the language type in the user profile or cookie. Alternatively, the profile or cookie could be read instead of setting this variable.

In the site, the MessageManager object references a single (may be multiple) rc.xml file that can hold multiple languages. During the application initialization, the MM object is loaded with data in the rc.xml file. The rc.xml file defines localizable string constants. Since most strings are in the rc.xml file, translating website strings can be implemented by translating the strings in the rc.xml file and changing the Language attributes in the file to the name of the new language. The rc.xml is cached on the web server and is portable for transition. Each enterprise/site will have it's own rc.xml file that contains all languages required by that enterprise.

The following is an example of an rc.xml file.

<?xml version=“1.0”?>
<MessageManager DefaultLanguage=“EN”>

<Language Name=“EN” Locale=“1033”/>
<Language Name=“ES” Locale=“1034”/>
<Language Name=“FR” Locale=“1036”/>
<Language Name=“DE” Locale=“1031”/>
<Entry Name=“L_Prop_user_title” Type=“General”>

<Value Language=“EN”>Title</Value>
<Value Language=“ES”>Título</Value>
<Value Language=“FR”>Titre</Value>
<Value Language=“DE”>Position</Value>

</Entry>
<Entry Name=“L_Prop_last_name” Type=“General”>

<Value Language=“EN”>Last Name</Value>
<Value Language=“ES”>Apellido</Value>
<Value Language=“FR”>Nom</Value>
<Value Language=“DE”>Nachname </Value>

</Entry>
<Entry Name=“L_Prop_first_name” Type=“General”>

<Value Language=“EN”>First Name</Value>
<Value Language=“ES”>Nombre</Value>
<Value Language=“FR”>Prénom</Value>
<Value Language=“DE”>Vorname</Value>

</Entry>
<Entry Name=“L_Prop_tel_number” Type=“General”>

<Value Language=“EN”>Phone</Value>
<Value Language=“ES”>Telefono</Value>
<Value Language=“FR”>Téléphone</Value>
<Value Language=“DE”>Telefon</Value>

</Entry>
</MessageManager>

### Sample rc.xml Screen Capture

In the CCMD development environment, different versions of rc.xml unavoidably reside in the developers' workstations. It is necessary to ensure that coordination exists among the developers to avoid redundancy and promote efficiency when adding or changing Entry names in the rc.xml file.

Implementation of IIS

There are several static graphics files used to create the menu and navigation bars of the site layout. In addition to these images, a few more appear on various site pages, but are for navigational or orientation purposes. To centralize the location of these images and to allow for ease of retrieval based on the language choice, separate image folder are used to contain the language-specific images. For example, the Spanish-language MenuBar Browse Catalog image can be contained in the folder:/enterpriseA/images/menubar/ES/browse.gif

The following shows the code used to access this image:

RenderImage(GenerateURL(enterprise_cd & “/images/menubar/” & pl_sLanguage &“/browse.gif”)

Each enterprise has its own IIS web root directory. Below is one example of the IIS directory structure.

/InetPub

/EnterpriseAroot

/Store
/Admin
/CSR
/Images

/EN

EnglishImage1.gif
EnglishImage2.gif

/FR

FrenchImage1.gif
FrenchImage2.gif

/Common

/Images
/Include
/Scripts
/Styles

global.asa (enterprise specific configuration file)
default.asp (determines if user has cookie, re-directs to

splash page or home page)

rc.xml (enterprise specific static text file)

/EnterpriseBroot

/Store

/Admin
/CSR
/Images

/EN

EnglishImage1.gif
EnglishImage2.gif

/FR

FrenchImage1.gif
FrenchImage2.gif

/Common

/Images
/Include
/Scripts
/Styles

global.asa (enterprise specific configuration file)
default.asp (determines if user has cookie, re-directs to

splash page or home page)

rc.xml (enterprise specific static text file)

General Internationalization Coding Guidelines

When an a application, several coding practices can make the internationalization process easier. Below are guideline provided by Microsoft® in an online document entitled, “Coding for Internationalization” which can be found at the following URL: http://msdn.microsoft.com/library/default.asp?url=/library/en-us/wcedesgn/htm/globui_{—}6.asp.

Do not hard-code localizable elements.

Hard-coded strings, characters, constants, screen positions, file names, and file paths are difficult to track down and localize. Isolate all localizable items into resource files, and minimize compile dependencies.

Do not make buffers too small to handle localized text.

Buffers that are declared to be the exact size of a word or a sentence may overflow when text is translated. For example, an application declares a 2-byte buffer size for the word “OK.” In Spanish, however, when it refers to the text in an OK button, the same word is translated as “Aceptar,” which would cause your application to overflow.

Do not perform string composition.

For example, translating “wrong file” and “wrong directory” to Italian results in “file errato” and “cartella erratta,” respectively. Performing string composition using the syntax “wrong%s” does not work.

Another potential problem involves declaring a single string and displaying it in a number of different contexts: on a menu, in a dialog box, and perhaps in several messages. The problem with using all-purpose strings is that in European languages, adjectives and some nouns have from 4 to 14 different forms—such as masculine, feminine, and neuter singular, and masculine, feminine, and neuter plural—that must match the nouns they modify. A single string displayed in different contexts is correct in gender and number in some cases but incorrect in others.

One way to ensure that your coding practices work in an international market is to substitute your language strings with a pseudo-language, and then test your code. Any potential problems should surface immediately.

Navigation Framework

Graphics, layout and design for the entire application can be handled using standards and style sheets. This ensures the CCMD, as a whole, is seamless in its look and feel. It also makes the application easy to modify visually per enterprise if necessary.

UI Navigation Options

CCMD Content Types

General Site Information: (Contact Information, Privacy Policy, Security Statement, Logo, Copyright, Sponsors, Other Links)

General Services: (Login/off, Search, Advanced Search, Help, Account, Shopping Basket, Feedback, Administrative Tasks, Customer Service, Part Creation, Part Tracking)

User Specific Information: (Welcome, Favorites, Messages, Campaigns)

Level 1 Navigation: Catalog Information

Level 2 Navigation: Category Information

Level 3 Navigation: Product Information

Modes of Navigation

Tabs

Tabs are becoming more popular in web site design however they can be difficult to code and maintain, and may require image download.

Icons (Images)

Icons or images add to the overall aesthetics of site however all icons need to be downloaded and should be limited if users with slow connections are expected.

Mouse-Over Dropdown Menus

Mouse-over menus allow for added site real estate however can be difficult to code/maintain and may involve image download.

Hyperlinks

Hyperlinks are easy to code and available within HTML, however are not aesthetically pleasing.

Buttons(Images or HTML)

HTML buttons are easy to code and are available within HTML, however tend not to be aesthetically pleasing.

Button images will need to be downloaded.

Tree Structure/Expanding Menu

Allows for a Microsoft® Windows Explorer feel, however can be difficult to code/maintain.

Breadcrumb

Allows for easy site orientation however can be difficult to code/maintain and tend not to be aesthetically pleasing.

Possible Navigation Locations

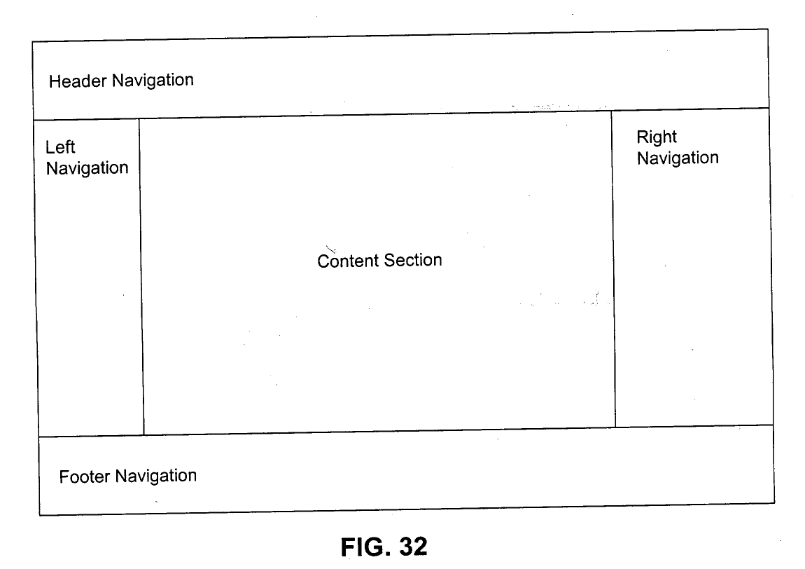

FIG. 32 shows a navagation map having possible navigation locations.

Header

Footer

Left

Right

Content Section

TABLE 3.0

| Location | Mode | Content |
|---|---|---|
| Header | Icons and Hyperlinks | General Services and Site |
| | | Information |
| Footer | Hyperlinks and some Icons | General Services and Site |
| | | Information |
| Left | Hyperlinks(Expanding | Catalog, and Category |
| | Menu), and some Icons | Information |
| Right | Hyperlink and some Icons | User Specific and Pro- |
| | | duct Information |
| Content Section | Icons and Hyperlinks | Product Information |

Description

The Header includes the Logo image that links to the Home page, as well as a menu bar containing a Free Text Search and icon links to the Shopping Basket, Account, Help Desk, Administrator (for authorized Biz Administration users), and Customer Service (for authorized Customer Service users). The Footer contains the Contact information, hyperlinks to Home, Shopping Basket, Account, and Copyright Information, and icon links to Feedback and the Help Desk. The Left navigation area will contain Catalog hyperlinks, which once clicked will display the Catalog page as well as expand the list of Category hyperlinks below the selected catalog hyperlink. The Right navigation area contains the Login and Password boxes, or Logout and Welcome message if the user is logged in, as well as Product Creation and Tracking links if the user is a Content Creator/Approver, Campaign (Discount) information if the user is just a consumer. Feature Product images along with a short description and hyperlinks appear within the Content Section and either link to a full description of the product or to add the product to the shopping cart.

Benefits

The expanded menu easily orients the user to where they are located in the site. The use of icons and expanding menus add to the aesthetics of the site. No additional screen is necessary to login (although we may still have a login screen depending on the multi-enterprise approach). The removal of statically displaying the categories allows for more room on the left navigation bar (eliminates scrolling). The addition of the Right navigation area allows for added functionality such as links specific to the different user types: Content Approver, Content Creator/Owner, Marketing Rep, CSR and Regular User.

Disadvantages

If all the catalog hyperlinks are expanded, scrolling maybe necessary. The user interface appears a little busy and both left and right navigation areas limit screen real estate. The left navigation area requires one to click on the catalog link before viewing the available category links.

Targeted User Group

Medium-to-high power usage.

Interfaces

This section provides a high-level overview of the internal and external interfaces for the CCMD. It does not cover conversion of data and only focuses on interfaces that are executed on a regular basis.

Product Push to CS2k 220

CCMD has built interfaces to support the transfer of product information, meta data, and digital assets from client systems. The BizTalk™ 230 interface for this is called the Staging_Items interface. Typically a Digital asset management system 325 application located at the client facility pushes digital assets, product data, and meta data associated with an asset to the CCMD environment. The digital assets can be pushed directly to the production digital asset repository 1685 server. The meta data and product data can be pushed to BizTalk™ 230 in an XML format and then loaded to the CS2k 220 staging data tables. These additions can be migrated to production during the nightly staging process once the products have been added to a category or catalog.

HR System 350 Push to CS2k 220

The HR system 350 application located at the client facility maintains all the profile information and address for the client employees. The client may provide an XML file of all changed information to the CCMD team. This information is sent to BizTalk™ server 1650, which manages the load to the production environment CS2k database server 1630. This information is not replicated in the staging environment 1665. This interface is called CS2k_EmployeeInfo interface.

ERP System 340 Push to CS2k 220

The ERP systems 340 application located at the client facility maintains all the charge code and purchase order information. The client may provide an XML file of all changed information to the CCMD team. This information can be sent to BizTalk™ server 1650, which manages the load to the production environment CS2k 220 database server. This information is not replicated in the staging environment 1665. This interface is called CS2k_InternalCodes interface.

CS2k 220 Business Object Calls to Yantra 225

CS2k application 220 can call Yantra 225 APIs on a real-time basis to access information such as order history and inventory and to post orders and returns. CS2k 220 can use the Yantra 225 provided eCommerce Adapter APIs for the interface.

Yantra eCommerce Adapter APIs includs the following:

Available To Promise

Inventory Reservation

Inventory Reservation Cancellation

Submit Order—this API is called via BizTalk™ 230 (see below)

Request Order List

Request Order Status

Modify Order

Cancel Order

Create Return—Return functionality is currently not available in the CCMD solution.

Return Status Inquiry

Orders from CS2k 220 to Yantra 225 via BizTalk™ 230

BizTalk™ 230 can be used to marshal orders from CS2k 220 to Yantra 225. The CS2k 220 application sends the order information details to BizTalk™ 230 in the format of an XML document. The user is returned to the CS2k 220 application as soon as BizTalk™ 230 receive the XML document. BizTalk™ 230 can then send the XML order information to Yantra 225. BizTalk™ 230 was chosen for this API because the response time for creating an order in Yantra 225 is longer than desired for an on-line user. The interface is referred to as Yantra_Orders interface in BizTalk™ 230.

Yantra 225 to/from WMS 335

Yantra 225 can exchange information regarding products (items), shipment details, inventory, and orders with Warehouse Management Systems 235 (WMSs). This information can be sent to both systems via BizTalk™ 230. Currently these interfaces are in the XML format. CCMD can use BizTalk™ 230 for any data translations or processing of additional business logic that may be necessary for a specific client or WMS 335. The interfaces are called Yantra_Inventory, Yantra_ShipDetails, WMS_Items, and WMS_orders interfaces.

Cybersource

CS2k 220 can make an http call to Cybersouce for credit card authorizations, tax calculations, and fraud check. Cybersouce provides the http response and response information. Yantra 225 may also interface with Cybersouce for settlement. This interface is still under development.

Settlement Information to ERP System 340

Settlement information can be sent to a client's ERP system 340 or other financial system on a per client basis. This interface can be built once a client is established. The interface is referred to as the Finance_Settlement interface.

Batch Architecture

CCMD can use the Microsoft® scheduling tool, Task Scheduler, which is included in the Microsoft® Advanced Server 2000™ install for scheduling batch jobs that need to run on a particular server. BizTalk™ 230 can also be used to monitor directories and kick off jobs based on a file(s) being placed in the directories.

Jobs can be manually entered into the scheduler on each particular machine. Scripts can be created to handle dependencies between jobs. Please see the Batch Sheduler Architecture document for the batch jobs and the flow.

A future enhancement to batch processing would be to implement ACA's 210 batch services. This service provides functionality for restart/recovery, enhanced support for dependencies, and integration with ACA's 210 error handling and logging.

Security Architecture

The security architecture includes authentication and authorization at the application level, as well as the security parameters and configuration of the hardware, operating system 415, and networking components. This section focuses on the authentication and authorization at the application level.

Authentication

In one embodiment, a method for authentication is to require a unique user id, password, and enterprise id for the system. Once the users have successfully logged on the user id, an enterprise id is stored in a persistent cookie on the users system. Whenever the user returns to the site the user id and enterprise id can be obtained from the cookie. At this point, the user only has to enter their password. For users that do not accept cookies, this information can be re-entered each time the user logs into the site. Regardless of the type of user (StoreFront application 305 user, Administration User, Customer Service), the user has only one point where they have to enter user id/password information.

In another embodiment, warehouses 1670 that choose to use Yantra Pure eCommerce Portal 230 over WMS 335 integration with Yantra 225 can also use a unique id and password to authenticate to Yantra Pure eCommerce Portal 230 application.

Authorization

StoreFront application 305 and the administration application 310 authorization is different from Yantra 225 authorization. StoreFront application 305 and the administration application 310 authorization is based on the enterprise id and on information in the user's profile.

Yantra 225 authorization is based on information entered about the specific users. This is internal to Yantra 225 and can be defined by the CCMD team. Yantra 225 inherently separates data based on enterprise.

IIS File Structure

Two files that are used for support of the security architecture are ACAConfig.xml and global.ASA which are provided as part of the Avanade Connected Architecture.

Integration Points

Profile Data

After a new enterprise purchases the CCMD solution, an initial data conversion of the new interprises' user profile data from their existing data source to our CS2k 220 profile tables should be performed. There should be ongoing “pushes” of this data from their data source (safe source) to us via a BizTalk™/CS2k 220 interface between the enterprise's HR tables to our CS2k 220 user profile tables. Depending on the enterprise, it may be possible to directly integrate the CS2k 220 Profile Service with their data source (aggregate profile data across multiple data source).

Charge Codes

After a new enterprise purchases the CCMD solution, an initial data conversion of their charge codes from their existing data source (assuming the enterprise wishes to use charge codes as a viable payment option) should be performed. There should be ongoing “pushes” of this data from their safe source to CCMD via a BizTalk™/CS2k 220 interface between the enterprise's finance tables to our custom charge code table in CS2k 220.

Product Data

After a new enterprise purchases the CCMD solution, an initial data conversion of their product data from their existing product data sources should be performed. Going forward, as products are added to the product catalog through the administration application 310, part of the submission process includes the generation of the product information as XML that is sent to a BizTalk™ Message Queue for pickup on a scheduled basis. The product XML is mapped to what is required by Yantra 225 and the WMS 335 and then sent to those systems for upload.

Digital Asset Repository 1685

After a new enterprise purchases the CCMD solution, an initial data conversion of their digital asset metadata and physical files from their Digital Asset Repository 1685 should be performed. As digital assets are added to their Digital Asset Repository 1685, there may be either a triggered push of this to CCMD via a BizTalk™/CS2k 220 interface that maps the enterprise's digital asset metadata to the CS2k 220 product tables and the actual digital asset file to the CCMD DAM repository.

Inventory

CS2k 220 integrates with Yantra 225 via existing APIs to check available inventory for a product and to create a “soft reserve” of the inventory when a product is placed in the shopping basket.

Orders

CS2k 220 integrates with Yantra 225 to submit orders. Yantra 225 is the Order Master in the CCMD. When an order is completed in CS2k 220, the order is generated as XML and sent to a BizTalk™ Message Queue for pickup on a scheduled basis. BizTalk™ 230 uses the Yantra 225 createOrder( ) API to submit these completed orders to Yantra 225.

Digital Asset Management/Delivery Approach

The CCMD solution is designed and built to integrate with enterprises with existing digital asset management solutions, as well as those that do not. In either case, it is preferable that the CCMD receives the digital asset and the metadata as one transaction so that both are available on the site.

Integration with Existing Digital Asset Management Solutions

Design Considerations

Digital Asset Storage

A repository of “finished” digital assets is maintained within CCMD. CCMD deals with both file transferring and storage/capacity. CCMD does not handle versioning of these files and only keeps the most current copy of each asset.

Push vs. Pull (Metadata and Assets)

If a company has an existing DAM-solution, it may be necessary for CCMD to have both the digital asset and metadata of a “finished” good within the CCMD environment. The company pushes the digital asset and metadata of a “finished” good to the CCMD environment.

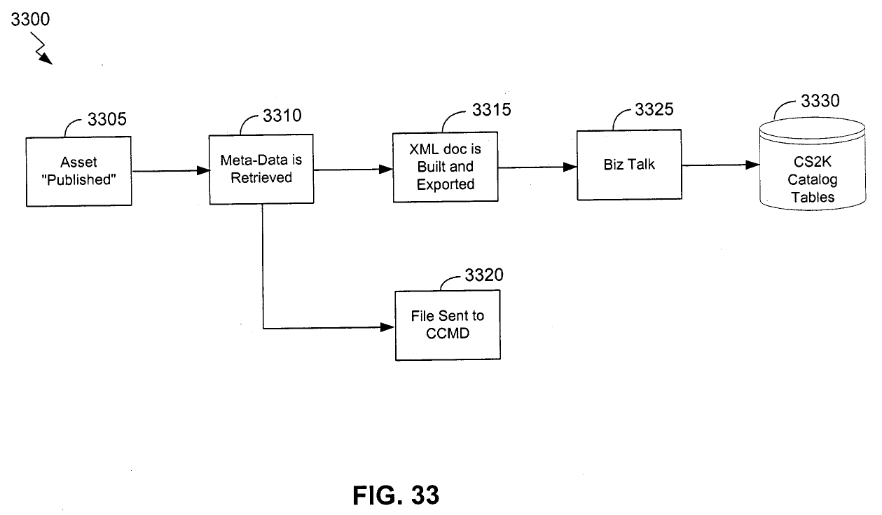

FIG. 33 shows a process flow diagram for the DAM/CS2k 220 interface. A “publishing” interface manages the export of finished assets from Bulldog to CS2k 220 in step 3305. This interface is an extension to the existing Bulldog™ application and leverages Bulldog APIs to pull together the appropriate metadata in step 3310. Bulldog is modified to be aware of the existing product catalogs and categories within CS2k 220. The product creators will use the CCMD to assign a category and catalog to their newly imported DAM asset. Other embodiments will enable Bulldog to build its UDF (user defined fields) from the CS2k 220 solution via a data import. Then, Bulldog users can categorize these assets correctly upon publishing.

The XML document is delivered at the same time as the digital asset in steps 3315 and 3320. If the XML document (containing product metadata) becomes “live” on the site, an associated digital asset is ready for purchase. BizTalk™ 230 is used to ensure successful transmission in step 3325.

The BizTalk™ 230 interface is designed and built to take the DAM data into CS2k staging environment 1665 (catalog tables) and the digital asset file to the appropriate CCMD file server in step 3330. File and document transmission frequency is also determined.

CCMD Digital Asset Management Solution

Design Considerations

Digital Asset Storage

CCMD is the company's Digital Asset Repository 1685. CCMD deals with both file transferring and storage/capacity. CCMD does not handle versioning of these files and only keeps the most current copy of each asset.

Submitting Digital Assets

The Product Creation screens in the CCMD solution provide the capability for someone to “upload” a thumbnail image and digital asset into the CCMD Digital Asset Repository 1685. The metadata about the product is submitted via a form on the Part Creation screen.

Assets Delivered in Digital & Physical Format

Products may exist which can be fulfilled either digitally or physically. The CCMD solution addresses this from both a product creation and order fulfillment process.

Product Creation

The Product Creation screen allows the creator to specify the format of the item (digital, physical, CD-ROM, printed, etc.). Products that come in multiple formats are treated as product variants. Product variants can have a unique SKU (appended to the parent sku) and different price and fulfillment rules. For any product that is “digital”, CCMD provides the capability to upload the file and specify a download link path. The possible formats are pre-defined by CCMD. The possible formats can be: digital audio, digital video, or physical (any printable media, VHS tapes, DVD, CD-ROM etc.) The system is designed such that new formats are easily added.

Order Fulfillment

From a StoreFront 305 perspective, the product search functionality only returns one match (the parent product). The Product Detail screen displays the available mediums of the asset (digital, physical or CD-ROM) if the product has variants. The associated price of those variants is also displayed. If a product is free and available in “digital” format, a link is provided to download the asset. However, if a product has an associated price, the user designates what format they want to order, along with their quantity. It is possible that a user may wish to purchase quantities of both the digital and physical version. The CCMD solution supports that scenario.

When the order is submitted from CS2k 220 to Yantra 225, the format of the item is passed along so Yantra 225 knows how to handle the order. Yantra 225 can differentiate the product format using the “product class” attribute.

Although particular embodiments have been described in detail, various modifications to the embodiments described herein may be made without departing from the spirit and scope of the present invention, thus, the invention is limited only by the appended claims.

In the claim:

1. A computer-based corporate content management and delivery (CCMD) system for efficient storage and management of corporate content, and delivery of such content in response to orders for such content, the CCMD comprising:
a first module configured to create and/or acquire digital content for repurposing in a digital and/or a physical format;
a second module electronically coupled to the first module and configured to manage data necessary to process and execute orders for such corporate content in one of said digital format and said physical format; and
a third module configured to integrate operations of said first module and said second module and to coordinate these operations with internal and/or external third party content/product providers and customers.

2. The computer-based corporate content management and delivery (CCMD) system of claim 1 wherein the digital content is uploaded into the CCMD system by content creators/owners and said internal and/or external third party content/product providers.

3. The computer-based corporate content management and delivery (CCMD) system of claim 1 wherein the first module comprises:
a first sub-module comprising a content storefront and administration portal and configured to receive and coordinate orders for digital and/or physical content; and
a second sub-module electronically coupled to the first sub-module and configured to produce actions to deliver said digital content in a digital format or a physical format or in both digital and physical format.

4. The computer-based corporate content management and delivery (CCMD) system of claim 3, wherein said second sub-module delivers said digital content through a set of pre-configured third party fulfillment providers.

5. The computer-based corporate content management and delivery (CCMD) system of claim 1 wherein the CCMD system comprises:
hardware and software modules configured to provide;
a production mode configured to receive and process orders for digital and/or physical content and cause actions necessary to deliver such digital and/or physical content as the orders require; and
an administration mode wherein digital content products are created, modified, priced and assigned to catalogues and categories, and wherein campaigns such as advertising and marketing campaigns can be created and modified and related to other relevant campaign materials, and wherein the catalogues and categories are created and modified, and wherein profiles of users and customers are created and maintained.

6. The computer-based corporate content management and delivery (CCMD) system of claim 3 wherein the storefront comprises additional sub-modules configured to
receive customer orders and reserve inventory upon checkout by a customer;
select available shipping methods and payment methods for the order;
maintain multiple ship/bill to addresses for a customer;
integrate the order processing with a credit card electronic payment processing system for tax calculation, fraud detection, credit card authorization and settlement and internal billing using charge codes;
correlate data with financial and third party warehouse management systems; and
provide status and tracking information to customers and CCMD system administrators for all the orders.

7. The computer-based corporate content management and delivery (CCMD) system of claim 1 wherein the first module and the second module are designed based on standard internationalization rules so that localization of digital content and currency can be provided.

8. The computer-based corporate content management and delivery (CCMD) system of claim 1 comprising mechanisms to support multiple enterprises, multiple departments within each said enterprise, and their respective digital content, orders and related files.

9. The computer-based corporate content management and delivery (CCMD) system of claim 8 comprising a security architecture configured to restrict access to data of each of the multiple enterprises and the multiple departments within each said enterprise to authorized customers and users.

10. The computer-based corporate content management and delivery (CCMD) system of claim 1 wherein the CCMD is integrated with the external third party content providers and fulfillment providers via XML protocols.

11. The computer-based corporate content management and delivery (CCMD) system of claim 1 wherein the second module communicates with the third module via XML protocols.

12. The computer-based corporate content management and delivery (CCMD) system of claim 1, wherein said physical formats comprise brochures, training materials, advertisements, tent cards, pamphlets, CDs, and VHS tapes.

13. A method for providing corporate content management and delivery (CCMD) services for efficient storage and management of corporate content, and delivery of such content in response to orders for such content comprising the steps of:
creating and/or acquiring digital content for repurposing in a digital and/or a physical format;
managing data necessary to process and execute orders for such corporate content in one of said digital format and said physical format; and
delivering said orders to internal and/or external third party content/product providers and customers.

14. The method of claim 13, wherein the digital content is created by and/or acquired from creators/owners and external third party content/product providers.

15. The method of claim 13, further comprising the steps of:
receiving and coordinating orders for said digital and/or physical content;
reserving inventory upon checkout by a customer;
selecting available shipping methods and payment methods for said orders;
maintaining multiple ship/bill to addresses for said customer;
integrating the order processing with a credit card electronic payment processing system for tax calculation, fraud detection, credit card authorization and settlement and internal billing using charge codes;
producing actions to deliver said digital content in a digital format or a physical format or in both digital and physical format;
correlating data with financial and third party warehouse management systems; and
providing status and tracking information to customers and CCMD administrators for all said orders.

16. The method of claim 13, wherein said CCMD services support standard internationalization rules so that localization of digital content and currency can be provided.

17. The method of claim 13, wherein multiple enterprises, multiple departments within each said enterprise, and their respective digital content, orders and related files are supported.

18. The method of claim 17, wherein a security architecture restricts access to data of each of the multiple enterprises and the multiple departments within each said enterprise to authorized customers and users.

19. The method of claim 13, wherein said orders are delivered to said external third party content providers via XML protocols.

20. A computer-readable storage medium containing computer executable code for implementing a computer-based corporate content management and delivery (CCMD) system for efficient storage and management of corporate content, and delivery of such content in response to orders for such content by instructing a computer to operate as follows:
execute a first module configured to create and/or acquire digital content for repurposing in a digital and/or a physical format;
execute a second module electronically coupled to the first module and configured to manage data necessary to process and execute orders for such corporate content in one of said digital format and said physical format; and
execute a third module configured to integrate operations of said first module and said second module and to coordinate these operations with internal and/or external third party content/product providers and customers.

21. The computer-readable storage medium of claim 20, wherein the digital content is uploaded into the CCMD system by content creators/owners and the internal and/or external third party content/product providers.

22. The computer-readable storage medium of claim 20, wherein the computer instructs said first sub-module to:
execute a first sub-module comprising a content storefront and administration portal and configured to receive and coordinate orders for digital and/or physical content; and
execute a second sub-module electronically coupled to the first sub-module and configured to produce actions to deliver said digital content in a digital format or a physical format or in both digital and physical format.

23. The computer-readable storage medium of claim 20, wherein said computer instructs said a computer-based corporate content management and delivery (CCMD) system to:
execute a production mode configured to receive and process orders for digital and/or physical content and cause actions necessary to deliver such digital and/or physical content as the orders require; and
execute an administration mode wherein digital content products are created, modified, priced and assigned to catalogues and categories, and wherein campaigns such as advertising and marketing campaigns can be created and modified and related to other relevant campaign materials, and wherein the catalogues and categories are created and modified, and wherein profiles of users and customers are created and maintained.

24. The computer-readable storage medium of claim 23, wherein said computer instructs said digital storefront to:
receive customer orders and reserve inventory upon checkout by the customer;
select available shipping methods and payment methods for the order;
maintain multiple ship/bill to addresses for a user;
integrate the order processing with a credit card electronic payment processing system for tax calculation, fraud detection and credit card authorization and settlement;
correlate data with financial and third party warehouse management systems; and
provide status and tracking information to customers and CCMD system administrators for all the orders.

25. The computer-readable storage medium of claim 20, wherein the first module and the second module are designed based on standard internationalization rules so that localization of digital content and currency can be provided.

26. The computer-readable storage medium of claim 20, wherein said computer instructs said computer-based corporate content management and delivery (CCMD) system to support multiple enterprises, multiple departments within each said enterprise and their respective digital content, orders and related files.

27. The computer-readable storage medium of claim 26, wherein said computer instructs said computer-based corporate content management and delivery (CCMD) system to restrict access to data of each of the multiple enterprises and the multiple departments within each said enterprise to authorized customers and users.
